(19) United States
(12) Patent Application Publication
(10) Pub. No.: US 2024/0361241 A1
(43) Pub. Date: Oct. 31, 2024

(54) METHODS AND SYSTEMS FOR BOND-SELECTIVE FLUORESCENCE-DETECTED INFRARED-EXCITED IMAGING

(71) Applicant: California Institute of Technology, Pasadena, CA (US)

(72) Inventors: Lu Wei, Pasadena, CA (US); Haomin Wang, Pasadena, CA (US); Dongkwan Lee, Pasadena, CA (US)

(21) Appl. No.: 18/645,178

(22) Filed: Apr. 24, 2024

Related U.S. Application Data
(60) Provisional application No. 63/462,131, filed on Apr. 26, 2023.

(51) Int. Cl. G01N 21/64

(52) U.S. Cl. CPC G01N 21/6402; G01N 21/6428; G01N 21/6458; G01N 2021/6439; G01N 2201/06113; G01N 2201/067

(57) ABSTRACT

Disclosed herein include methods and related systems of bond-selective fluorescence-detected infrared-excited (BonFIRE) spectroscopy. BonFIRE employs two-photon excitation in the mid-IR and near-IR to upconvert vibrational excitations to electronic states for fluorescence detection, thus encoding vibrational information into fluorescence. The method comprises providing a sample comprising a dye molecule having an UV-vis absorption maximum; generating an IR laser and a NIR laser, wherein the IR laser and the NIR laser are coherent; aligning the IR laser and the NIR laser in a counter-propagating configuration on the sample; irradiating the dye molecule with the IR laser and the NIR laser; and detecting a fluorescence from the dye molecule which can be used to extract a bond-selective IR absorption maximum of the dye molecule or form an image of the sample from the fluorescence with single-molecule sensitivity. The WF-BonFIRE technique significantly increases the imaging speed for single-molecule samples and for biological samples.

### RELATED APPLICATIONS

The present application claims priority under 35 U.S.C. § 119 (e) to U.S. Provisional Application No. 63/462,131, filed on Apr. 26, 2023, the content of which is herein expressly incorporated by reference in its entirety.

### STATEMENT REGARDING FEDERALLY SPONSORED R&D

This invention was made with government support under Grant No. GM140919 awarded by the National Institutes of Health. The government has certain rights in the invention.

### BACKGROUND

### Field

The present disclosure relates generally to the field of imaging technology, and in particular fluorescence-detected infrared-excited bioimaging.

### Description of the Related Art

Current understanding of biological processes has been significantly advanced by powerful optical bioimaging techniques that allow visualization of subcellular components with superb specificity, resolution, and sensitivity. Versatile fluorescence microscopic strategies with single-molecule sensitivity have generated a profound impact from fundamental biology to translational medicine. Complementarily, vibrational imaging, harnessing exquisite chemical contrasts from Raman scattering or mid-infrared (IR) absorption, can uniquely inform the distribution, transformation, and micro-environment of biomolecules and are quickly evolving. While Raman microscopy, such as stimulated Raman scattering (SRS) microscopy, is pushing the boundaries for metabolic imaging and optical super-multiplexing, IR microscopy has yet to unleash its full potential for modern bioimaging due to inherent limitations, such as coarse spatial resolution (owing to the long-wavelength IR excitation), strong water background, and the low detectability of dilute samples.

Many techniques were developed over the past decade to address the limitations associated with direct IR imaging for biology, utilizing secondary readout schemes. For example, mid-IR photothermal (MIP) microscopy and ultraviolet (UV)-localized mid-IR photoacoustic microscopy (ULM-PAM) record IR-induced photothermal and photoacoustic responses with short-wavelength visible and UV probes, respectively, detecting biomolecules with sub-IR-diffraction-limited resolution in cells and clinical tissues. However, their detection sensitivity is limited to tens of μM to mM of chemical bonds from biomolecules in situ, restricting their applications to abundant macromolecules (e.g., proteins and lipids). While single-protein IR detection has been achieved with near-field plasmonic enhancements, it is not readily applicable to general and quantitative bioimaging, especially moving into cells and tissues.

Thus, there remains a need for new methods and systems for fluorescence-detected infrared-excited spectroscopy that can offer superior sensitivity, resolution and specificity as well as multiplexity for bioimaging and tracking complex cellular dynamics and interactions.

### SUMMARY

Disclosed herein includes a method of bond-selective fluorescence-detected infrared-excited (BonFIRE) spectroscopy. The method can comprise: providing a sample comprising a dye molecule having an UV-vis absorption maximum; generating an IR laser and a NIR laser, wherein the IR laser and the NIR laser are coherent; aligning the IR laser and the NIR laser in a counter-propagating configuration on the sample; irradiating the dye molecule with the IR laser and the NIR laser; and detecting a fluorescence from the dye molecule. The method can comprise extracting a bond-selective IR absorption maximum of the dye molecule from the fluorescence, and/or selecting a total energy of a photon of the IR laser and a photon of the NIR laser to be about equal to the energy of the UV-vis absorption maximum.

In some embodiments, the UV-vis absorption maximum ranges from 400-800 nm. In some embodiments, the IR laser has a wave number ranging from 800-4800 cm⁻¹. In some embodiments, the NIR laser has a wavelength ranging from 700-960 nm. In some embodiments, the IR laser has a duration ranging from 0.1 to 10 picoseconds, and/or the NIR laser has a duration ranging from 0.1 to 10 picoseconds. In some embodiments, the IR laser has duration of 2 picoseconds and/or the NIR laser has a duration of 2 picoseconds. In some embodiments, the IR laser has a bandwidth ranging from 1 to 25 cm⁻¹ and/or the NIR laser has a bandwidth ranging from 1 to 25 cm⁻¹. In some embodiments, the IR laser has a bandwidth of 8 cm⁻¹ and/or the NIR laser has a bandwidth of 8 cm⁻¹.

The method can, for example, comprise providing the NIR laser with a temporal delay (t_{D}) ranging from −10 picoseconds to 25 picoseconds or a temporal delay (t_{D}) ranging from −3 picoseconds to 5 picoseconds. In some embodiments, the temporal delay (t_{D})) is 0 picosecond. In some embodiments, wherein the sample comprises a single dye molecule. The dye molecule can be, for example, Coumarin 6, Nile Blue A, CY5, ATTO 647N, Alexa Fluor 647, Cy5.5, CY7, Cy7.5, ATTO680, BF1, Rh800, BF2, BF3, BF4, or any derivatives thereof. In some embodiments, the dye molecule is a naturally occurring or bioengineered fluorophore present in a cell. In some embodiments, the naturally occurring fluorophore is selected from the group consisting of FAD and NADH. In some embodiments, the bioengineered fluorophore is selected from the group consisting of green fluorescent protein (GFP), blue fluorescent protein, cyan fluorescent protein, and yellow fluorescent protein derivatives; and optionally (1) the blue fluorescent protein is EBFP, EBFP2, Azurite, or mKalama1, (2) the cyan fluorescent protein is ECFP, Cerulean, CyPet, or mTurquoise2, and (3) the yellow fluorescent protein derivative is YFP, Citrine, Venus, or YPet. In some embodiments, the dye molecule comprises one or more isotopologues of conjugated carbon-carbon double bond (C═C), conjugated carbon-carbon triple bond (C≡C) and/or conjugated carbon-nitrogen triple bond (C≡N), wherein the carbon is ¹²C or ¹³C and the nitrogen is ¹⁴N or ¹⁵N, in any combinations. In some embodiments, the dye molecule comprises BF1 having a formula (XIII),

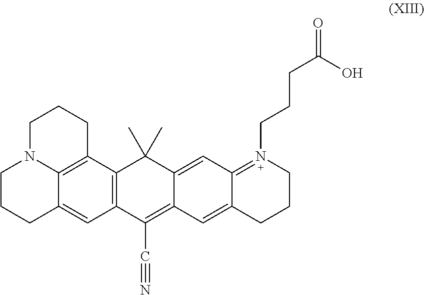

wherein the carbon-nitrogen triple bond (C≡N) is ¹²C≡¹⁴N, ¹³C≡¹⁴N, ¹³C≡¹⁵N or any combination thereof.

In some embodiments, the separation in bond-selective IR absorption maxima of two of the one or more isotopologues of the dye molecule is about equal to or more than half of the summation of the full width at half maximum (FWHM) of the two of the one or more isotopologues of the dye molecule. In some embodiments, the IR absorption maximum of the dye molecule falls within the range from 800-3300 cm⁻¹. In some embodiments, the IR absorption maximum of the dye molecule falls within the range from 800-1800 cm⁻¹. In some embodiments, the IR absorption maximum of the dye molecule falls within the range from 1800-2800 cm⁻¹.

The method can, in some embodiments, comprise obtaining an image of the sample from the fluorescence, obtaining a plurality of images of the sample from the fluorescence, wherein the plurality of images each corresponds to one of a plurality of temporal delays (t_{D}), obtaining a vibrational relaxation lifetime of a chemical bond associated with the fluorescence, or a combination thereof. In some embodiments, the sample is a neuron, a cell, or a tissue; and optionally the cell is a cancer cell. In some embodiments, the dye is chemically conjugated to the sample. In some embodiments, the dye comprises ATTO680 azide, having a Formula (IX),

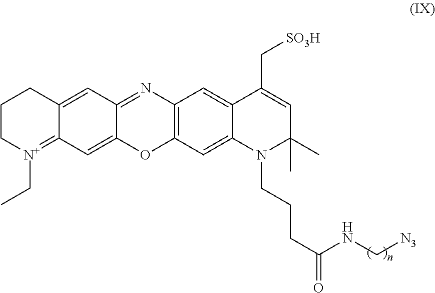

wherein n is an integer ranging from 1 to 6, ATTO680 azide is azide-click-labeled to 5-ethynyl-2′-deoxyuridine (EdU) of the sample. In some embodiments, n is 3.

In some embodiments, the method comprises passing the IR laser through an acoustic optical modulator (AOM) to obtain a first-order diffraction IR laser before aligning the IR laser and the NIR laser in a counter-propagating configuration on the sample, wherein the acoustic optical modulator (AOM) is controlled by a trigger source which produces a modulation frequency. In some embodiments, the detecting a fluorescence from the dye molecule was performed with a photomultiplier tube (PMT), wherein the BonFIRE microscopy has a signal to background ratio (S/B) ranging from 2 to 100. In some embodiments, the detecting a fluorescence from the dye molecule was performed with a photomultiplier tube (PMT), wherein the BonFIRE microscopy has a signal to background ratio (S/B) ranging from 5 to 50. In some embodiments, the detecting a fluorescence from the dye molecule was performed with a photomultiplier tube (PMT), wherein the BonFIRE microscopy has a signal to background ratio (S/B) ranging from 15 to 20. In some embodiments, the BonFIRE microscopy has a signal to noise ratio (S/N) ranging from 2 to 100. In some embodiments, the BonFIRE microscopy has a signal to noise ratio (S/N) ranging from 5 to 50. In some embodiments, the BonFIRE microscopy has a signal to noise ratio (S/N) ranging from 15 to 20. In some embodiments, the sample is a cell and time-lapse images of the cell is obtained at each interval of time of 1 to 60 minutes for a period of 10 minutes to 24 hours. In some embodiments, the modulation frequency ranges from 0.1 to 5.0 MHz. In some embodiments, the modulation frequency ranges from 1.0 to 3.0 MHz. In some embodiments, the cell is a dividing live cell. In some embodiments, the each interval of time is 5 minutes and the period is 20 minutes.

In some embodiments, the detecting comprises a field of view ranging from 1 to 25 μm in dimension. In some embodiments, the field of view is about 12.5 μm in dimension. In some embodiments, the detecting comprises a field of view ranging from 25 to 100 μm in dimension. In some embodiments, the field of view is about 50 μm in dimension. The detecting can have a detection limit ranging from 0.01 nM to 50 nM, or a detection limit ranging from 0.1 nM to 10 nM, or a detection limit of about 0.5 nM.

In some embodiments, the detecting has an acquisition speed ranging from 20 to 10,000 frames per second (fps). In some embodiments, the detecting has an acquisition speed ranging from 100 to 3,000 fps. In some embodiments, the detecting has an acquisition speed about 2,100 fps.

Disclosed herein includes a system for bond-selective fluorescence-detected infrared-excited (BonFIRE) spectroscopy. The system can, in some embodiments, comprise: a piezo stage for holding a sample comprising a dye molecule wherein the dye molecule has an UV-vis absorption maximum; a laser source for an IR-OPO (optical parametric oscillator), and a NIR-OPO for generating an IR laser and a NIR laser, respectively, wherein the IR laser and the NIR laser are coherent and, wherein the IR-OPO was followed by and optically connected to a DFG (difference frequency generation), optionally followed by and optically connected to an acoustic optical modulator (AOM), and the NIR-OPO is preceded by a SHG (second-harmonic generation), and a SPCM (single-photon counting module) or a photomultiplier tube (PMT) for detecting a fluorescence from the dye molecule. In some embodiments, the acoustic optical modulator (AOM), and the photomultiplier tube (PMT) are present, and wherein the acoustic optical modulator (AOM) and the photomultiplier tube (PMT) are communicatively electrically connected to a lock-in amplifier, wherein the acoustic optical modulator (AOM) is controlled by a trigger source which produces a modulation frequency. In some embodiments, the system further comprises a delay stage on a light path of the NIR laser and/or an optical chopper on a first path and a second path of the NIR laser. In some embodiments, the optical chopper has a rotation speed ranging from 1 to 20 kHz, or a rotation speed ranging from 5 to 10 kHz. In some embodiments, the system further comprises a first beam splitter and a second beam splitter on the first path and the second path of the NIR laser. In some embodiments, the second path is lengthier than the first path by Δl ranging from 0.01 mm to 10 mm, or 0.1 to 1 mm.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1F illustrate principle, setup, and broad spectral coverage of BonFIRE spectro-microscopy. FIG. 1A illustrates an energy diagram of bond-selective fluorescence-detected IR-excited (BonFIRE) spectroscopy. S₀ and S₁: Ground and first electronic excited states. Ωᵥ: Ground-state vibrational energy. FIG. 1B illustrates spectral coverage of BonFIRE. Grey dots are vibrational peaks of 18 dyes measured by FTIR (see Table 1 and FIG. 12A-D for details). Rainbow-colored dots filled with solid colors are vibrational peaks that are already detected by BonFIRE. FIG. 1C illustrates BonFIRE experimental setup. Dashed gray rectangles indicate flip mirrors. Gray-shaded boxes labeled with numbers 1, 2, and 3 indicate three interdependent laser modules for generating coherent and tunable 2-ps near-IR (NIR) and mid-IR pulses in BonFIRE. SHG: second-harmonic generation; OPO: optical parametric oscillator; DFG: difference frequency generation; SPCM: single-photon counting module.

FIG. 1D shows another WF-BonFIRE experimental scheme. OBJ, objective; BFP, back focal plane; DM, dichroic mirror; TL, tube lens; C, camera; L, lens; DL, delay line; BS, beamsplitter; DFG, difference frequency generation; OPO, optical parametric oscillator; SHG, sum frequency generation.

FIG. 1E shows two implementation modes of WF-BonFIRE (Mode 1 & Mode 2). Figure not in scale.

FIG. 1F shows comparison of speed and sensitivity of WF-BonFIRE to that of other chemical imaging modalities.

FIGS. 2A-2H depict double-bond BonFIRE characterizations. FIG. 2A shows fluorescence absorption/emission spectra of ATTO680 with indicated optimal BonFIRE up-conversion probe wavelength (orange) and collection band (gray), targeting the IR vibrational peak at 1598 cm⁻¹. FIG. 2B shows BonFIRE signal dependence on IR-probe pulse delay. cpms: counts per millisecond. FIG. 2C shows BonFIRE signal dependence on probe wavelength (dashed orange). The BonFIRE excitation profile (orange dots, by horizontally shifting the raw data by adding the IR frequency of 1598 cm⁻¹) is also overplotted with the absorption spectrum of ATTO680 (purple). AU: arbitrary unit. Data are presented as peak values+/−SD from the background (n=13). FIGS. 2D-2E provide BonFIRE signal dependences on IR power (FIG. 2D) and probe power (FIG. 2E) on sample, measured from 10 μM ATTO680 in DMSO. Data are presented as peak values+/−SD from the background (n=18). FIG. 2F shows overplot of BonFIRE (red) and FTIR (gray) spectra of ATTO680. FIG. 2G shows comparison of BonFIRE signals among eight dyes (1 μM in DMSO), targeting the IR excitation for their corresponding C═C bonds around 1600 cm⁻¹, details are provided in Table 3. FIG. 2H shows the dependence of BonFIRE signal on the ATTO680 concentration in DMSO. A detection limit of 0.5 nM was obtained with a signal-to-noise ratio (S/N) of 3. Data are presented as mean+/−SD (n=3). Error bars: standard deviations.

FIGS. 3A-3L show cell-silent BonFIRE spectroscopy. FIG. 3A shows fluorescence absorption/emission spectra of BF1 with optimal BonFIRE up-conversion probe wavelength (orange) and collection band (gray), targeting the IR vibrational peak at 2224 cm⁻¹. FIG. 3B shows BonFIRE signal dependence on IR-probe temporal delay for C═C (yellow) and C≡N (blue) in BF1. Backgrounds were subtracted to compare the BonFIRE peak heights directly. cpms: counts per millisecond. FIG. 3C shows BonFIRE signal dependence on the probe wavelength (dashed orange). The BonFIRE excitation profile (blue, by horizontally shifting the raw data by adding the IR frequency of 2224 cm⁻¹) is overplotted with the absorption spectrum of BF1 (purple). Data are presented as peak values+/−s.d. from the background (n=14). FIG. 3D shows a contour map of C≡N BonFTRE signals as functions of IR frequency (vertical) and IR-probe delay t_{D} (horizontal). FIG. 3E shows BonFIRE spectra of C≡N taken at t_{D}=0 ps (blue) and t_{D}=1.5 ps (green). Data are shown as dots, and fittings (Gaussian+linear) are shown as dashed curves. FIGS. 3F-3G show BonFIRE signal dependence on the IR power (FIG. 3F) and the probe power (FIG. 3G) on sample, measured from 10 μM BF1 in PBS. The probe power dependence shows good linearity (R²=1.00) at low power levels but quickly saturates. Data are presented as peak values+/−s.d. from the background (n=17). FIG. 3H shows BonFIRE spectra of four C≡N isotopes of BF1. Fitted spectra are shown for clarity. AU: arbitrary unit. FIG. 3I shows Solvatochromism of C≡N measured from 10 μM BF1 in three different PBS/DMSO mixtures. FIG. 3J shows comparison of BonFIRE signals targeting the triple bonds from six dyes (1 μM in PBS). Details are provided in Table 4. FIG. 3K shows concentration curve of C≡N in BF1 in water. The detection limit was 5 nM with a signal-to-noise ratio (S/N) of 6. Data are presented as mean+/−SD (n=3). FIG. 3L shows BonFTRE spectrum of 5 nM BF1 in water. Error bars: standard deviations.

FIGS. 4A1-4G show single-molecule BonFIRE imaging and spectroscopy. FIG. 4A1 and FIG. 4B1: single-molecule BonFIRE images of C═C modes in ATTO680 (FIG. 4A1) and Rh800 (FIG. 4B1) across IR frequencies. The corresponding IR frequencies and the probe wavelengths used are indicated in each image. FIG. 4A2 and FIG. 4B2: The spectra with Gaussian fittings are obtained by plotting the average BonFTRE signals within the central 500×500 nm² area. FIG. 4C1 and FIG. 4D1: single-molecule BonFIRE images of C≡N bonds in BF1 (FIG. 4C1) and its ¹³C≡¹⁵N isotopologue (FIG. 4D1) across IR frequencies. FIG. 4C2 and FIG. 4D2: The spectra with Gaussian fittings are obtained by plotting average BonFIRE signals within the 500×500 nm² area indicated by white dashed boxes in (FIG. 4C2) and (FIG. 4D2). Single dye-conjugated antibodies are used. FIGS. 4E-4G show fluorescence image (FIG. 4E) of the single-molecule mixture with three BF1 isotopologues, resolved and color-coded (i.e., ¹³C≡¹⁴N (red), ¹²C≡¹⁵N (green), and ¹²C≡¹⁴N (blue)) in (FIG. 4F) based on their in-situ BonFIRE spectra (FIG. 4G, representative spectra plotted from arrowhead-indicated single molecules from FIG. 4F). Unassigned (gray) dots in (FIG. 4F) are due to either a poor S/N or the existence of more than one color (FIG. 18A-B). Scale bars: 500 nm (FIGS. 4A1-4D2) and 1 μm (FIGS. 4E-4F).

FIGS. 5A1-5J5 show bond-selective bioimaging by BonFIRE microscopy. FIGS. 5A1-2 On-resonance (FIG. 5A1, 1598 cm⁻¹) and off-resonance (FIG. 5A2, 1650 cm⁻¹) BonFIRE images of C═C vibration in ATTO680-click-labeled EdU in nuclei of HeLa cells. (FIGS. 5B-C) BonFIRE images targeting C═C vibration in ATTO680-click-labeled EdU in extracted chromosomes (FIG. 5B) and ATTO680-immunolabeled-fibrillarin in nucleoli (FIG. 5C) from HeLa cells. (FIGS. 5D1-2) On-resonance (FIG. 5D1, 2220 cm⁻¹) and off-resonance (FIG. 5D2, 2100 cm⁻¹) BonFIRE images of C≡N vibrations in BF1-immunolabeled α-tubulin in HeLa cells. (FIGS. 5E-F) BonFIRE images of ¹²C≡¹⁴N (2220 cm⁻¹, FIG. 5E) in BF1-immunolabeled MAP2 (marker for mature neurons) and ¹³C≡¹⁴N (2170 cm⁻¹, FIG. 5F) in BF1-isotopologue-immunolabeled GFAP (marker for astrocytes) in mouse neuronal co-cultures. (FIG. 5G) Two-color BonFIRE imaging of ¹³C≡¹⁴N (green, 2170 cm⁻¹) and ¹²C≡¹⁴N (red, 2220 cm⁻¹) in BF1- and BF1-isotopologue-immunolabeled GFAP and MAP2 from the same set of neuronal co-culture. (FIG. 5H-FIG. 5I) 2D (FIG. 5H) and 3D rendering (FIG. 5I) BonFIRE images of BF1-¹³C≡¹⁴N-immunolabeled GFAP in a mouse brain tissue slice. (FIGS. 5J1-4) Four-color BonFIRE images of ¹²C≡¹⁴N (FIG. 5J1, red, 2220 cm⁻¹), ¹²C≡¹⁵N (FIG. 5J2, blue, 2195 cm⁻¹), ¹³C≡¹⁴N (FIG. 5J3, green, 2170 cm⁻¹), and ¹³C≡¹⁵N (FIG. 5J4, yellow, 2145 cm⁻¹) BF1-isotopologue-click-labeled EdU in nuclei of HeLa cells. The merged image is shown in FIG. 5J5. Cpms: counts per millisecond. Scale bars: 10 μm.

FIGS. 6A-G illustrate background-free BonFIRE microscopy. (FIG. 6A) Two major background sources in BonFIRE: anti-Stokes fluorescence (blue-shaded) and photothermal induced fluorescence (red-shaded). Signals shown are from the C≡N of 10 μM BF1 in PBS. cpms: counts per millisecond. (FIG. 6B) Experimental setup of background-free BonFIRE microscopy with fast modulation. AOM: acoustic optical modulator, PMT: photomultiplier tube, DAQ: data acquisition. (FIG. 6C) Dependence of BonFIRE AC S/B (left) and S/N (right) on the AOM modulation frequency. Reductions of background and noise as modulation frequency increases are shown in the insets. Data shown are extracted from a series of BonFIRE images of neuron cells (not shown). Signals are mean values from an area of 4.7×4.7 μm² (n=400 pixels). Background and noise are from the mean and SD of the same area (n=400 pixels) in fluorescence images at t_{D}=10 ps. Data are fitted and connected by polynomial curves (order=4). (FIGS. 6D1-2) 0-ps delay (FIG. 6D1) and 20-ps delay (FIG. 6D2) BonFIRE images of C═C in BF1-click-labeled-EdU in nuclei of HeLa cells. (FIGS. 6E1-2) BonFIRE imaging of BF1-¹³C≡¹⁵N-immunolabeled a-tubulin in HeLa cells (FIG. 6E1, 2150 cm⁻¹) and BF2-click-labeled EdU of extracted chromosomes (FIG. 6E2, 2228 cm⁻¹). (FIGS. 6F1-2) Background-free live-cell BonFIRE imaging of Rh800-stained HeLa cells in PBS. FIG. 6F1: IR at 1598 cm⁻¹; FIG. 6F2: IR at 2224 cm⁻¹. (FIG. 6G) Representative time-lapse BonFIRE imaging (targeting C≡N at 2224 cm⁻¹) for dividing live HeLa cells stained with Rh800 in PBS. Scale bars: 10 μm.

FIGS. 7A-B provide energy diagrams of fluorescence-encoded IR (FEIR, FIG. 7A) and stimulated Raman excited fluorescence (SREF, FIG. 7B).

FIG. 8 depicts power outputs of the Idler (orange) and the DFG (blue) IR lasers. The power was measured at the laser outputs using a thermopile power meter (919P-003-10, Newport). All wavenumbers within 800 and 4800 cm⁻¹ (2.1-12 μm) are covered. The pulse width is 2 ps with a bandwidth of 8-10 cm⁻¹ according to the manufacturer (APE Angewandte Physik & Elektronik GmbH, Berlin, Germany).

FIGS. 9A-G show simulation of BonFIRE process with a three-level system. (FIG. 9A) The energy diagram for the three-level system simulation. Two scenarios—one with C═C excitation (orange-shade highlighted, FIGS. 9B-D) and the other with C≡N excitation (blue-shade highlighted, FIGS. 9E-G) in BF1 dye molecule—were numerically simulated. In the simulation, the initial ground-state population (N₁) is set to 10000, and the number of steps of the population evolution is set to 50000, corresponding to 4×10⁻⁵ ps per step. (FIG. 9B) & (FIG. 9E) Population changes in N₂ and N₃ during 2-ps pulse duration. (FIGS. 9C-D)&(FIGS. 9F-G) Electronic excited-state population (N₃) as functions of IR transition rate of q₁₂ and probe transition rate of q₂₃. Fixing all other parameters (pulse duration, wavelength, Franck-Condon constant, etc.), q₁₂ and q₂₃ are pure functions of IR and probe powers. IR powers used for simulation in (FIG. 9B) & (FIG. 9E) and probe powers reaching the saturation level are indicated by red dots. The equations and details of the simulation are described in the “Modeling of the double-resonance in BonFIRE” in Methods of Example 6.

FIG. 10 depicts reduced photothermal background in acetonitrile-d₃. The fluorescence vs. IR-probe delay (t_{D}) of ATTO680 in DMSO (blue) and acetonitrile-d₃ (orange) obtained using 1598 cm⁻¹ IR frequency and 765-nm probe wavelength. While the signal to background (S/B) ratio is about 8% in DMSO, it increases to 56% in acetonitrile-d₃.

FIG. 11 shows dependence of the BonFIRE background (orange) and signal-to-background ratios (S/B, blue) on the probe beam wavelength for ATTO680. The BonFIRE background increases as the combined excitation frequency of the probe and the IR (at 1598 cm⁻¹) gets closer toward the absorption peak (681 nm), leading to a drop in S/B at the probe wavelength lower than 775 nm. To strike a balance between the signal sizes, signal-to-noise ratios (S/N), and S/B, 765 nm was chosen for BonFIRE spectroscopy. The sample here is 1 μM ATTO680 in DMSO. The on-sample powers are 350 μW of the probe and 40 mW of the IR (1598 cm⁻¹). SPCM readings (photon counts per ms) were corrected based on the calibration curve provided by the manufacturer (Excelitas).

FIGS. 12A-D provide correlation between BonFIRE and FTIR spectra. (FIG. 12A) FTIR (gray) and BonFIRE (red) spectra obtained for dyes in the fingerprint region. The dye and the experimental conditions (either in 10 mM DMSO solutions or in KBr solids) for obtaining FTIR spectrum are indicated in each spectrum. The BonFIRE spectra (red curves) and single-point BonFIRE measurements (red circles, BonFIRE vs. IR-probe delay obtained for the single wavenumber) were scaled and overplotted on top of the FTIR reference for better comparison. (FIGS. 12B1-2) FTIR and BonFIRE spectra of four dyes in the cell-silent region. (FIG. 12C) FTIR spectra of other dyes expected to be measured in BonFIRE (for grey dots in FIG. 1B). The FTIR spectra measured in DMSO in the fingerprint region in (FIG. 12A) and (FIG. 12C) are often complicated by the IR absorption of DMSO and water (DMSO is hygroscopic), whose spectra were plotted in (FIG. 12D) for reference. The spectra of ATTO680 and Rh800 are not shown here as they are already shown in FIG. 2F and FIGS. 26A-B.

FIG. 13 shows raw data (dotted) and fittings (solid-lined) in FIG. 3H. The fittings were performed with a Gaussian function and a linear background for each color-coded spectrum.

FIG. 14 shows UV-vis spectra of four BF1 isotopologues. Four absorption spectra and peaks (758 nm) of BF1 dyes with ¹³C≡¹⁵N, ¹³C≡¹⁴N, ¹²C≡¹⁵N, and ¹²C≡¹⁴N are almost identical in DMSO solutions. The concentration for the measurement is 10 μM. Absorption profiles were vertically shifted for better comparison.

FIGS. 15A1-B show spatial resolution of BonFIRE microscopy. (FIGS. 15A1-2) BonFIRE images of 100-nm fluorescent beads (Invitrogen™ FluoSpheres™ carboxylate-modified microspheres, 0.1 μm, 715/755 nm, Fisher Scientific) embedded in PVA film on a CaF₂ substrate. The image was taken with 1592 cm⁻¹ IR (about 24 mW on sample) and 815 nm probe (about 180 μW on sample). Scale bar is 1 μm. (FIG. 15B) A sectional profile obtained from XY plane from a location indicated by the white dashed line in (FIG. 15A1), a lateral resolution (FWHM) of 0.6 μm was obtained from Gaussian fitting. The Z-resolution of 1.8 μm was determined by fitting the sectional profile from the ZY plane (shown as inset, FIG. 15A2). AU arbitrary unit.

FIGS. 16A-C show the single-molecule behavior and bulk BonFIRE spectra of ATTO680 and Rh800. (FIGS. 16A-B) Representative fluorescence image (FIG. 16A) and single-step photobleaching curve (FIG. 16B) for confirming the single-molecule sample preparation. In (FIG. 16A), the white arrow on the left shows the scan direction, and the white arrowhead indicates the “half-moon” bleach of a single molecule. cpms: counts per millisecond. Scale bar: 1 μm. (FIG. 16C) BonFIRE spectra of C═C modes in ATTO680 and Rh800 from dried dye/PVA aggregates. Spectra are shifted vertically for better comparison.

FIGS. 17A1-C2 show representative fluorescence images with photobleaching curves of single-molecule samples. Representative fluorescence images and photobleaching curves (three representative curves for each sample) are obtained for ATTO680 (FIGS. 17A1-2), Rh800 (FIGS. 17B1-2), and BF1-antibody conjugates (FIGS. 17C1-2). Single-step bleach and blinking could be observed in photobleaching curves, indicating the presence of single molecules. For (FIGS. 17A1-2) and (FIGS. 17B1-2), single-molecule samples were prepared by spin casting 20 μM ATTO680 or 10 μM Rh800 in 0.2% PVA solution onto a new CaF₂ window using 5000 rpm for 30 s. For (FIGS. 17C1-2), the single-molecule sample was prepared by incubating dye-antibody conjugates solution (diluted 625000 times in PBS from a 0.5 mg/mL stock solution, the dye:protein ratio is 1.7:1) onto a poly-l-lysine coated CaF₂ window for 30 min, and then dried in air before imaging. For ATTO680 with a high quantum yield (30%), the probe wavelength (763 nm, 2 ps) used for BonFIRE can be directly applied to performing in-situ photobleaching, while the fluorescence photon counts were recorded over time through the SPCM with a binning width (temporal step) of 2 ms. For Rh800 and BF1, however, the quantum yield is low (16% and 10%), and the wavelength of BonFIRE probe (788 nm and 840 nm) is too red to obtain reproducible bleach curves. Bleach curves of the same samples was instead obtained using a commercial confocal microscope (Olympus FV3000) with a 640-nm cw laser and detected the fluorescence change over time using PMT. Each step is 40 ms in (FIGS. 17B1-2) and (FIGS. 17C1-2). The PMT offset was corrected so that the fluorescence baseline was zero. 0.2 mW at 763 nm for ATTO680 and 5 mW at 640 nm for Rh800 and BF1 were used for obtaining photobleaching curves. Cpms: counts per millisecond. Scale bars: 1 μm.

FIGS. 18A-B provide observation of multiple single-molecule isotopologues within the same diffraction-limited spot. (FIG. 18A) Color-coded fluorescence imaging for a mixture of single-molecule BF1 isotopologues as shown in FIG. 41. Red: BF1-¹³C≡¹⁴N (2170 cm⁻¹); green: BF1-¹²C≡¹⁵N (2195 cm⁻¹); and blue: BF1-¹²C≡¹⁴N (2220 cm⁻¹). (FIG. 18B) In-situ BonFIRE spectra obtained from three spots indicated by the corresponding numbered arrowheads in (FIG. 18A). Gaussian fittings (and a linear background) are shown as solid curves, and BonFIRE data are plotted as markers. Spectra of spots 1 (orange), 2 (gray), and 3 (light blue) contain all three vibrational peaks. Slight variations in peak positions are possibly due to local interactions. These results demonstrate that BonFIRE can resolve multiple vibrational colors within the same diffraction-limited spot at the single-molecule level.

FIGS. 19A-C provide evidence for robust single-molecule sensitivity of BonFIRE. (FIG. 19A) Raw data of single-molecule BonFIRE imaging of ATTO680 C═C in FIG. 4A, confirming that BonFIRE data from subtraction are not from single-molecule bleaching or blinking. The S/Bs reach >1 because of the much-reduced photothermal background of the dilute single-molecule sample and the IR-transparent PVA matrix. c.p.ms, counts per millisecond. (FIG. 19B) Raw data of single-molecule BonFIRE imaging of ¹²C≡¹⁵N labeled BF1, the same sample was used in FIG. 4E-G. Repeatable BonFIRE contrast and no photobleaching were confirmed by the continuous scan. (FIG. 19C) Signal vs. IR-probe delay (t_{D}) of a small region containing multiple single BF1 molecules. The S/Bs reach ˜3. The signal on/off as the function of t_{D} is another evidence of the BonFIRE's single-molecule sensitivity. Scale bars: 1 μm. Color bar unit: cpms.

FIGS. 20A1-C show photo-stability of biological BonFIRE microscopy. ATTO680-click-labeled-EdU cells on CaF₂ were imaged with on-sample IR power of 21 mW and probe power of 2 mW over 100-frame consecutive image scans. BonFIRE images were obtained by subtracting two adjacent frames captured at 0-ps and 20-ps probe-IR delays. (FIGS. 20A1-2) The first and the last (50^{th}) BonFIRE images of ATTO680 C═C showing two cell nuclei. The average signal from a cropped area (indicated by a white dashed box in the first image) is plotted against time in (FIG. 20B), where the BonFIRE signal oscillates between 97.5% and 100%. (FIG. 20C) Comparison of photobleaching between probe-only fluorescence and BonFIRE under the same power and imaging condition, confirming that introducing an additional IR beam does not increase the photobleaching rate in BonFIRE as compared to that of the probe-only fluorescence. Cpms: counts per millisecond. Scale bars: 10 μm.

FIGS. 21A-B provide a comparison between BonFIRE (FIG. 21A, blue) and photothermal (FIG. 21A, red, PT 20 ps, taken at t_{D}=20 ps) spectra from a 100 μM ATTO680 DMSO solution. While the BonFIRE spectrum shows the 1598 cm⁻¹ peak of ATTO680 explicitly, the photothermal spectrum at t_{D}=20 ps is featureless. The BonFIRE-to-photothermal background ratios (S/Bs) across frequencies are plotted in (FIG. 21B).

FIGS. 22A-C shows sample movement during live-cell imaging. C≡N BonFIRE imaging of Rh800-stained live HeLa cells at IR-probe delays (t_{D}) of 0 ps (FIG. 22A), 10 ps (FIG. 22B), and after subtraction (FIG. 22C). The time for capturing each frame was ˜40 s. The first two images were acquired consecutively using SPCM. The arrow indicates the subtraction artifact in (FIG. 22C) caused by cell movement. Cpms: counts per millisecond.

FIG. 23 provides characterization for the temporal buildup of the photothermal background. BonFIRE intensity measured by PMT is plotted against time, as the IR beam is chopped at 10 kHz. When the IR and probe are temporally overlapped (red curve), a fast-increasing component in the BonFIRE signal (the blue-shaded area) could be observed, followed by a slow-increasing component due to the temperature rise caused by the IR-photothermal effect. When the IR and probe are temporally separated (blue curve), only the slow-increasing component is seen, resulting from the pure photothermal effect. The orange-shaded area indicates the photothermal-induced BonFIRE background rises at the time scale of tens of μs, while the initial BonFIRE signal burst stops within several μs (blue-shaded area). Note that the slow increase of BonFIRE-dominant fluorescence signal around 20 μs is mostly caused by the slow chopper movement and data acquisition and does not accurately indicate the temporal generation of BonFIRE signals.

FIGS. 24A-D show a modulation scheme of background-free BonFIRE microscopy. (FIGS. 24A-B) Simulated pulse trains (FIG. 24A) and the expected total signal (FIG. 24B) when IR pulses are not modulated. The total signal is composed of anti-Stokes fluorescence (blue shaded) detected with probe laser alone, IR-induced photothermal fluorescence (yellow shaded) detected when IR and probe are temporally offset, and BonFIRE signal (red shaded) detected when IR and probe are temporally overlapped. (FIGS. 24C-D) Simulated pulse trains (FIG. 24C) and the expected signal (FIG. 24D) when 80 MHz IR pulse trains are intensity-modulated by AOM at 1 MHz. The first-order diffraction from AOM completely turns off the IR throughput and achieves maximal on/off ratios. Due to the high-frequency modulation, the photothermal background has no time to build up (FIG. 23) and is almost completely suppressed, and the anti-Stokes fluorescence is removed through the lock-in demodulation (FIG. 24D).

FIGS. 25A-B show BonFIRE concentration curves with PMT AC detection. (FIG. 25A) The concentration curve of C═C in ATTO680 in DMSO. The lowest concentration measured is 1 nM. The probe wavelength is 765 nm, and the IR frequency is 1592 cm⁻¹. Data are presented as peak values+/−SD from the background (n=9). a.u., arbitrary unit. (FIG. 25B) Concentration curve of C≡N in Rh800 in DMSO. The lowest concentration measured is 8 nM. The probe wavelength is 830 nm, and the IR frequency is 2228 cm⁻¹. Both minimum concentrations are close to or below the calculated single-molecule threshold of 5 nM. Data are presented as peak values+/−s.d. from the background (n=22). Error bars are standard deviations.

FIGS. 26A-B show broad spectral coverage of BonFIRE microscopy. (FIG. 26A) BonFIRE images of Rh800-stained HeLa cells targeting six different vibrational modes. Vibrations of phenolic C—O (1100 cm⁻¹), aromatic C—N (1300 cm⁻¹), conjugated C═C (1504 cm⁻¹ and 1598 cm⁻¹), conjugated C≡N (2228 cm⁻¹), and C—H stretch (2860 cm⁻¹) can all serve for BonFIRE imaging. a.u., arbitrary unit. Scale bars: 10 μm. (FIG. 26B) BonFIRE spectrum (red) and FTIR spectrum (grey) of Rh800. BonFIRE spectrum is normalized to the most intense peak at 1598 cm⁻¹. The C≡N peak around 2228 cm⁻¹ and a weak broad peak of the C—H region (2700 cm⁻¹−3200 cm⁻¹) are enlarged in insets for better comparison.

FIGS. 27A-N depict BonFIRE lifetime imaging microscopy (BLIM). (FIG. 27A) BonFIRE signal dependence on IR-probe temporal delay measured for C≡N (2228 cm⁻¹), aromatic C≡N (1300 cm⁻¹), and C═C (1598 cm⁻¹) of Rh800 in water and DMSO environments. While both C≡N and C≡N show different lifetimes in water and DMSO, the lifetime of C═C is constant between the two environments. (FIG. 27B) Solvatochromism of C≡N of Rh800 in PBS:DMSO mixture (left, blue-shaded) and different aprotic solvents with varying electrostatic fields (right, yellow-shaded) calculated from Onsager reaction field theory, Shi, L., Hu, F. & Min, W. Optical mapping of biological water in single live cells by stimulated Raman excited fluorescence microscopy. Nature Communications 10, 4764, doi:10.1038/s41467-019-12708-2 (2019) (field of PBS was adopted from literature, Deb, P. et al. Correlating Nitrile IR Frequencies to Local Electrostatics Quantifies Noncovalent Interactions of Peptides and Proteins. The Journal of Physical Chemistry B 120, 4034-4046, doi:10.1021/acs.jpcb.6b02732 (2016)). An inverted “V-shape” is observed in (FIG. 27B), showing the lifetime of C≡N is an indicator of the Stark effect (right part) and hydrogen-bonding environment (left part). This finding is consistent with the vibrational Stark effect (VSE) benchmarked with nitrile peak shift, and the opposite trend in PBS:DMSO mixture due to hydrogen-bonding effects. (FIG. 27C) BonFIRE image of Rh800-stained HeLa cells immersed in PBS obtained at 2228 cm⁻¹. Subcellular regions are indicated by dashed green (nucleus and nucleoli), red (endoplasmic reticulum, ER), and white (cytoplasm, excluding ER) enclosures. (FIG. 27D) BLIM image at 2228 cm⁻¹ for C≡N of the same field of view (FOV). Nucleus and cytoplasm (including ER) regions are clearly differentiated. (FIG. 27E) Histogram of lifetime values in different subcellular regions. (FIG. 27F) Statistics of lifetime measurements. While the C≡N lifetime can differentiate between the nucleus and cytoplasm (**p=0.0012 unpaired Student's t-test, two-tailed, n=5), it cannot distinguish the nucleus from nucleoli. Data are presented as mean values+/−SD. (FIG. 27G) Solvatochromism of aromatic C≡N (1300 cm⁻¹) lifetime in different solvents. Although a large difference could be found between different solvents (e.g., ˜80% increase from PBS to CHCl₃), no linear dependence on the electric field could be established, indicating a different sensing mechanism from C≡N. (FIG. 27H) BLIM image at 1300 cm⁻¹. In addition to the nucleus and cytoplasm, nucleoli and ER (highlighted by white dashed enclosures) could be further distinguished from the nucleus and cytoplasm. (FIG. 27I) Histogram of lifetime values obtained in different subcellular regions. (FIG. 27J) Statistics of lifetime measurements. Bar diagrams of lifetimes measured from five FOVs (11 cells). Clear differences could be found between the nucleus and nucleoli (**p=0.0015 unpaired Student's t-test, two-tailed, n=5) and between ER and cytoplasm (****p<0.0001 unpaired Student's t-test, two-tailed, n=5). Compared to C≡N, C—N is more sensitive to differentiate nucleoli from nucleus. Moreover, with a positive charge in the resonant structure, aromatic C—N is likely more sensitive to varied charged membrane environments so that the ER could be distinguished by BLIM. Data are presented as mean values+/−SD. (FIG. 27K) Solvatochromism of conjugated C═C (1598 cm⁻¹). The lifetimes are highly close in different solvents, indicating that C═C is less sensitive in sensing. (FIG. 27L) BLIM image at 1598 cm⁻¹, no clear contrast could be extracted between different subcellular regions. (FIG. 27M) Histogram of lifetime values obtained in nucleus and cytoplasm, showing a small difference. (FIG. 27N) Statistics of lifetime measurements. Bar diagrams of lifetimes measured from four FOVs (9 cells). No difference (ns=not significant, unpaired Student's t-test, two-tailed, n=5) could be found between the nucleus and cytoplasm, indicating the C═C is the least sensitive mode among the three modes. Data are presented as mean values+/−SD. Scale bars: 10 μm.

FIGS. 28A-B show linewidth, peak position, and lifetime measurements of the 1300 cm⁻¹ peak for Rh800 in different solvents. (FIG. 28A) To fit and extract the linewidth, the BonFTRE spectral data was oversampled by using a 4 cm⁻¹ step size, which is the half of the IR laser bandwidth (8 cm⁻¹). BonFIRE data were obtained from 100 μM Rh800 in each solvent with probe wavelength fixed at 780 nm. The fitted Gaussian peak (black dashed curve) is deconvolved with the laser bandwidth with 8 cm⁻¹ full width at the half maximum (FWHM), lifetime calculated from the FWHM assuming the lifetime-broadening, and lifetime measured directly by BLIM are summarized in (FIG. 28B). The lifetime measured by BLIM is significantly longer than that calculated from linewidth, indicating the 1300 cm⁻¹ peak of Rh800 is not lifetime-broadened.

FIGS. 29A-H show widefield BonFIRE microscopy. (FIG. 29A) Characterization of illumination area of the widefield BonFIRE microscopy with single-molecule sensitivity. The measured radial profile of BonFIRE indicates a 5 μm BonFIRE spot size. More experimental details in Methods in Example 5. Scale bar: 5 μm. (FIG. 29B) Widefield BonFIRE images of single ATTO680 molecules embedded in PVA matrix. Each BonFIRE frame is a single field of view (FOV) obtained using widefield illumination and 5 s camera exposure time. The clear contrast between on (1598 cm⁻¹) and off (others) frames indicates the single-molecule sensitivity. Three single molecules (i, ii, and iii) are highlighted with dashed circles in the first on-resonance frame. (FIG. 29C) In-situ BonFIRE spectra and Gaussian fittings obtained from molecules i, ii, and iii. After the BonFIRE imaging, the same FOV was illuminated with a probe beam with increased power (2 mW on sample) to obtain single-molecule photobleaching curves. (FIG. 29D) A representative single-molecule blinking time trace obtained from the single molecule i, proving the sample quality. The fluorescence readings were corrected by subtracting the baseline due to the system offset of the sCMOS detector. (FIGS. 29E-F) Widefield BonFIRE images of single BF1-conjugated antibodies (FIG. 29E) and representative in-situ spectra from three single molecules (labeled as i, ii, and iii in the 1601 cm⁻¹ frame, FIG. 29F). Similar to FIG. 19A, fluorescence signals in both 0-ps and 20-ps frames were confirmed to rule out any false results caused by photobleaching/blinking. Scale bars in (FIG. 29B) & (FIG. 29E): 1 μm. (FIGS. 29G1-H) Widefield BonFIRE image of ATTO680-EdU-labelled HeLa nucleus at 1598 cm⁻¹. Using an evenly illuminated 3×3 μm² BonFIRE FOV, each FOV can be acquired at the video rate (e.g., 2 ms per frame, FIGS. 29G1-3) and stitched together to form a large-area BonFIRE image (FIG. 29H). The stitched large-area (87×87 μm²) image with 406×406 pixels was captured within 51 s, about 30 times faster than using the point-scan scheme with same parameters (i.e., pixel size and dwell time). It is noted here, the imaging speed for the stitching is limited by the movement speed of the piezostage and the time needed for the synchronization between the camera and PC using a customized LabVIEW code (˜60 ms per step), not by the imaging acquisition speed (2 ms per frame). The scanning and stitching speed could be further improved by enlarging the FOV. Scale bars are 1 μm in (FIGS. 29G1-3) and 10 μm in (FIG. 29H).

FIGS. 30A-K show characterization of WF-BonFIRE spectroscopy and imaging performance. (FIG. 30A) BonFIRE signal as a function of temporal delay (t_{D}). (FIG. 30B) BonFIRE image generated by subtracting two images acquired at temporal delays t0 and t1. (FIG. 30c) Overlay plot of WF-BonFIRE (black) and FTIR (red) spectra of Rh800. (FIG. 30D) Montage BonFIRE image of copolymer film acquired using Mode 1 at 1510 cm⁻¹. Acquisition area: 100×100 μm. (FIG. 30E) Single field-of-view BonFIRE image indicated red in (FIG. 30D). Exposure time: 17.6 us. (FIG. 30F) BonFIRE image of single-molecule Rh800 using Mode 1 at 1598 cm⁻¹. Exposure time: 200 ms. (FIG. 30G) X profile of the single molecule indicated with yellow arrow in (FIG. 30F). (FIG. 30H) BonFIRE image of single-molecule Rh800 using shorter exposure time of 20 ms. (FIG. 30I) Temporal sweep of single molecules i), ii), and iii) in (FIG. 30H). SNR, 11.5. (J) Montage BonFIRE image of copolymer film acquired using Mode 2 at 1510 cm⁻¹. Acquisition area: 200×200 μm. (FIG. 30K) Single field-of-view BonFIRE image indicated red in (FIG. 30J). Exposure time: 500 us.

FIGS. 31A-D show large area WF-BonFIRE imaging of biological samples. (FIG. 31A) On-resonance (left, 1,598 cm⁻¹) and off-resonance (top right, 1,700 cm⁻¹) montage WF-BonFIRE images of C═C vibration in ATTO680-immunolabeled GFAP in mouse neuronal co-cultures. Acquisition area: 200×200 μm. (FIG. 31B) Montage WF-BonFIRE image targeting C═C vibration in ATTO680-click-labelled EdU in the nuclei of HeLa cells. Acquisition area: 200×200 μm. (FIG. 31C) Montage WF-BonFIRE image of C═C vibrations in ATTO680-immunolabelled a-tubulin in HeLa cells. Acquisition area: 200×200 μm. (FIG. 31D) Montage WF-BonFIRE image of C═C vibrations of Rh800 staining mitochondria in live neurons. Acquisition area: 100×100 μm.

FIGS. 32A-F show ultrafast WF-BonFIRE imaging using temporal delay modulation. (FIG. 32A-B) Experimental set-up of temporal delay modulation involving Path 1 (FIG. 32A) and Path 2 (FIG. 32B). Path 1 (FIG. 32A) and Path 2 (FIG. 32B), which have varying path lengths (Δl), introduce different temporal delays (t₀ and t₁) to the pulse trains. A chopper ensures that pulse trains from only one path reach the sample at any given time. (FIG. 32C) Pulse trains from Path 1 (blue), Path 2 (red), and after combination at beam splitter BS2 (Recombined). (FIG. 32D) Wiring diagram for camera-chopper synchronization. (FIG. 32E) Synchronization timing chart. (FIG. 32F) BonFIRE images acquired using temporal delay modulation. These images, captured using pulse trains from Path 1 (Path 1 (t0)) and Path 2 (Path 2 (t1)), were subtracted to produce a BonFIRE image (Iₜ₀−Iₜ₁). FPS, 300 Hz. Scale bars, 10 μm.

FIG. 33 shows ultrafast WF-BonFIRE imaging capturing Brownian motion in Rh800-stained E. coli at 150 frames per second (FPS) using temporal delay modulation.

FIGS. 34A-B show BonFIRE signal estimation with varying lifetimes of intermediate state (N2). (FIG. 34A) The energy diagram of a three-level system used for the simulation. (FIG. 34B) Result from rate equation simulations, which utilize molecular balances of each energy state to compute the population of the electronic excited state (N3)1. Probe power on-sample is 0.1 mW, with IR power at 10 mW. The pulse duration is 2 μs. Lifetimes of virtual states (1-100 fs) and vibrational states (1-2 ps) for typical vibrational modes (e.g., double bonds, nitriles) are highlighted in grey and yellow, respectively. An increase in N3 population ranging from 5- to 500-fold is observed as intermediate state lifetimes extend from virtual to vibrational state, indicating efficient vibronic excitation.

FIG. 35 shows BonFIRE signal estimation at varying field-of-view size using Rh800 as detailed in Example 12.

FIG. 36 shows BonFIRE speed estimation relative to PT-BonFIRE as detailed in Example 13.

FIGS. 37A-B3 depicts magnification characterization. FIG. 37A shows normalized pixel intensity (a.u.) vs pixels. Profiles of 100 nm beads were imaged at different stage position FIG. 37B1: i) X=0 μm, FIG. 37B2: ii) X=10 μm, FIG. 37B3: iii) X=20 μm. The resulting pixel size and magnification are 10 μm/(95−52)=0.233 μm and 6.5 μm/0.233 μm=27.9×, which agrees with the theoretical magnification determined by the effective focal lengths of the objective and the tube lens (200 mm/7.2 mm=27.8×).

FIG. 38 shows absorption and emission spectra of Rh800. The blue indicates collection window, whereas the red and grey line indicates sum frequency and probe wavelength, respectively.

FIG. 39A shows temporal sweep of Rh800 polymer sample. Identical to FIG. 30A. FIG. 39B shows fluorescence images corresponding to different temporal delays t_{D}.

FIGS. 40A-D show field-of-view characterizations of Mode 1 and Mode 2. (FIG. 40A) BonFIRE image polymer film using Mode 1. (FIG. 40B) Spatial profile of (FIG. 40A) across white dotted line. 1/e² diameter: 12.5 μm. (FIG. 40C) BonFIRE image polymer film using Mode 2. (FIG. 40D) Spatial profile of (FIG. 40C) across white dotted line 1/e² diameter: 49.5 μm.

FIGS. 41A-B show BonFIRE signal (FIG. 41A) probe power dependence and (FIG. 41B) IR power dependence.

FIGS. 42A-D show BonFIRE images of polymer samples using Mode 1 at (FIG. 42A) 1505 cm⁻¹ and (FIG. 42B) 1700 cm⁻¹ and Mode 2 at (FIG. 42C) 1505 cm⁻¹ and (FIG. 42D) 1700 cm⁻¹.

FIGS. 43A-D show (FIG. 43A) BonFIRE image of single-molecule sample at 200 ms exposure time. Identical to FIG. 30F. (FIG. 43B) Single step photobleaching curve of molecule i) in (FIG. 43A). (FIG. 43C) X profile of the single molecule ii) in (FIG. 43A). Identical to FIG. 30G. (FIG. 43D) Temporal sweep of molecule ii) in (FIG. 43A). SNR, 48.5.

FIGS. 44A-B show comparison between (FIG. 44A) large-area WF-BonFIRE imaging and (FIG. 44B) ultrafast WF-BonFIRE imaging using temporal delay modulation.

FIGS. 45A-C show temporal modulation at shifted delay stage position. BonFIRE image (I_{t0′}−I_{t1′}) (FIG. 45C) was generated by subtracting image I_{t1′} (FIG. 45B) from I_{t0′} (FIG. 45A). Each image was acquired at temporal delay t0′ and t1′, where both temporal delay positions result in temporally misaligned IR and probe pulses. Subtraction of the two images result in dark image with close to 0 intensities, indicating absence of artifacts caused by temporal delay modulation scheme. FPS, 300 Hz, exposure, 1 ms.

FIGS. 46A-C show temporal delay modulation at triple bond frequency using Rh800 copolymer sample. BonFIRE image (Iₜ₀−Iₜ₁) (FIG. 46C) was generated by subtracting image It0 (FIG. 46A) and It1 (FIG. 46B), where each image was acquired at temporal delay t0 and t1. FPS, 100 Hz, exposure, 4 ms.

FIGS. 47A-B show Iₜ₀ and Iₜ₁ images used to generate BonFIRE images for FIG. 33.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

As used herein, a dye refers to a chromophore or a molecule containing the chromophore which has an UV-vis absorption maximum, typically having a wavelength of the UV-vis absorption maximum in the range of 400 nm to 800 nm. Typically, the dye as used herein is also a fluorophore which has a fluorescence emission maximum at a wavelength in the range of 400 nm to 850 nm.

The chromophore can be an organic moiety covalently conjugated to a structural unit of a sample. For example, Example 11 depicts BF1 chromophore (an organic moiety) covalently conjugated to HeLa-CCL2 cells via Click-reaction of EdU labeled cells. In some embodiment a dye can be a dye molecule, which can be an organic molecule having a molecular weight ranging from 100 to 1000 Daltons. Still, a dye can be a naturally occurring protein or a genetically engineer protein.

BonFIRE is an acronym for bond-selective fluorescence-detected infrared-excited spectroscopy or microscopy. As used herein, BonFIRE refers the technique of employing nonlinear mid-IR-near-IR double-resonance excitation, which upconverts the vibrational excitation of a selected chemical bond of a dye to an electronic state of the dye for fluorescence detection.

As used herein, field-of-view (FOV) refers to a dimension of an object detected by the WF-BonFIRE spectroscopy or microscopy. When the object detected is a circle in shape, the dimension refers to the diameter of the circle. When the object detected is a square in shape, the dimension refers to the length of a side of the square. When the object detected is a shape otherwise specified, the FOV refers to an equivalent diameter which is the diameter of a circle which has an equal area as the shape otherwise specified.

WF-BonFIRE is an acronym for wide-field bond-selective fluorescence-detected infrared-excited spectroscopy or microscopy. As used herein, WF-BonFIRE refers to BonFIRE that is capable of fast imaging speed over the entire field-of-view (FOV). Typically, the imaging speed of WF-BonFIRE is at least 20 frames per second (FPS), and can be, for example, 100, 1000, 2000, 4000, 5000, 6000, 7000, 8000, 9000, or 10000 FPS or any speed therebetween. Typically, the field-of-view (FOV) for the WF-BonFIRE is at least 1 μm in diameter, and can be 2, 5, 10, 12.5, 25, 50, 75, 100 μm in dimension or diameter.

Disclosed herein includes a method of bond-selective fluorescence-detected infrared-excited (BonFIRE) spectroscopy, the method comprising providing a sample comprising a dye molecule wherein the dye molecule has an UV-vis absorption maximum; generating an IR laser and a NIR laser, wherein the IR laser and the NIR laser are coherent; aligning the IR laser and the NIR laser in a counter-propagating configuration on the sample; irradiating the dye molecule with the IR laser and the NIR laser; and detecting a fluorescence from the dye molecule.

The method as described herein further comprises extracting a bond-selective IR absorption maximum of the dye molecule from the fluorescence. The method as described herein further comprises selecting a total energy of a photon of the IR laser and a photon of the NIR laser to be about equal to the energy of the UV-vis absorption maximum.

The UV-vis absorption maximum ranges from 400-800 nm. In some embodiments, the UV-vis absorption maximum of the dye can have any of the absorption peaks listed in Table 1, including, for example, 444, 635, 646, 647, 662, 680, 681, 684, 695, 696, 728, 735, 743, 749, 750, 782, 788 nm. The IR laser can have a wave number ranging from 800-4800 cm¹. In some embodiments, the IR laser can have a wave number equal to the vibrational peaks listed in Table 1. The NIR laser can have a wavelength ranging from 700-960 nm.

In some embodiments, the IR laser has a duration ranging from 0.1 to 10 picoseconds, or 0.1, 0.2, 0.5, 0.8, 1.0, 1.1, 1.2, 1.5, 1.8, 2.0, 2.5, 3.0, 3.5, 4.0, 4.5, 5.0, 5.5, 6.0, 6.5, 7.0, 7.5, 8.0, 8.5, 9.0, 9.5, or, 10.0 picoseconds, including ranges between any two of the values therein, for example, 0.1 to 0.2, 0.1 to 0.5, 0.1 to 0.8, 0.1 to 1.0, 0.1 to 1.1, 0.1 to 1.2, 0.1 to 1.5, 0.1 to 1.8, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 6.0, 0.1 to 6.5, 0.1 to 7.0, 0.1 to 7.5, 0.1 to 8.0, 0.1 to 8.5, 0.1 to 9.0, 0.1 to 9.5, or 0.1 to 10.0 picoseconds; 0.2 to 0.5, 0.2 to 0.8, 0.2 to 1.0, 0.2 to 1.1, 0.2 to 1.2, 0.2 to 1.5, 0.2 to 1.8, 0.2 to 2.0, 0.2 to 2.5, 0.2 to 3.0, 0.2 to 3.5, 0.2 to 4.0, 0.2 to 4.5, 0.2 to 5.0, 0.2 to 5.5, 0.2 to 6.0, 0.2 to 6.5, 0.2 to 7.0, 0.2 to 7.5, 0.2 to 8.0, 0.2 to 8.5, 0.2 to 9.0, 0.2 to 9.5, or 0.2 to 10.0 picoseconds; 0.5 to 0.8, 0.5 to 1.0, 0.5 to 1.1, 0.5 to 1.2, 0.5 to 1.5, 0.5 to 1.8, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 0.5 to 6.0, 0.5 to 6.5, 0.5 to 7.0, 0.5 to 7.5, 0.5 to 8.0, 0.5 to 8.5, 0.5 to 9.0, 0.5 to 9.5, or, 0.5 to 10.0 picoseconds; or 1.0 to 1.1, 1.0 to 1.2, 1.0 to 1.5, 1.0 to 1.8, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.5, 1.0 to 9.0, 1.0 to 9.5, or 1.0 to 10.0 picoseconds.

In some embodiments, the NIR laser independently has a duration ranging from 0.1 to 10 picoseconds or 0.1, 0.2, 0.5, 0.8, 1.0, 1.1, 1.2, 1.5, 1.8, 2.0, 2.5, 3.0, 3.5, 4.0, 4.5, 5.0, 5.5, 6.0, 6.5, 7.0, 7.5, 8.0, 8.5, 9.0, 9.5, or, 10.0 picoseconds, including ranges between any two of the values therein, for example, 0.1 to 0.2, 0.1 to 0.5, 0.1 to 0.8, 0.1 to 1.0, 0.1 to 1.1, 0.1 to 1.2, 0.1 to 1.5, 0.1 to 1.8, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 6.0, 0.1 to 6.5, 0.1 to 7.0, 0.1 to 7.5, 0.1 to 8.0, 0.1 to 8.5, 0.1 to 9.0, 0.1 to 9.5, or 0.1 to 10.0 picoseconds; 0.2 to 0.5, 0.2 to 0.8, 0.2 to 1.0, 0.2 to 1.1, 0.2 to 1.2, 0.2 to 1.5, 0.2 to 1.8, 0.2 to 2.0, 0.2 to 2.5, 0.2 to 3.0, 0.2 to 3.5, 0.2 to 4.0, 0.2 to 4.5, 0.2 to 5.0, 0.2 to 5.5, 0.2 to 6.0, 0.2 to 6.5, 0.2 to 7.0, 0.2 to 7.5, 0.2 to 8.0, 0.2 to 8.5, 0.2 to 9.0, 0.2 to 9.5, or 0.2 to 10.0 picoseconds; 0.5 to 0.8, 0.5 to 1.0, 0.5 to 1.1, 0.5 to 1.2, 0.5 to 1.5, 0.5 to 1.8, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 0.5 to 6.0, 0.5 to 6.5, 0.5 to 7.0, 0.5 to 7.5, 0.5 to 8.0, 0.5 to 8.5, 0.5 to 9.0, 0.5 to 9.5, or 0.5 to 10.0 picoseconds; or 1.0 to 1.1, 1.0 to 1.2, 1.0 to 1.5, 1.0 to 1.8, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.5, 1.0 to 9.0, 1.0 to 9.5, or 1.0 to 10.0 picoseconds.

In some embodiments, the IR laser has duration of 2 picoseconds, the NIR laser has a duration of 2 picoseconds, or both.

In some embodiments, the IR laser has a bandwidth ranging from 1 to 25 cm⁻¹, or 1.0, 1.1, 1.2, 1.5, 1.8, 2.0, 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, 15, 16, 17, 18, 19, 20, 21, 22, 23, 24, or 25 cm⁻¹, including ranges between any two of the values therein, for example, 1.0 to 1.1, 1.0 to 1.2, 1.0 to 1.5, 1.0 to 1.8, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 11, 1.0 to 12, 1.0 to 13, 1.0 to 14, 1.0 to 15, 1.0 to 16, 1.0 to 17, 1.0 to 18, 1.0 to 19, 1.0 to 20, 1.0 to 21, 1.0 to 22, 1.0 to 23, 1.0 to 24, or 25 cm⁻¹, 1.5 to 1.8, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 1.5 to 6.0, 1.5 to 6.5, 1.5 to 7.0, 1.5 to 7.5, 1.5 to 8.0, 1.5 to 8.5, 1.5 to 9.0, 1.5 to 9.5, 1.5 to 10.0, 1.5 to 11, 1.5 to 12, 1.5 to 13, 1.5 to 14, 1.5 to 15, 1.5 to 16, 1.5 to 17, 1.5 to 18, 1.5 to 19, 1.5 to 20, 1.5 to 21, 1.5 to 22, 1.5 to 23, 1.5 to 24, or 1.5 to 25 cm⁻¹, 2.0 to 2.5, 2.0 to 3.0, 2.0 to 3.5, 2.0 to 4.0, 2.0 to 4.5, 2.0 to 5.0, 2.0 to 5.5, 2.0 to 6.0, 2.0 to 6.5, 2.0 to 7.0, 2.0 to 7.5, 2.0 to 8.0, 2.0 to 8.5, 2.0 to 9.0, 2.0 to 9.5, 2.0 to 10.0, 2.0 to 11, 2.0 to 12, 2.0 to 13, 2.0 to 14, 2.0 to 15, 2.0 to 16, 2.0 to 17, 2.0 to 18, 2.0 to 19, 2.0 to 20, 2.0 to 21, 2.0 to 22, 2.0 to 23, 2.0 to 24, or 2.0 to 25 cm⁻¹, 3.0 to 3.5, 3.0 to 4.0, 3.0 to 4.5, 3.0 to 5.0, 3.0 to 5.5, 3.0 to 6.0, 3.0 to 6.5, 3.0 to 7.0, 3.0 to 7.5, 3.0 to 8.0, 3.0 to 8.5, 3.0 to 9.0, 3.0 to 9.5, 3.0 to 10.0, 3.0 to 11, 3.0 to 12, 3.0 to 13, 3.0 to 14, 3.0 to 15, 3.0 to 16, 3.0 to 17, 3.0 to 18, 3.0 to 19, 3.0 to 20, 3.0 to 21, 3.0 to 22, 3.0 to 23, 3.0 to 24, or 3.0 to 25 cm⁻¹, 4.0 to 4.5, 4.0 to 5.0, 4.0 to 5.5, 4.0 to 6.0, 4.0 to 6.5, 4.0 to 7.0, 4.0 to 7.5, 4.0 to 8.0, 4.0 to 8.5, 4.0 to 9.0, 4.0 to 9.5, 4.0 to 10.0, 4.0 to 11, 4.0 to 12, 4.0 to 13, 4.0 to 14, 4.0 to 15, 4.0 to 16, 4.0 to 17, 4.0 to 18, 4.0 to 19, 4.0 to 20, 4.0 to 21, 4.0 to 22, 4.0 to 23, 4.0 to 24, or 4.0 to 25 cm⁻¹, 5.0 to 5.5, 5.0 to 6.0, 5.0 to 6.5, 5.0 to 7.0, 5.0 to 7.5, 5.0 to 8.0, 5.0 to 8.5, 5.0 to 9.0, 5.0 to 9.5, 5.0 to 10.0, 5.0 to 11, 5.0 to 12, 5.0 to 13, 5.0 to 14, 5.0 to 15, 5.0 to 16, 5.0 to 17, 5.0 to 18, 5.0 to 19, 5.0 to 20, 5.0 to 21, 5.0 to 22, 5.0 to 23, 5.0 to 24, or 5.0 to 25 cm⁻¹, 6.0 to 6.5, 6.0 to 7.0, 6.0 to 7.5, 6.0 to 8.0, 6.0 to 8.5, 6.0 to 9.0, 6.0 to 9.5, 6.0 to 10.0, 6.0 to 11, 6.0 to 12, 6.0 to 13, 6.0 to 14, 6.0 to 15, 6.0 to 16, 6.0 to 17, 6.0 to 18, 6.0 to 19, 6.0 to 20, 6.0 to 21, 6.0 to 22, 6.0 to 23, 6.0 to 24, or 6.0 to 25 cm⁻¹, 7.0 to 7.5, 7.0 to 8.0, 7.0 to 8.5, 7.0 to 9.0, 7.0 to 9.5, 7.0 to 10.0, 7.0 to 11, 7.0 to 12, 7.0 to 13, 7.0 to 14, 7.0 to 15, 7.0 to 16, 7.0 to 17, 7.0 to 18, 7.0 to 19, 7.0 to 20, 7.0 to 21, 7.0 to 22, 7.0 to 23, 7.0 to 24, or 7.0 to 25 cm⁻¹, 8.0 to 8.5, 8.0 to 9.0, 8.0 to 9.5, 8.0 to 10.0, 8.0 to 11, 8.0 to 12, 8.0 to 13, 8.0 to 14, 8.0 to 15, 8.0 to 16, 8.0 to 17, 8.0 to 18, 8.0 to 19, 8.0 to 20, 8.0 to 21, 8.0 to 22, 8.0 to 23, 8.0 to 24, or 8.0 to 25 cm⁻¹.

In some embodiments, the NIR laser has a bandwidth ranging from 1 to 25 cm⁻¹, including, for example, 1.0, 1.1, 1.2, 1.5, 1.8, 2.0, 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, 15, 16, 17, 18, 19, 20, 21, 22, 23, 24, or 25 cm⁻¹, and a range between any two of the values therein, for example, 1.0 to 1.1, 1.0 to 1.2, 1.0 to 1.5, 1.0 to 1.8, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 11, 1.0 to 12, 1.0 to 13, 1.0 to 14, 1.0 to 15, 1.0 to 16, 1.0 to 17, 1.0 to 18, 1.0 to 19, 1.0 to 20, 1.0 to 21, 1.0 to 22, 1.0 to 23, 1.0 to 24, or 25 cm⁻¹, 1.5 to 1.8, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 1.5 to 6.0, 1.5 to 6.5, 1.5 to 7.0, 1.5 to 7.5, 1.5 to 8.0, 1.5 to 8.5, 1.5 to 9.0, 1.5 to 9.5, 1.5 to 10.0, 1.5 to 11, 1.5 to 12, 1.5 to 13, 1.5 to 14, 1.5 to 15, 1.5 to 16, 1.5 to 17, 1.5 to 18, 1.5 to 19, 1.5 to 20, 1.5 to 21, 1.5 to 22, 1.5 to 23, 1.5 to 24, or 1.5 to 25 cm⁻¹, 2.0 to 2.5, 2.0 to 3.0, 2.0 to 3.5, 2.0 to 4.0, 2.0 to 4.5, 2.0 to 5.0, 2.0 to 5.5, 2.0 to 6.0, 2.0 to 6.5, 2.0 to 7.0, 2.0 to 7.5, 2.0 to 8.0, 2.0 to 8.5, 2.0 to 9.0, 2.0 to 9.5, 2.0 to 10.0, 2.0 to 11, 2.0 to 12, 2.0 to 13, 2.0 to 14, 2.0 to 15, 2.0 to 16, 2.0 to 17, 2.0 to 18, 2.0 to 19, 2.0 to 20, 2.0 to 21, 2.0 to 22, 2.0 to 23, 2.0 to 24, or 2.0 to 25 cm⁻¹, 3.0 to 3.5, 3.0 to 4.0, 3.0 to 4.5, 3.0 to 5.0, 3.0 to 5.5, 3.0 to 6.0, 3.0 to 6.5, 3.0 to 7.0, 3.0 to 7.5, 3.0 to 8.0, 3.0 to 8.5, 3.0 to 9.0, 3.0 to 9.5, 3.0 to 10.0, 3.0 to 11, 3.0 to 12, 3.0 to 13, 3.0 to 14, 3.0 to 15, 3.0 to 16, 3.0 to 17, 3.0 to 18, 3.0 to 19, 3.0 to 20, 3.0 to 21, 3.0 to 22, 3.0 to 23, 3.0 to 24, or 3.0 to 25 cm⁻¹, 4.0 to 4.5, 4.0 to 5.0, 4.0 to 5.5, 4.0 to 6.0, 4.0 to 6.5, 4.0 to 7.0, 4.0 to 7.5, 4.0 to 8.0, 4.0 to 8.5, 4.0 to 9.0, 4.0 to 9.5, 4.0 to 10.0, 4.0 to 11, 4.0 to 12, 4.0 to 13, 4.0 to 14, 4.0 to 15, 4.0 to 16, 4.0 to 17, 4.0 to 18, 4.0 to 19, 4.0 to 20, 4.0 to 21, 4.0 to 22, 4.0 to 23, 4.0 to 24, or 4.0 to 25 cm⁻¹, 5.0 to 5.5, 5.0 to 6.0, 5.0 to 6.5, 5.0 to 7.0, 5.0 to 7.5, 5.0 to 8.0, 5.0 to 8.5, 5.0 to 9.0, 5.0 to 9.5, 5.0 to 10.0, 5.0 to 11, 5.0 to 12, 5.0 to 13, 5.0 to 14, 5.0 to 15, 5.0 to 16, 5.0 to 17, 5.0 to 18, 5.0 to 19, 5.0 to 20, 5.0 to 21, 5.0 to 22, 5.0 to 23, 5.0 to 24, or 5.0 to 25 cm⁻¹, 6.0 to 6.5, 6.0 to 7.0, 6.0 to 7.5, 6.0 to 8.0, 6.0 to 8.5, 6.0 to 9.0, 6.0 to 9.5, 6.0 to 10.0, 6.0 to 11, 6.0 to 12, 6.0 to 13, 6.0 to 14, 6.0 to 15, 6.0 to 16, 6.0 to 17, 6.0 to 18, 6.0 to 19, 6.0 to 20, 6.0 to 21, 6.0 to 22, 6.0 to 23, 6.0 to 24, or 6.0 to 25 cm⁻¹, 7.0 to 7.5, 7.0 to 8.0, 7.0 to 8.5, 7.0 to 9.0, 7.0 to 9.5, 7.0 to 10.0, 7.0 to 11, 7.0 to 12, 7.0 to 13, 7.0 to 14, 7.0 to 15, 7.0 to 16, 7.0 to 17, 7.0 to 18, 7.0 to 19, 7.0 to 20, 7.0 to 21, 7.0 to 22, 7.0 to 23, 7.0 to 24, or 7.0 to 25 cm⁻¹, 8.0 to 8.5, 8.0 to 9.0, 8.0 to 9.5, 8.0 to 10.0, 8.0 to 11, 8.0 to 12, 8.0 to 13, 8.0 to 14, 8.0 to 15, 8.0 to 16, 8.0 to 17, 8.0 to 18, 8.0 to 19, 8.0 to 20, 8.0 to 21, 8.0 to 22, 8.0 to 23, 8.0 to 24, or 8.0 to 25 cm⁻¹.

In some embodiments, the IR laser has a bandwidth ranging from 1 to 25 cm⁻¹, the NIR laser has a bandwidth ranging from 1 to 25 cm⁻¹, or both. In some embodiments, the IR laser has a bandwidth of 8 cm⁻¹, the NIR laser has a bandwidth of 8 cm⁻¹, or both.

In some embodiments, the method comprises providing the NIR laser with a temporal delay (t_{D}) ranging from −10 picoseconds to 25 picoseconds. In some embodiments, the method further comprises providing the NIR laser with a temporal delay (t_{D}) ranging from −3 picoseconds to 5 picoseconds. In some embodiments, the temporal delay (t_{D}) is 0 picosecond. In some embodiments, the NIR laser has a temporal delay (t_{D}) ranging from −10 to 25 picoseconds, or −10.0, −9.0, −8.0, −7.0, −6.0, −5.0, −4.0, −3.0, −2.0, −1.0, 0, 1.0, 1.1, 1.2, 1.5, 1.8, 2.0, 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, 15 picoseconds, including ranges between any two of the values therein, for example, −9.0 to −8.0, −9.0 to −7.0, −9.0 to −6.0, −9.0 to −5.0, −9.0 to −4.0, −9.0 to −3.0, −9.0 to −2.0, −9.0 to −1.0, −9.0 to 0, −9.0 to 1.0, −9.0 to 1.1, −9.0 to 1.2, −9.0 to 1.5, −9.0 to 1.8, −9.0 to 2.0, −9.0 to 2.5, −9.0 to 3.0, −9.0 to 3.5, −9.0 to 4.0, −9.0 to 4.5, −9.0 to 5.0, −9.0 to 5.5, −9.0 to 6.0, −9.0 to 6.5, −9.0 to 7.0, −9.0 to 7.5, −9.0 to 8.0, −9.0 to 8.5, −9.0 to 9.0, −9.0 to 9.5, −9.0 to 10.0, −9.0 to 11, −9.0 to 12, −9.0 to 13, −9.0 to 14, or −9.0 to 15 picoseconds; or −8.0 to −7.0, −8.0 to −6.0, −8.0 to −5.0, −8.0 to −4.0, −8.0 to −3.0, −8.0 to −2.0, −8.0 to −1.0, −8.0 to 0, −8.0 to 1.0, −8.0 to 1.1, −8.0 to 1.2, −8.0 to 1.5, −8.0 to 1.8, −8.0 to 2.0, −8.0 to 2.5, −8.0 to 3.0, −8.0 to 3.5, −8.0 to 4.0, −8.0 to 4.5, −8.0 to 5.0, −8.0 to 5.5, −8.0 to 6.0, −8.0 to 6.5, −8.0 to 7.0, −8.0 to 7.5, −8.0 to 8.0, −8.0 to 8.5, −8.0 to 9.0, −8.0 to 9.5, −8.0 to 10.0, −8.0 to 11, −8.0 to 12, −8.0 to 13, −8.0 to 14, or −8.0 to 15 picoseconds; or −7.0 to −6.0, −7.0 to −5.0, −7.0 to −4.0, −7.0 to −3.0, −7.0 to −2.0, −7.0 to −1.0, −7.0 to 0, −7.0 to 1.0, −7.0 to 1.1, −7.0 to 1.2, −7.0 to 1.5, −7.0 to 1.8, −7.0 to 2.0, −7.0 to 2.5, −7.0 to 3.0, −7.0 to 3.5, −7.0 to 4.0, −7.0 to 4.5, −7.0 to 5.0, −7.0 to 5.5, −7.0 to 6.0, −7.0 to 6.5, −7.0 to 7.0, −7.0 to 7.5, −7.0 to 8.0, −7.0 to 8.5, −7.0 to 9.0, −7.0 to 9.5, −7.0 to 10.0, −7.0 to 11, −7.0 to 12, −7.0 to 13, −7.0 to 14, or −7.0 to 15 picoseconds; or −6.0 to −5.0, −6.0 to −4.0, −6.0 to −3.0, −6.0 to −2.0, −6.0 to −1.0, −6.0 to 0, −6.0 to 1.0, −6.0 to 1.1, −6.0 to 1.2, −6.0 to 1.5, −6.0 to 1.8, −6.0 to 2.0, −6.0 to 2.5, −6.0 to 3.0, −6.0 to 3.5, −6.0 to 4.0, −6.0 to 4.5, −6.0 to 5.0, −6.0 to 5.5, −6.0 to 6.0, −6.0 to 6.5, −6.0 to 7.0, −6.0 to 7.5, −6.0 to 8.0, −6.0 to 8.5, −6.0 to 9.0, −6.0 to 9.5, −6.0 to 10.0, −6.0 to 11, −6.0 to 12, −6.0 to 13, −6.0 to 14, or −6.0 to 15 picoseconds; or −5.0 to −4.0, −5.0 to −3.0, −5.0 to −2.0, −5.0 to −1.0, −5.0 to 0, −5.0 to 1.0, −5.0 to 1.1, −5.0 to 1.2, −5.0 to 1.5, −5.0 to 1.8, −5.0 to 2.0, −5.0 to 2.5, −5.0 to 3.0, −5.0 to 3.5, −5.0 to 4.0, −5.0 to 4.5, −5.0 to 5.0, −5.0 to 5.5, −5.0 to 6.0, −5.0 to 6.5, −5.0 to 7.0, −5.0 to 7.5, −5.0 to 8.0, −5.0 to 8.5, −5.0 to 9.0, −5.0 to 9.5, −5.0 to 10.0, −5.0 to 11, −5.0 to 12, −5.0 to 13, −5.0 to 14, or −5.0 to 15 picoseconds; or −4.0 to −3.0, −4.0 to −2.0, −4.0 to −1.0, −4.0 to 0, −4.0 to 1.0, −4.0 to 1.1, −4.0 to 1.2, −4.0 to 1.5, −4.0 to 1.8, −4.0 to 2.0, −4.0 to 2.5, −4.0 to 3.0, −4.0 to 3.5, −4.0 to 4.0, −4.0 to 4.5, −4.0 to 5.0, −4.0 to 5.5, −4.0 to 6.0, −4.0 to 6.5, −4.0 to 7.0, −4.0 to 7.5, −4.0 to 8.0, −4.0 to 8.5, −4.0 to 9.0, −4.0 to 9.5, −4.0 to 10.0, −4.0 to 11, −4.0 to 12, −4.0 to 13, −4.0 to 14, or −4.0 to 15 picoseconds, or −3.0 to −2.0, −3.0 to −1.0, −3.0 to 0, −3.0 to 1.0, −3.0 to 1.1, −3.0 to 1.2, −3.0 to 1.5, −3.0 to 1.8, −3.0 to 2.0, −3.0 to 2.5, −3.0 to 3.0, −3.0 to 3.5, −3.0 to 4.0, −3.0 to 4.5, −3.0 to 5.0, −3.0 to 5.5, −3.0 to 6.0, −3.0 to 6.5, −3.0 to 7.0, −3.0 to 7.5, −3.0 to 8.0, −3.0 to 8.5, −3.0 to 9.0, −3.0 to 9.5, −3.0 to 10.0, −3.0 to 11, −3.0 to 12, −3.0 to 13, −3.0 to 14, or −3.0 to 15 picoseconds; or −2.0 to −1.0, −2.0 to 0, −2.0 to 1.0, −2.0 to 1.1, −2.0 to 1.2, −2.0 to 1.5, −2.0 to 1.8, −2.0 to 2.0, −2.0 to 2.5, −2.0 to 3.0, −2.0 to 3.5, −2.0 to 4.0, −2.0 to 4.5, −2.0 to 5.0, −2.0 to 5.5, −2.0 to 6.0, −2.0 to 6.5, −2.0 to 7.0, −2.0 to 7.5, −2.0 to 8.0, −2.0 to 8.5, −2.0 to 9.0, −2.0 to 9.5, −2.0 to 10.0, −2.0 to 11, −2.0 to 12, −2.0 to 13, −2.0 to 14, or −2.0 to 15 picoseconds; or −1.0 to 0, −1.0 to 1.0, −1.0 to 1.1, −1.0 to 1.2, −1.0 to 1.5, −1.0 to 1.8, −1.0 to 2.0, −1.0 to 2.5, −1.0 to 3.0, −1.0 to 3.5, −1.0 to 4.0, −1.0 to 4.5, −1.0 to 5.0, −1.0 to 5.5, −1.0 to 6.0, −1.0 to 6.5, −1.0 to 7.0, −1.0 to 7.5, −1.0 to 8.0, −1.0 to 8.5, −1.0 to 9.0, −1.0 to 9.5, −1.0 to 10.0, −1.0 to 11, −1.0 to 12, −1.0 to 13, −1.0 to 14, or −1.0 to 15 picoseconds; or 0 to 1.0, 0 to 1.1, 0 to 1.2, 0 to 1.5, 0 to 1.8, 0 to 2.0, 0 to 2.5, 0 to 3.0, 0 to 3.5, 0 to 4.0, 0 to 4.5, 0 to 5.0, 0 to 5.5, 0 to 6.0, 0 to 6.5, 0 to 7.0, 0 to 7.5, 0 to 8.0, 0 to 8.5, 0 to 9.0, 0 to 9.5, 0 to 10.0, 0 to 11, 0 to 12, 0 to 13, 0 to 14, or 0 to 15 picoseconds; or 1.0 to 1.1, 1.0 to 1.2, 1.0 to 1.5, 1.0 to 1.8, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 11, 1.0 to 12, 1.0 to 13, 1.0 to 14, or 1.0 to 15 picoseconds.

In some embodiments, the sample comprises a single dye molecule, that is the sample comprises no other dye than the single dye molecule. The dye molecule can be, for example, Coumarin 6, Nile Blue A, CY5, ATTO 647N, Alexa Fluor 647, Cy5.5, CY7, Cy7.5, ATTO680, BF1, Rh800, BF2, BF3, BF4, and any derivatives thereof.

The dye molecule can be a naturally occurring fluorophore (e.g., a fluorophore naturally present in a cell), or a bioengineered fluorophore (e.g., an engineered fluorophore that is present in a cell). In some embodiments, the natural fluorophore is selected from the group consisting of FAD and NADH. In some embodiments, the bioengineered fluorophore is selected from the group consisting of green fluorescent protein (GFP), blue fluorescent protein (e.g., EBFP, EBFP2, Azurite, or mKalama1), cyan fluorescent protein (e.g., ECFP, Cerulean, CyPet, or mTurquoise2), and yellow fluorescent protein derivatives (e.g., YFP, Citrine, Venus, or YPet).

The dye molecule can comprise, e.g., one or more isotopologues of conjugated carbon-carbon triple bond (C≡C) and/or conjugated carbon-nitrogen triple bond (C≡N), wherein the carbon is 12C or 13C and the nitrogen is 14N or 15N. In some embodiments, the conjugated carbon-carbon triple bond (C≡C) and/or conjugated carbon-nitrogen triple bond (C≡N) are conjugated to an aromatic ring or a heteroaromatic ring of the chromophore of the dye molecule.

In some embodiments, the separation in bond-selective IR absorption maxima of two of the one or more isotopologues of the dye molecule is about equal to or more than half of the summation of the full width at half maximum (FWHM) of the two of the one or more isotopologues of the dye molecule. The IR absorption maximum of the dye molecule can fall within the range from 800-3300 cm⁻¹. The IR absorption maximum of the dye molecule can fall within the range from 800-1800 cm⁻¹. The IR absorption maximum of the dye molecule falls within the range from 1800-2800 cm⁻¹.

The method can comprise obtaining an image of the sample from the fluorescence. The method as described herein, can further comprise obtaining a plurality of images of the sample from the fluorescence, wherein the plurality of images each corresponds to one of a plurality of temporal delays (t_{D}). The method as described herein, can further comprise obtaining a vibrational relaxation lifetime of a chemical bond associated with the fluorescence. The sample can be a neuron, cell, cancer cell, or a tissue.

In some embodiments, the dye is chemically conjugated to a structural unit of the sample. The dye can be, or comprise, ATTO680, wherein the ATTO680 is azide-click-labeled to 5-ethynyl-2′-deoxyuridine (EdU) of the sample. In some embodiments, the dye is physically embedded in the sample.

In some embodiments, the method comprises passing the IR laser through an acoustic optical modulator (AOM) to obtain a first-order diffraction IR laser before aligning the IR laser and the NIR laser in a counter-propagating configuration on the sample.

In some embodiments, the detecting a fluorescence from the dye molecule was performed with a photomultiplier tube (PMT), wherein the BonFIRE microscopy is background-free.

In some embodiments, the detecting a fluorescence from the dye molecule was performed with a photomultiplier tube (PMT), wherein the BonFIRE microscopy has a signal to background ratio (S/B) ranging from 2 to 100, or 2, 5, 10, 15, 20, 25, 30, 35, 40, 45, 50, 55, 60, 65, 70, 75, 80, 85, 90, 95, 100, including ranges between any two of the values therein, for example, 2 to 5, 2 to 10, 2 to 15, 2 to 20, 2 to 25, 2 to 30, 2 to 35, 2 to 40, 2 to 45, 2 to 50, 2 to 55, 2 to 60, 2 to 65, 2 to 70, 2 to 75, 2 to 80, 2 to 85, 2 to 90, 2 to 95, 2 to 100, 5 to 10, 5 to 15, 5 to 20, 5 to 25, 5 to 30, 5 to 35, 5 to 40, 5 to 45, 5 to 50, 5 to 55, 5 to 60, 5 to 65, 5 to 70, 5 to 75, 5 to 80, 5 to 85, 5 to 90, 5 to 95, 5 to 100, 10 to 15, 10 to 20, 10 to 25, 10 to 30, 10 to 35, 10 to 40, 10 to 45, 10 to 50, 10 to 55, 10 to 60, 10 to 65, 10 to 70, 10 to 75, 10 to 80, 10 to 85, 10 to 90, 10 to 95, 10 to 100, 15 to 20, 15 to 25, 15 to 30, 15 to 35, 15 to 40, 15 to 45, 15 to 50, 15 to 55, 15 to 60, 15 to 65, 15 to 70, 15 to 75, 15 to 80, 15 to 85, 15 to 90, 15 to 95, 15 to 100, 20 to 25, 20 to 30, 20 to 35, 20 to 40, 20 to 45, 20 to 50, 20 to 55, 20 to 60, 20 to 65, 20 to 70, 20 to 75, 20 to 80, 20 to 85, 20 to 90, 20 to 95, 20 to 100, 25 to 30, 25 to 35, 25 to 40, 25 to 45, 25 to 50, 25 to 55, 25 to 60, 25 to 65, 25 to 70, 25 to 75, 25 to 80, 25 to 85, 25 to 90, 25 to 95, 25 to 100, 30 to 35, 30 to 40, 30 to 45, 30 to 50, 30 to 55, 30 to 60, 30 to 65, 30 to 70, 30 to 75, 30 to 80, 30 to 85, 30 to 90, 30 to 95, 30 to 100, 35 to 40, 35 to 45, 35 to 50, 35 to 55, 35 to 60, 35 to 65, 35 to 70, 35 to 75, 35 to 80, 35 to 85, 35 to 90, 35 to 95, 35 to 100, 40 to 45, 40 to 50, 40 to 55, 40 to 60, 40 to 65, 40 to 70, 40 to 75, 40 to 80, 40 to 85, 40 to 90, 40 to 95, and 40 to 100.

In some embodiments, the detecting a fluorescence from the dye molecule was performed with a photomultiplier tube (PMT), wherein the BonFIRE microscopy has a signal to background ratio (S/B) ranging from 5 to 50.

In some embodiments, the detecting a fluorescence from the dye molecule was performed with a photomultiplier tube (PMT), wherein the BonFIRE microscopy has a signal to background ratio (S/B) ranging from 15 to 20.

In some embodiments, the BonFIRE microscopy has a signal to noise ratio (S/N) ranging from 2 to 100, or 2, 5, 10, 15, 20, 25, 30, 35, 40, 45, 50, 55, 60, 65, 70, 75, 80, 85, 90, 95, 100, including ranges between any two of the values therein, for example, 2 to 5, 2 to 10, 2 to 15, 2 to 20, 2 to 25, 2 to 30, 2 to 35, 2 to 40, 2 to 45, 2 to 50, 2 to 55, 2 to 60, 2 to 65, 2 to 70, 2 to 75, 2 to 80, 2 to 85, 2 to 90, 2 to 95, 2 to 100, 5 to 10, 5 to 15, 5 to 20, 5 to 25, 5 to 30, 5 to 35, 5 to 40, 5 to 45, 5 to 50, 5 to 55, 5 to 60, 5 to 65, 5 to 70, 5 to 75, 5 to 80, 5 to 85, 5 to 90, 5 to 95, 5 to 100, 10 to 15, 10 to 20, 10 to 25, 10 to 30, 10 to 35, 10 to 40, 10 to 45, 10 to 50, 10 to 55, 10 to 60, 10 to 65, 10 to 70, 10 to 75, 10 to 80, 10 to 85, 10 to 90, 10 to 95, 10 to 100, 15 to 20, 15 to 25, 15 to 30, 15 to 35, 15 to 40, 15 to 45, 15 to 50, 15 to 55, 15 to 60, 15 to 65, 15 to 70, 15 to 75, 15 to 80, 15 to 85, 15 to 90, 15 to 95, 15 to 100, 20 to 25, 20 to 30, 20 to 35, 20 to 40, 20 to 45, 20 to 50, 20 to 55, 20 to 60, 20 to 65, 20 to 70, 20 to 75, 20 to 80, 20 to 85, 20 to 90, 20 to 95, 20 to 100, 25 to 30, 25 to 35, 25 to 40, 25 to 45, 25 to 50, 25 to 55, 25 to 60, 25 to 65, 25 to 70, 25 to 75, 25 to 80, 25 to 85, 25 to 90, 25 to 95, 25 to 100, 30 to 35, 30 to 40, 30 to 45, 30 to 50, 30 to 55, 30 to 60, 30 to 65, 30 to 70, 30 to 75, 30 to 80, 30 to 85, 30 to 90, 30 to 95, 30 to 100, 35 to 40, 35 to 45, 35 to 50, 35 to 55, 35 to 60, 35 to 65, 35 to 70, 35 to 75, 35 to 80, 35 to 85, 35 to 90, 35 to 95, 35 to 100, 40 to 45, 40 to 50, 40 to 55, 40 to 60, 40 to 65, 40 to 70, 40 to 75, 40 to 80, 40 to 85, 40 to 90, 40 to 95, and 40 to 100.

In some embodiments, the BonFIRE microscopy has a signal to noise ratio (S/N) ranging from 5 to 50. The BonFIRE microscopy has a signal to noise ratio (S/N) ranging from 15 to 20. The sample can be a dividing live cell and a plurality of images of the dividing cell is obtained at each interval of time of 1 to 60 minutes for a period of 10 minutes to 24 hours. The each interval of time is 5 minutes and the period is 20 minutes.

The method includes a wide-field BonFIRE microscopy having a field of view ranging from 1 to 25 μm in dimension or about 12.5 μm in dimension. In another embodiment of wide-field BonFIRE microscopy, the method includes a field of view ranging from 25 to 100 μm in dimension or being about 50 μm in dimension.

The method includes a wide-field BonFIRE microscopy having a detection limit ranging from 0.01 nM to 50 nM, from 0.1 nM to 10 nM or being about 0.5 nM.

The method can include an acquisition speed ranging from 20 to 10,000 frames per second (fps), from 100 to 3,000 fps or being about 2,100 fps.

In some embodiments, a system for bond-selective fluorescence-detected infrared-excited (BonFIRE) spectroscopy, the system comprising a piezo stage for holding a sample comprising a dye molecule wherein the dye molecule has an UV-vis absorption maximum; a laser source for an IR-OPO (optical parametric oscillator), and a NIR-OPO for generating an IR laser and a NIR laser, respectively, wherein the IR laser and the NIR laser are coherent and, wherein the IR-OPO was followed by and optically connected to a DFG (difference frequency generation), optionally followed by and optically connected to an acoustic optical modulator (AOM), and the NIR-OPO is preceded by a SHG (second-harmonic generation), and a SPCM (single-photon counting module) or a photomultiplier tube (PMT) for detecting a fluorescence from the dye molecule. In some embodiment the system as described herein comprises the acoustic optical modulator (AOM), and the photomultiplier tube (PMT), wherein the acoustic optical modulator (AOM) and the photomultiplier tube (PMT) are communicatively electrically connected to a lock-in amplifier, wherein the acoustic optical modulator (AOM) is controlled by a trigger source which produces a modulation frequency.

In some embodiments, in the system as described herein, the modulation frequency ranges from 0.1 to 10 MHz, or 0.1, 0.5, 1.0, 1.2, 1.5, 1.8, 2.0, 2.2, 2.5, 2.8, 3.0, 3.2, 3.5, 3.8, 4.0, 5.0, 6.0, 7.0, 8.0, 9.0, 10.0 MHz, including ranges between any two of the values therein, for example, 0.1 to 0.5, 0.1 to 1.0, 0.1 to 1.2, 0.1 to 1.5, 0.1 to 1.8, 0.1 to 2.0, 0.1 to 2.2, 0.1 to 2.5, 0.1 to 2.8, 0.1 to 3.0, 0.1 to 3.2, 0.1 to 3.5, 0.1 to 3.8, 0.1 to 4.0, 0.1 to 5.0, 0.1 to 6.0, 0.1 to 7.0, 0.1 to 8.0, 0.1 to 9.0, or 0.1 to 10.0 MHz; or 0.5 to 1.0, 0.5 to 1.2, 0.5 to 1.5, 0.5 to 1.8, 0.5 to 2.0, 0.5 to 2.2, 0.5 to 2.5, 0.5 to 2.8, 0.5 to 3.0, 0.5 to 3.2, 0.5 to 3.5, 0.5 to 3.8, 0.5 to 4.0, 0.5 to 5.0, 0.5 to 6.0, 0.5 to 7.0, 0.5 to 8.0, 0.5 to 9.0, or 0.5 to 10.0 MHz; or 1.0 to 1.2, 1.0 to 1.5, 1.0 to 1.8, 1.0 to 2.0, 1.0 to 2.2, 1.0 to 2.5, 1.0 to 2.8, 1.0 to 3.0, 1.0 to 3.2, 1.0 to 3.5, 1.0 to 3.8, 1.0 to 4.0, 1.0 to 5.0, 1.0 to 6.0, 1.0 to 7.0, 1.0 to 8.0, 1.0 to 9.0, or 1.0 to 10.0 MHz; or 1.2 to 1.5, 1.2 to 1.8, 1.2 to 2.0, 1.2 to 2.2, 1.2 to 2.5, 1.2 to 2.8, 1.2 to 3.0, 1.2 to 3.2, 1.2 to 3.5, 1.2 to 3.8, 1.2 to 4.0, 1.2 to 5.0, 1.2 to 6.0, 1.2 to 7.0, 1.2 to 8.0, 1.2 to 9.0, or 1.2 to 10.0 MHz; or 1.5 to 1.8, 1.5 to 2.0, 1.5 to 2.2, 1.5 to 2.5, 1.5 to 2.8, 1.5 to 3.0, 1.5 to 3.2, 1.5 to 3.5, 1.5 to 3.8, 1.5 to 4.0, 1.5 to 5.0, 1.5 to 6.0, 1.5 to 7.0, 1.5 to 8.0, 1.5 to 9.0, 1.5 to 10.0 MHz, 1.8 to 2.0, 1.8 to 2.2, 1.8 to 2.5, 1.8 to 2.8, 1.8 to 3.0, 1.8 to 3.2, 1.8 to 3.5, 1.8 to 3.8, 1.8 to 4.0, 1.8 to 5.0, 1.8 to 6.0, 1.8 to 7.0, 1.8 to 8.0, 1.8 to 9.0, or 1.8 to 10.0 MHz; or 2.0 to 2.2, 2.0 to 2.5, 2.0 to 2.8, 2.0 to 3.0, 2.0 to 3.2, 2.0 to 3.5, 2.0 to 3.8, 2.0 to 4.0, 2.0 to 5.0, 2.0 to 6.0, 2.0 to 7.0, 2.0 to 8.0, 2.0 to 9.0, or 2.0 to 10.0 MHz, or 2.2 to 2.5, 2.2 to 2.8, 2.2 to 3.0, 2.2 to 3.2, 2.2 to 3.5, 2.2 to 3.8, 2.2 to 4.0, 2.2 to 5.0, 2.2 to 6.0, 2.2 to 7.0, 2.2 to 8.0, 2.2 to 9.0, or 2.2 to 10.0 MHz; or 2.5 to 2.8, 2.5 to 3.0, 2.5 to 3.2, 2.5 to 3.5, 2.5 to 3.8, 2.5 to 4.0, 2.5 to 5.0, 2.5 to 6.0, 2.5 to 7.0, 2.5 to 8.0, 2.5 to 9.0, 2.5 to 10.0 MHz, 2.8 to 3.0, 2.8 to 3.2, 2.8 to 3.5, 2.8 to 3.8, 2.8 to 4.0, 2.8 to 5.0, 2.8 to 6.0, 2.8 to 7.0, 2.8 to 8.0, 2.8 to 9.0, 2.8 to 10.0 MHz, 3.0 to 3.2, 3.0 to 3.5, 3.0 to 3.8, 3.0 to 4.0, 3.0 to 5.0, 3.0 to 6.0, 3.0 to 7.0, 3.0 to 8.0, 3.0 to 9.0, or 3.0 to 10.0 MHz.

The system as described herein can include an optical chopper on a first path and a second path of the NIR laser. The optical chopper can have a rotation speed ranging from 1 to 20 kHz or from 5 to 10 kHz. The system can further comprise a first beam splitter and a second beam splitter on the first path and the second path of the NIR laser, wherein the second path can be lengthier than the first path by Δl ranging from 0.01 mm to 10 mm.

### Definitions

Unless defined otherwise, technical and scientific terms used herein have the same meaning as commonly understood by one of ordinary skill in the art to which the present disclosure belongs.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

The term derivative as used herein refers to a compound that is modified from another compound but retains the basic structure and elemental composition. For example, a dye molecule with a carboxylic acid functional group can have a derivative where the carboxylic acid modified to a ester of N-hydroxysuccinimide (NHS) for facile coupling with an amino group of a protein. In the case of dyes as described herein, a derivative of the dye will not substantially change the photophysical property of the dye. In some embodiments, the UV-vis absorption maximum will not be changed by more than 20 nm, 10 nm, 5 nm or 2 nm.

As used herein, the term “about” means plus or minus 5% of the provided value.

As used herein, widefield BonFIRE refers to imaging of an entire sample by BonFIRE spectroscopy.

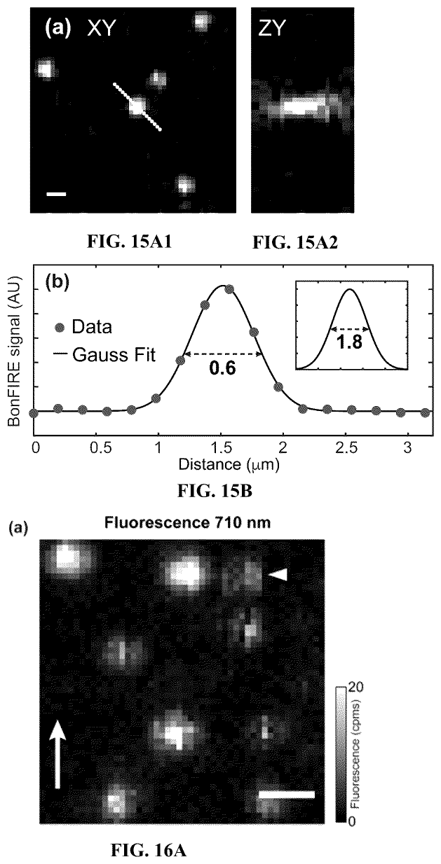

As used herein, full width at half maximum (FWHM) refers to a statistical measure which describes the width of a normal distribution or Gaussian distribution of a parameter, such as BonFIRE signal or a laser pulse. In the case of BonFIRE, it represents the width of a BonFIRE curve measured between the two points where the curve's value is half its maximum as illustrated in FIG. 15B. In the case of an IR pulse or a NIR pulse, full width at half maximum (FWHM) refers to the duration or width of the IR pulse or the NTR pulse.

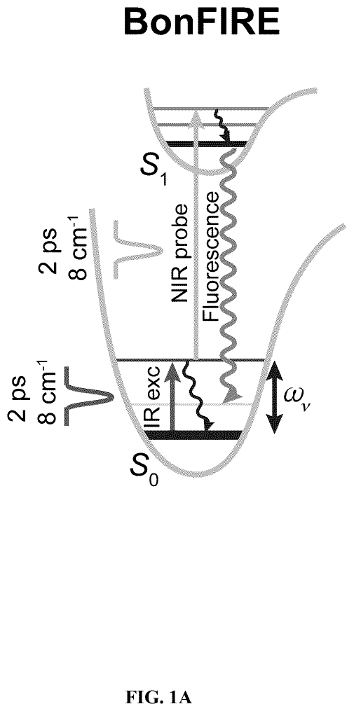

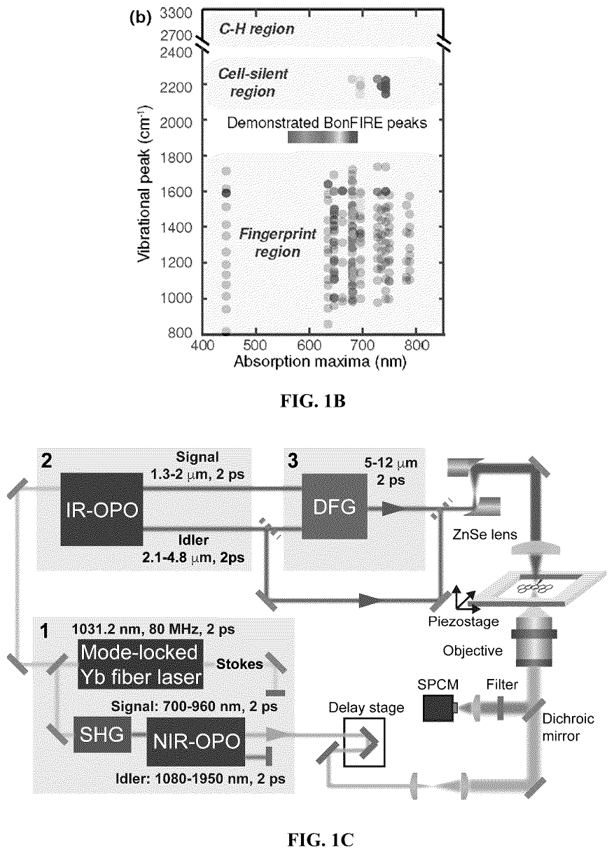

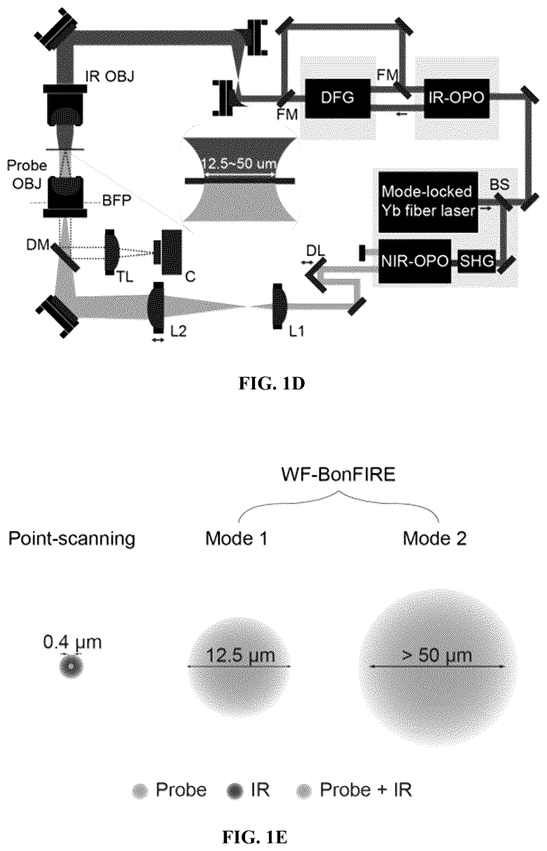

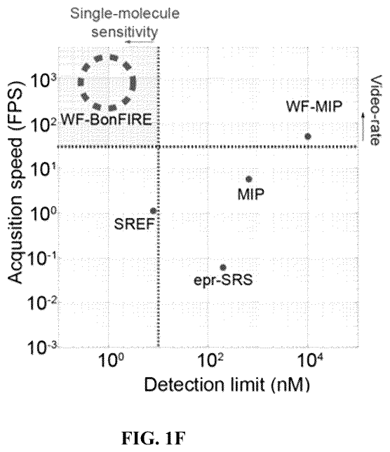

As used herein, a bandwidth refers to a range of frequencies or wave number of an IR laser or NIR laser pulse. For example, FIG. 1A shows a bandwidth of 8 cm¹ for an exciting IR laser and the NIR probe laser in a BonFIRE scheme.

As used herein, a temporal delay (t_{D}) as used herein refers to postponement in time of a NTR laser radiation on a sample relative an IR laser radiation on the sample in BonFIRE spectroscopy. Thus, negative temporal delay (t_{D}) means the NTR laser radiation on a sample is ahead of the IR laser radiation on the sample. Conversely, Thus, positive temporal delay (t_{D}) means the NR laser radiation on a sample is behind the IR laser radiation on the sample by t_{D}.

As used herein, photon upconversion (upconverting) is a nonlinear optical process in which the sequential absorption of two or more photons leads to the emission of light at shorter wavelength than the excitation wavelength. Such use of two radiation fields to interrogate a dye molecule is referred to herein as nonlinear double-resonance.

Infrared (IR) is generally understood to encompass electromagnetic radiation of wavelengths from around 750 nm to 1000 μm. Near-infrared (NTR) as used herein refers to electromagnetic radiation of wavelengths from around 750 nm to 3000 nm. A mid-infrared (mid-IR) as used herein electromagnetic radiation of wavelengths from around 3000 nm to 8000 nm.

A dye as used herein refers to an organic molecule that is fluorescent and has an UV-vis absorption maximum with a wavelength in the range of 400 to 750 nm and/or a NIR absorption from around 750 nm to 3000 nm. A dye as used herein can have carbon-carbon, carbon-oxygen, or carbon-nitrogen double bond with or without isotopologues. A dye as used herein can also have carbon-carbon, or carbon-nitrogen triple bond with or without isotopologues. In some embodiments, the carbon-carbon, carbon-oxygen, or carbon-nitrogen double bond, or the carbon-carbon, or carbon-nitrogen triple bond of the dye molecules herein can be conjugated to another double bond or an aromatic ring by a single bond.

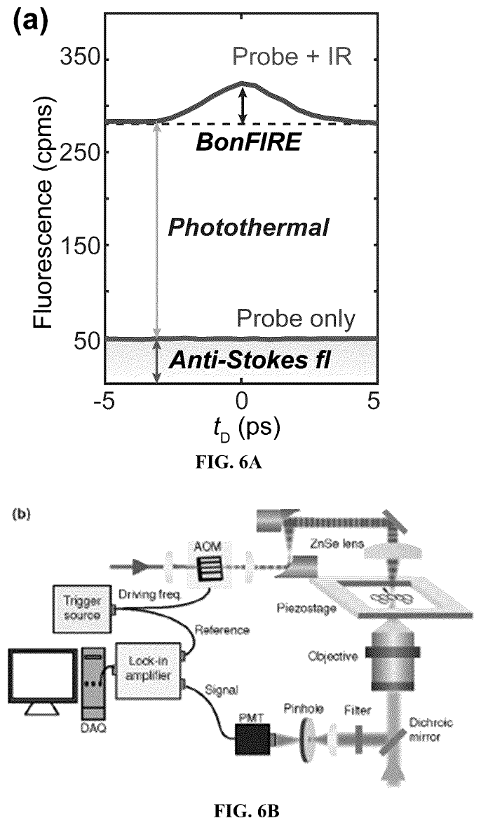

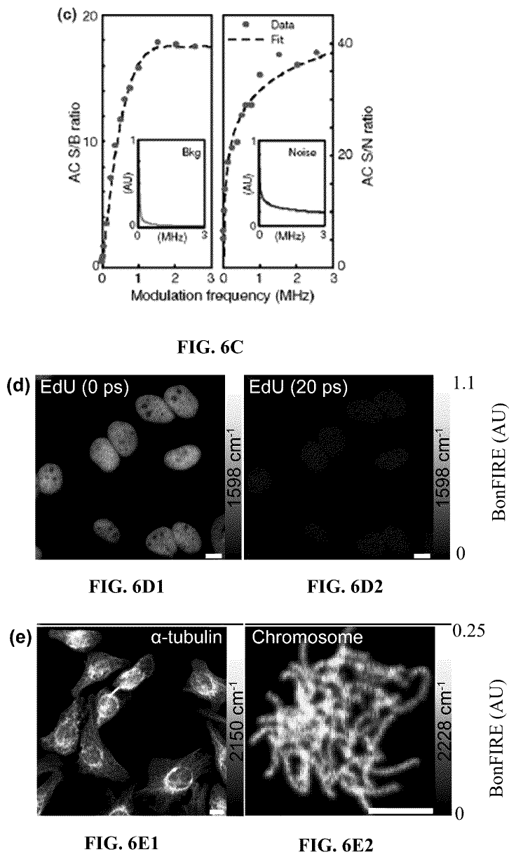

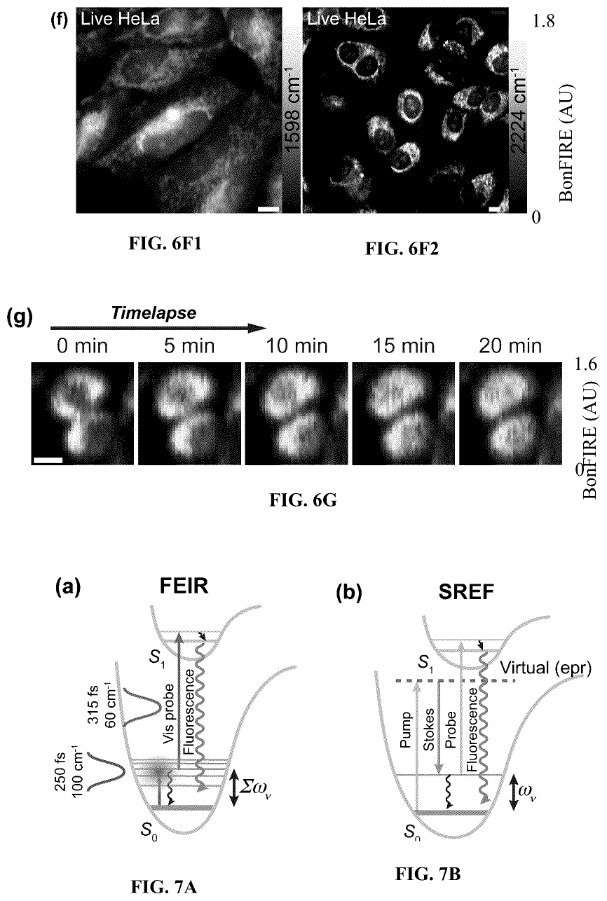

As used herein, time-lapse imaging refers to obtaining a plurality of successive images of a sample each at time interval for a period of time. For example, FIG. 6 shows a time-lapse BonFIRE imaging (targeting C≡N at 2224 cm⁻¹) for dividing live HeLa cells at an interval of 5 minutes for a period of 20 minutes.

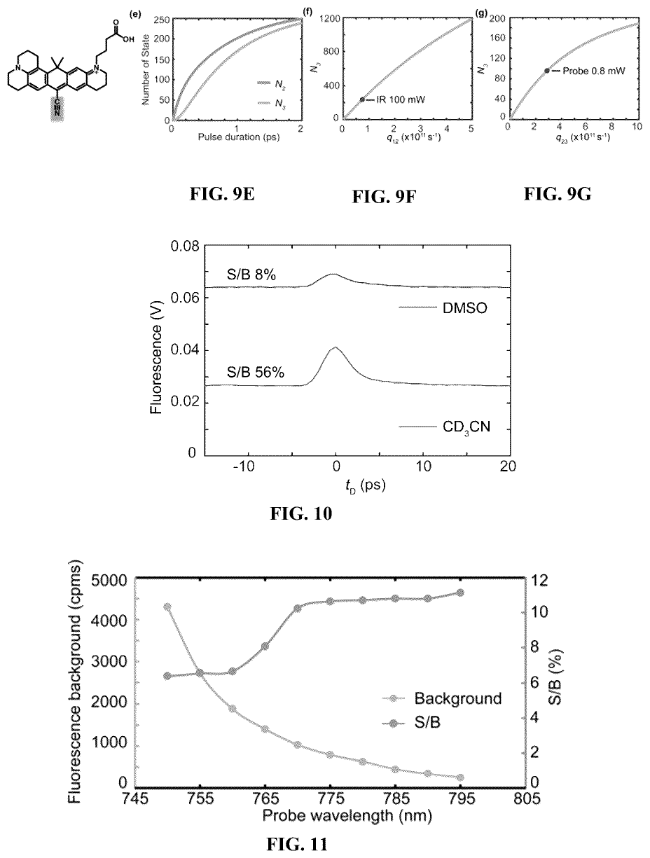

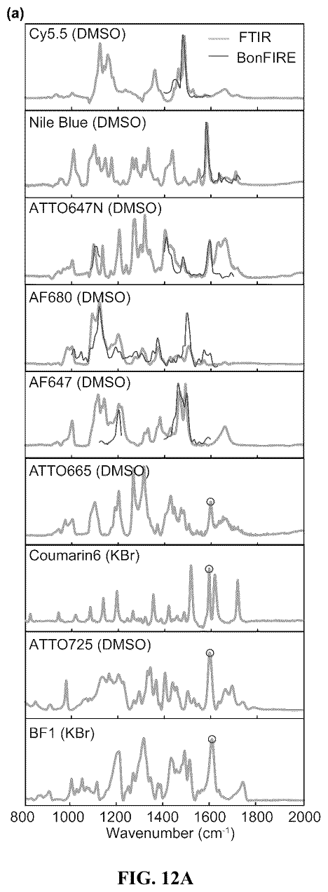

As used herein, the term vibrational relaxation lifetime refers to the time it takes for an initial population of vibrational excited state to decay to a ground state until a percentage, e⁻¹ (36.7%), of the initial population remains in the vibrational excited state. FIG. 9A illustrates a N2 population of a vibrational excited state decays to a ground state with a N1 population with a v₂₁ (vibrational relaxation rate).

Bioimaging harnessing optical contrasts is of vital importance in probing complex biology. While vibrational spectroscopy with mid-infrared (mid-IR) absorption could reveal rich chemical information about molecular distributions and local environments in native states, its full potential for bioimaging is hindered by either achievable sensitivity or non-biocompatible spectro-microscopy designs. However, IR presents several prominent spectroscopic features over its Raman counterparts. IR cross sections (σIR) are 10⁸ to 10¹⁰ times that of Raman, promising a much-increased sensitivity. Therefore, IR has the potential in fast widefield imaging with high-throughput dynamic analysis. Moreover, as IR and Raman selection rules are complementary, utilizing IR would expand the repertoire of versatile chemical bonds for functional imaging.

Here, an ultra-sensitive IR-bioimaging scheme, bond-selective fluorescence-detected infrared-excited (BonFIRE) spectro-microscopy were described herein. BonFIRE employs the nonlinear mid-IR-near-IR double-resonance excitation, which upconverts the vibrational excitation to the electronic state for fluorescence detection, pushing the IR imaging sensitivity to the ultimate single-molecule level. The rationally-designed system utilizes broadly-tunable narrowband picosecond pulses to ensure decent signal sizes, biocompatibility, and robustness for bond-selective biological interrogations with a wide spectrum of reporter molecules. The single-molecule BonFIRE spectro-imaging in both fingerprint and cell-silent spectroscopic regimes were validated, and BonFIRE bioimaging on various intracellular targets in fixed and live cells, neurons, and tissues demonstrated, with promises for vibrational super-multiplexing. For dynamic bioanalysis in living systems, it was implemented a high-frequency modulation scheme and demonstrated time-lapse BonFIRE microscopy. BonFIRE should expand the bioimaging toolbox by providing a new level of bond-specific vibrational details, facilitating functional imaging and sensing for complex biological investigations.

Here, it is described herein Bond-selective Fluorescence-detected IR-Excited (BonFIRE) spectro-microscopy, a newly-designed IR-bioimaging approach with a narrowband laser excitation setup suited for quantitative intracellular interrogations with high spatial and spectral resolution and unprecedented single-molecule sensitivity. BonFIRE harnesses a nonlinear double-resonance scheme, encrypting the bond-selective IR spectroscopic features into fluorescence—the most sensitive measurable in bioimaging—with an additional up-conversion probe laser in the near-IR range (FIG. 1A). The resulting high-fidelity fluorescence detection reports vibrational details with high sensitivity, and achieves subcellular spatial resolution determined by the up-conversion laser. Such IR-promoted double-resonance spectroscopy was introduced in 1975, mainly for vibrational lifetime studies. It was recently revisited by utilizing an amplified broadband femtosecond (fs) system in fluorescence-encoded IR (FEIR) spectroscopy (FIG. 7A), which demonstrated single-molecule sensitivity in IR-transparent acetonitrile-d₃ solutions.^{22,23} However, the excessive peak intensity and low repetition rate of the fs system make FEIR unfeasible for bioimaging due to sample damage with a slow acquisition rate. The interferometric detection of FEIR also requires a third IR pulse, adding more complexities to the setup. It was also noted another recently-introduced Raman-pumped double-resonance scheme, stimulated Raman excited fluorescence (SREF, FIG. 7B). However, SREF imposes a strict requirement on the electronic pre-resonance stimulated Raman excitation for optimal signals, which should be clearly retrieved but not buried in the overwhelming background, hence restricting the choice of reporter molecules and vibrational peaks for investigations. Moreover, this three-photon process suffers from complicated detection background for more general imaging analysis.

In the present approach, it was chosen 2-ps narrowband (˜8 cm⁻¹) pulses for both IR and up-conversion probe lasers with wide tunability (FIG. 1C). This new setup ensures biocompatibility with much lower peak power compared to the fs pulses; efficient up-conversion with matched vibrational relaxation lifetime (˜ps, see Methods in Example 5); explicit bond selectivity for functional and multiplexed imaging; and broad vibrational spectral coverage (800-3300 cm⁻¹) with flexible BonFIRE dye options (FIG. 1C), which greatly outnumber those offered by FEIR or SREF. It was first demonstrated BonFIRE spectro-microscopy in both fingerprint (800-1800 cm⁻¹) and cell-silent (1800-2800 cm⁻¹) regions. Then it was achieved the first far-field single-molecule IR spectroscopy and imaging for both conjugated C═C and C≡N bonds. It was next applied BonFIRE in targeted imaging with labeled nucleic acids and specific protein species in cells, neurons, and tissues with high spatial resolution and sensitivity, demonstrating vibrational multiplexing beyond what fluorescence alone could offer. For optimal live-cell applications, it was implemented a high-frequency modulation scheme for background-free time-lapse imaging. It was also benchmarked the unique advantages of BonFIRE, such as broader spectral coverage, vibrational lifetime imaging, and widefield imaging, over SREF and FEIR. It was expected BonFIRE to enable sensitive bond-selective bioimaging that complements fluorescence with rich vibrational information and functions, facilitating novel biological and biophysical discoveries.

Table 1 shows vibrational peaks of dyes in FIG. 1C.

TABLE 1
Vibrational peaks of dyes in FIG. 1C.

| | Absorption | |
|---|---|---|
| Dye | peak (nm) | Vibrational peaks (cm⁻¹) |
| Coumarin-6 | 444 | 817, 941, 1014, 1078, 1134, 1190, 1261, |
| | | 1350, 1413, 1512, 1589, 1614, 1714 |
| Nile Blue A | 635 | 858, 947, 1008, 1074, 1106, 1171, 1257, |
| | | 1275, 1332, 1375, 1438, 1549, 1584 |
| Cy5 | 646 | 961, 1007, 1106, 1155, 1220, 1298, 1316, |
| | | 1373, 1407, 1439, 1469, 1496 |
| ATTO647N | 646 | 1003, 1134, 1206, 1274, 1317, 1406, |
| | | 1439, 1483, 1598, 1693 |
| Alexa Fluor | 647 | 1006, 1110, 1145, 1215, 1385, 1470, 1500 |
| 647 | | |
| ATTO665 | 662 | 984, 1004, 1203, 1313, 1429, 1472, 1598 |
| BF2 | 680 | 997, 1071, 1160, 1184, 1198, 1258, |
| | | 1285, 1325, 1340, 1407, 1440, |
| | | 1515, 1603, 1663, 1695, 2228 (¹²C≡¹⁴N) |
| Alexa Fluor | 681 | 991, 1091, 1122, 1205, 1307, 1374, |
| 680 | | 1465, 1508, 1576 |
| ATTO680 | 681 | 982, 1024, 1038, 1074, 1142, 1168, 1286, |
| | | 1334, 1402, 1477, 1521, 1598, 1650, 1722 |
| Cy5.5 | 684 | 1124, 1157, 1361, 1463, 1489 |
| Rh800 | 695 | 1102, 1184, 1208, 1301, 1361, 1379, |
| | | 1461, 1508, 1544, 1598, 2142 |
| | | (¹³C≡¹⁵N), 2174 (¹³C≡¹⁴N), 2198 |
| | | (¹²C≡¹⁵N), 2222 (¹²C≡¹⁴N) |
| BF3 | 696 | 1000, 1079, 1145, 1219, 1314, 1340, |
| | | 1363, 1445, 1588, 2192 (C≡C) |
| ATTO725 | 728 | 978, 1102, 1165, 1224, 1289, 1341, |
| | | 1365, 1399, 1456, 1506, 1596, |
| | | 1738, 2228 (¹²C≡¹⁴N) |
| BF4 | 735 | 1163, 1183, 1222, 1266, 1326, 1358, |
| | | 1438, 1496, 1577, 2187 (C≡C) |
| MARS2228 | 743 | 998, 1043, 1109, 1203, 1265, 1311, |
| (BF1) | | 1371, 1429, 1487, 1508, 1598, |
| | | 1737, 2145 (¹³C≡¹⁵N), 2170 (¹³C≡¹⁴N), |
| | | 2195 (¹²C≡¹⁴N), 2220 (¹²C≡¹⁴N) |
| Alexa 750 | 749 | 998, 1100, 1206, 1368, 1516 |
| Cy7 | 750 | 1096, 1145, 1217, 1280, 1309, 1401, |
| | | 1449, 1578 |
| Alexa 790 | 782 | 1102, 1121, 1209, 1370, 1522 |
| Cy7.5 | 788 | 1106, 1156, 1206, 1242, 1281, 1362, |
| | | 1400, 1472, 1572 |

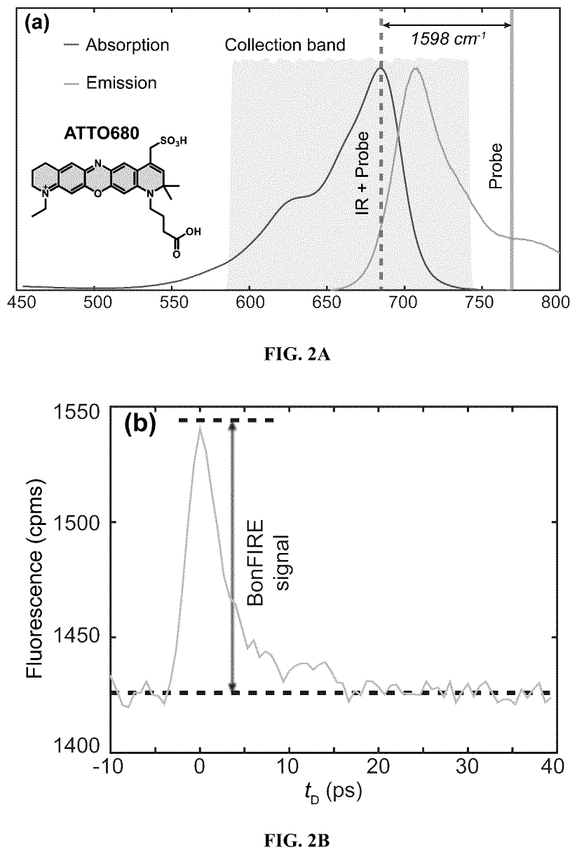

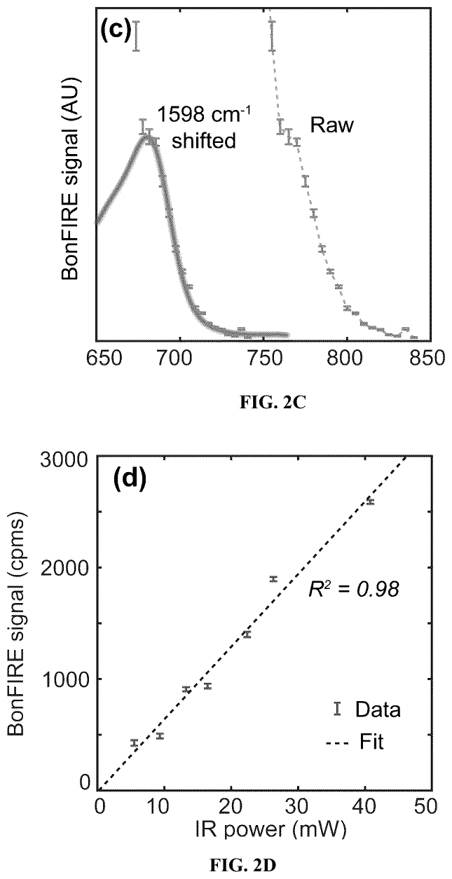

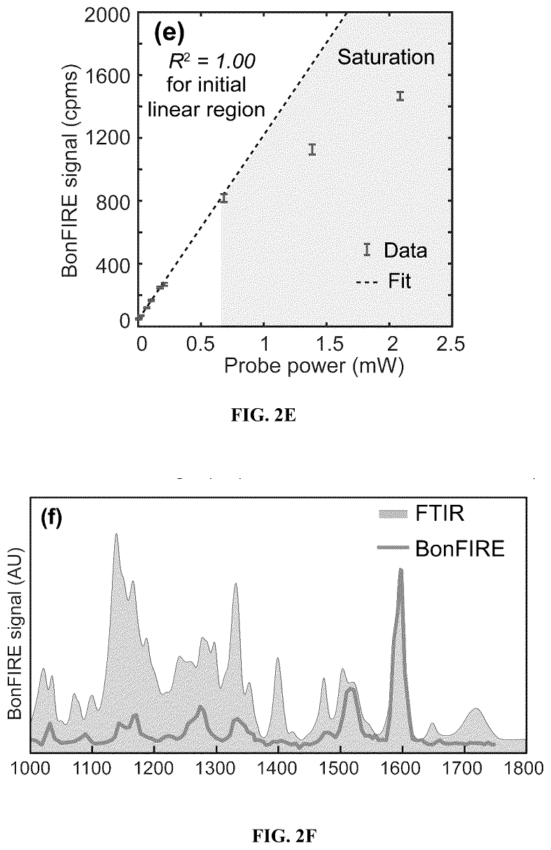

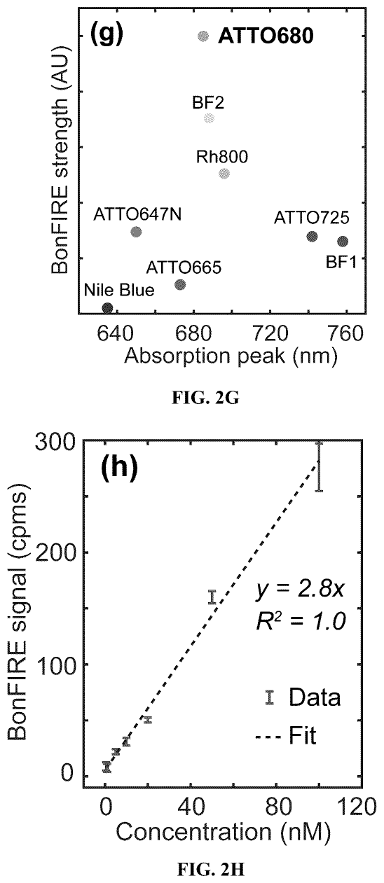

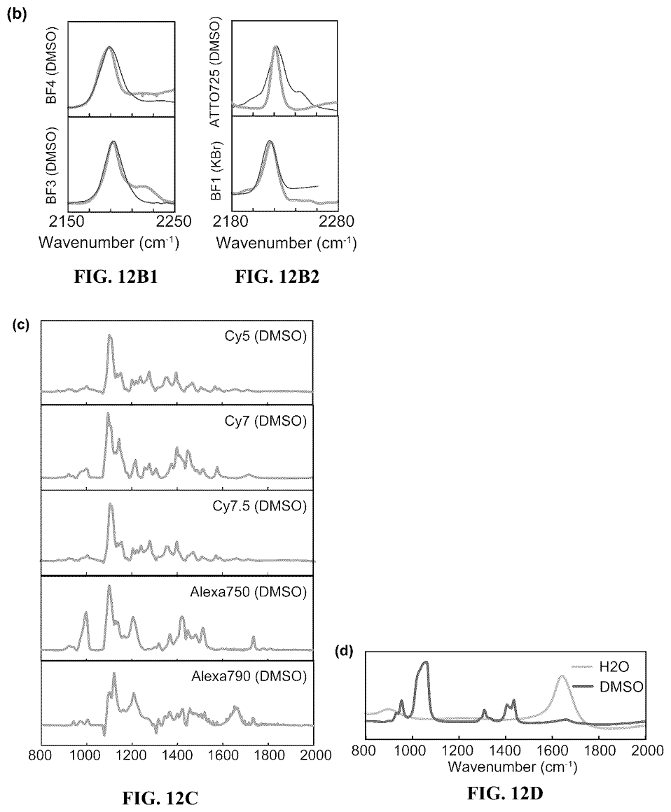

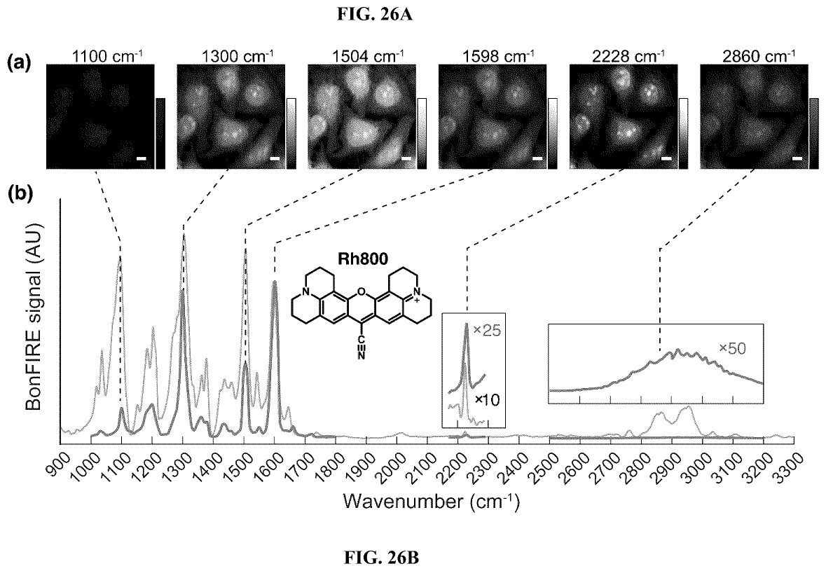

Note: Vibrational peaks were extracted from well-resolved absorption peaks from FTTR spectra of bulk samples or 10 mM solutions in DMSO. Vibrational peaks labeled in bold have been experimentally reproduced in BonFTRE spectroscopy, respectively. Except for ATTO680 (data in FIG. 2F), Rh800 (data in FIGS. 26A-B), and BF2 (with a structure similar to Rh800, see Table 2), FTTR and available BonFTRE spectra data can be found in FIGS. 12A-D.

Additional chemical structures for selected dyes Table 1 or their derivatives in shown below:

Coumarin 6, 3-(2-Benzothiazolyl)-7-(diethylamino)coumarin:

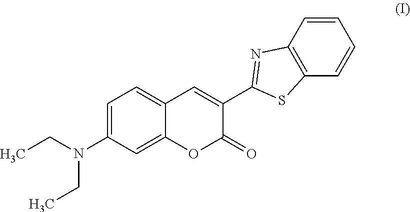 [SMILES: CCN(CC)c1ccc2cc(-c3nc4ccccc4s3)c(=O)oc2c1]

Nile Blue A, [9-(diethyl amino)benzo[a]phenoxazin-5-ylidene]azanium sulfate:

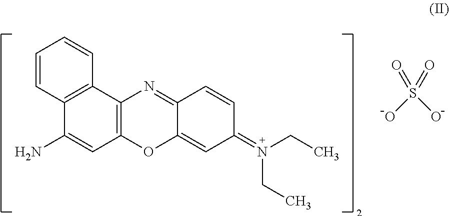

CY5, Cas. No.: 1032678-07-1:

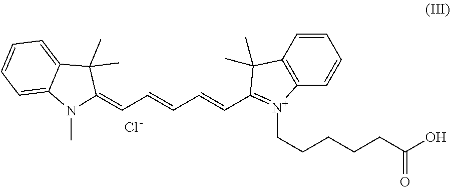 [SMILES: CN1/C(=C/C=C/C=C/C2=[N+](CCCCCC(=O)O)c3ccccc3C2(C)C)C(C)(C)c2ccccc21 ; Cl]

ATTO 647N:

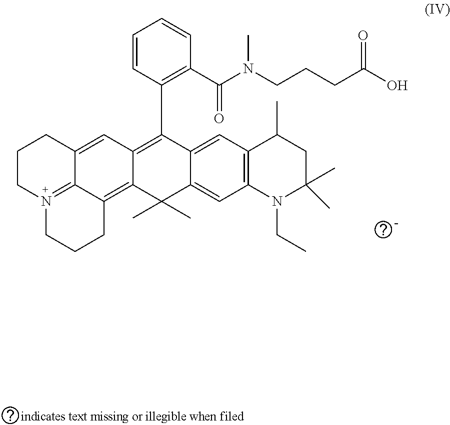

Alexa Fluor 647 acid:

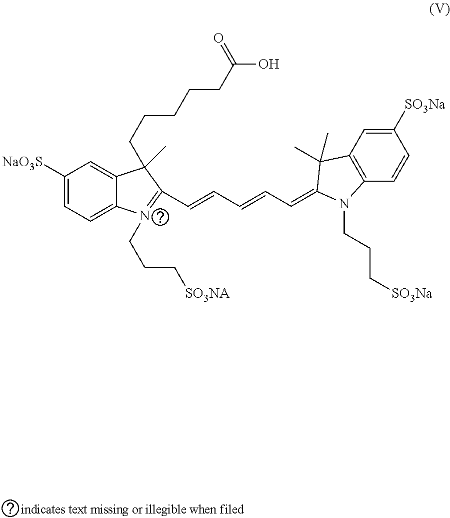

Cy5.5-NHS-ester:

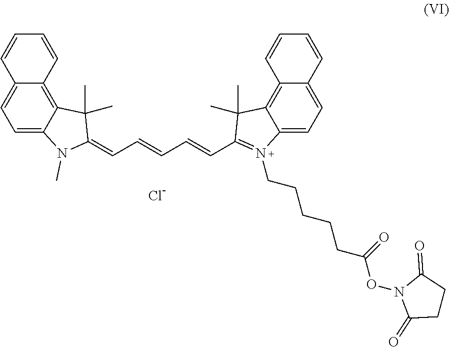

CY7, CAS No. 943298-08-6:

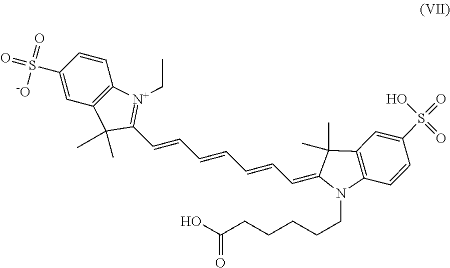 [SMILES: CC[N+]1=C(/C=C/C=C/C=C/C=C2/N(CCCCCC(=O)O)c3ccc(S(=O)(=O)O)cc3C2(C)C)C(C)(C)c2cc(S(=O)(=O)O)ccc21]

Cy7.5, CAS No. 847180-48-7:

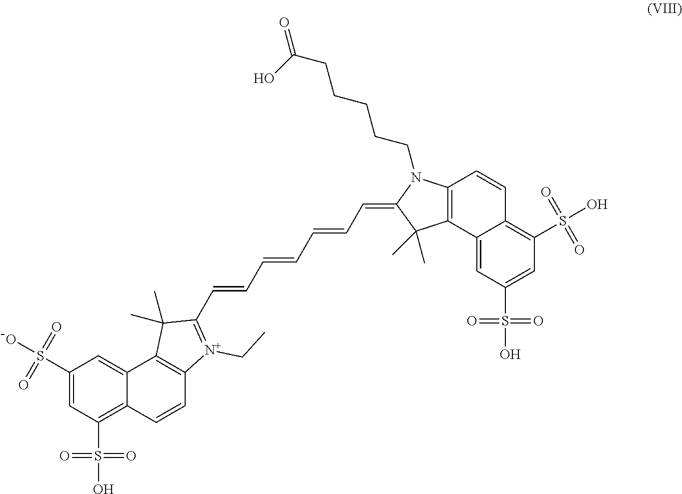 [SMILES: CC[N+]1=C(/C=C/C=C/C=C/C=C2/N(CCCCCC(=O)O)c3ccc4c(S(=O)(=O)O)cc(S(=O)(=O)O)cc4c3C2(C)C)C(C)(C)c2c1ccc1c(S(=O)(=O)O)cc(S(=O)(=O)O)cc21]

In some embodiments, the dyes can be appropriately derivatized without substantially affecting their spectroscopic properties. For example, Cy5.5-NHS-ester can react with an amino group of a protein to form a Cy5.5 conjugated protein by an amide group.

Table 2 shows additional exemplary molecular structures of dyes used in BonFIRE.

TABLE 2
Exemplary Molecular structures of dyes used in BonFIRE.

| Name in the | Commercial | Name in | |
|---|---|---|---|
| main text | name | reference | Structure |
| ATTO680 | ATTO680 | — | 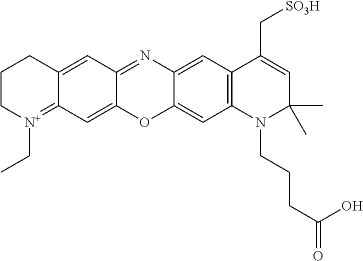 [SMILES: CC[N+]1=c2cc3c(cc2CCC1)=Nc1cc2c(cc1O3)N(CCCC(=O)O)C(C)(C)C=C2CS(=O)(=O)O] |
| BF1 | — | MARS2228 | 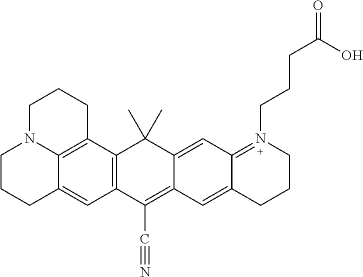 |
| Rh800 | Rh800 | — | 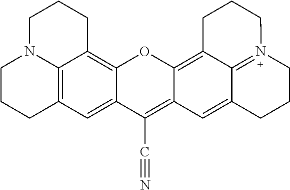 |
| BF2 | — | MARS2238 | 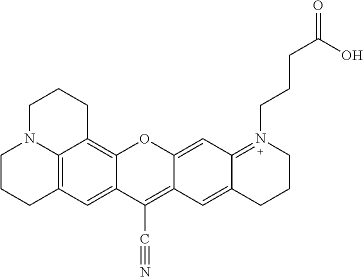 |
| BF3 | — | Compound la | 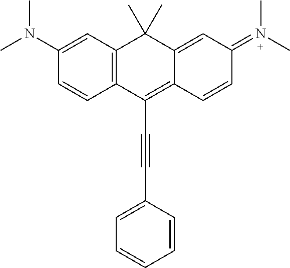 |
| BF4 | — | Compound 1b | 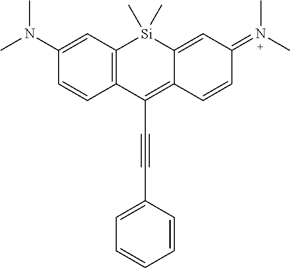 |

Materials described in this example: ATTO dyes were purchased from ATTO-Tec, GmBH. Rh800 was purchased from Sigma Aldrich. Cyanine dyes were purchased from Lumiprobe. Alexa dyes were purchased from Thermo Fisher. BF dyes were synthesized according to the corresponding literature cited in the third column. Isotopologues of BF 1 and BF2 were synthesized according to Wei, L. et al. Super-multiplex vibrational imaging. Nature 544, 465-470, doi:10.1038/nature22051 (2017). Available structures of other commercially available dyes (ATTO series, Alexa series, etc.) used in BonFTRE could be found on the corresponding vendor's websites.

BonFIRE spectro-microscopy disclosed herein realizes the IR-electronic double-resonance excitation with a pair of 2-ps narrowband mid-IR and near-IR pulses. BonFIRE has been demonstrated with high signal fidelity, subcellular spatial resolution, straightforward signal analysis with strict linear concentration dependence, minimum photobleaching, and accurate bond-selectivity and multiplexing with broad spectral coverage. Notably, BonFIRE achieved the first all-far-field single-molecule IR-vibrational imaging without plasmonic enhancements. These features of BonFIRE make it ideal for versatile spatially-resolved functional bio-analysis, including super-multiplexed imaging, live-cell time-lapse imaging, and micro-environment sensing, pushing the boundary of vibrational microscopy one step further to address real-world biological questions.

In some embodiments, BonFIRE is not able to detect nonfluorescent endogenous biomolecules compared to label-free vibrational techniques. However, BonFIRE benefits from the single-molecule sensitivity and high specificity of fluorescent reporters. With proper labeling strategies (e.g., isotope editing, click chemistry, immunolabeling, etc.), BonFIRE has enabled multiplexed bioimaging at the single molecule level and for dilute biomolecules in live cells. With proper instrument upgrades (e.g., frequency-doubling), it is also envisioned that BonFIRE should be readily applicable to investigate naturally-fluorescent endogenous biomolecules such as FAD and NADH, as well as other visible-range reporters, such as GFP for genetically-encoded live-cell applications.

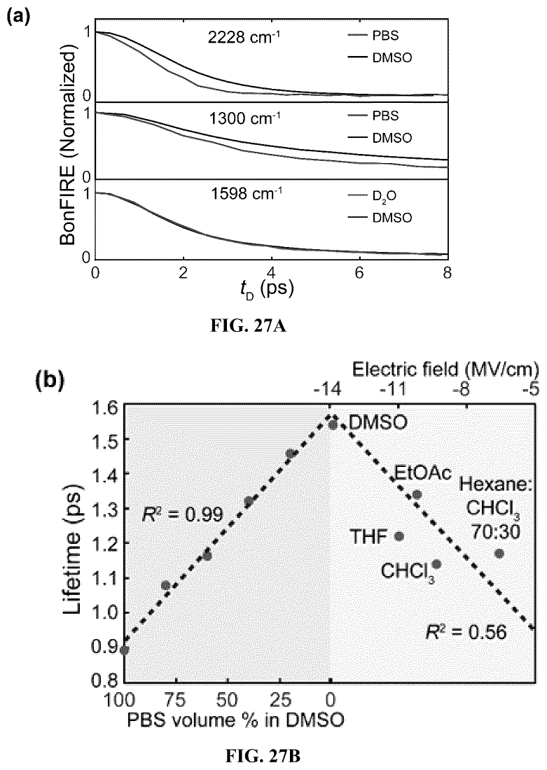

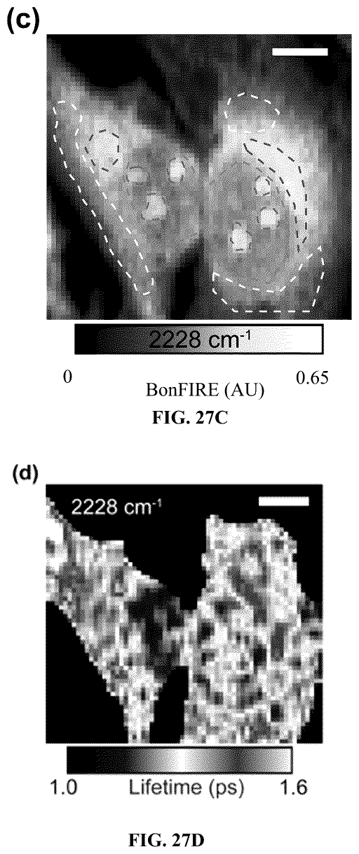

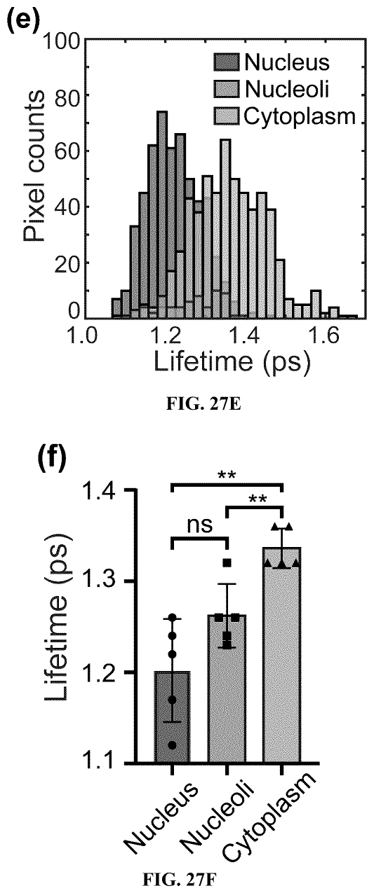

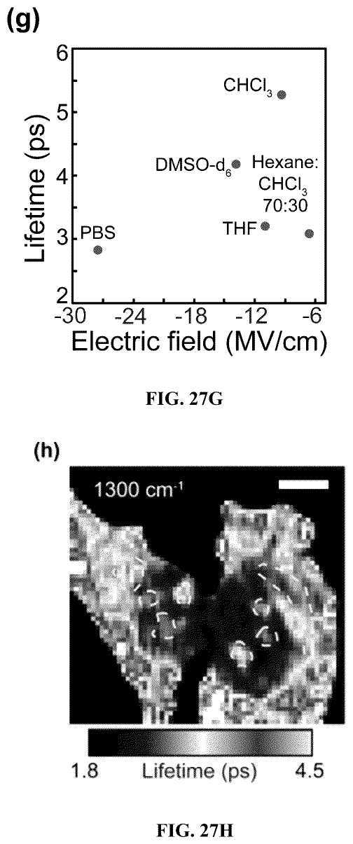

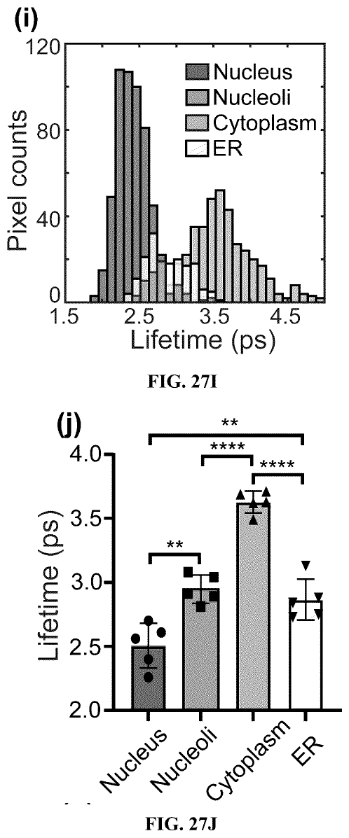

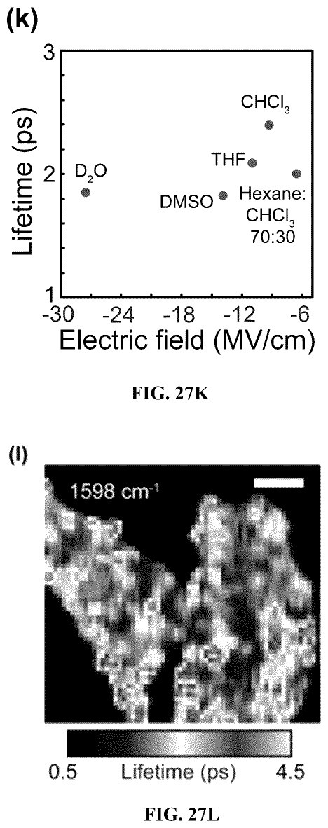

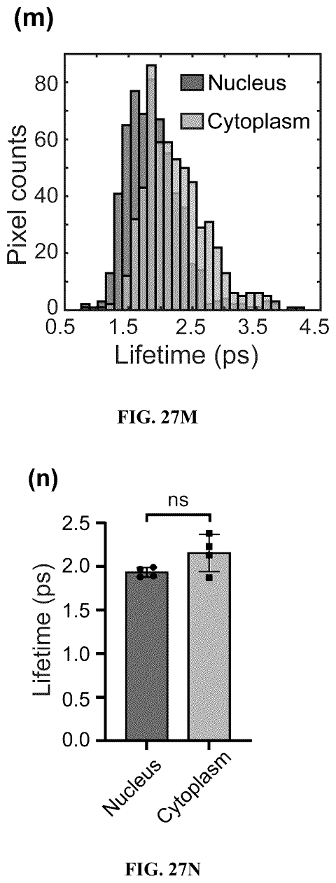

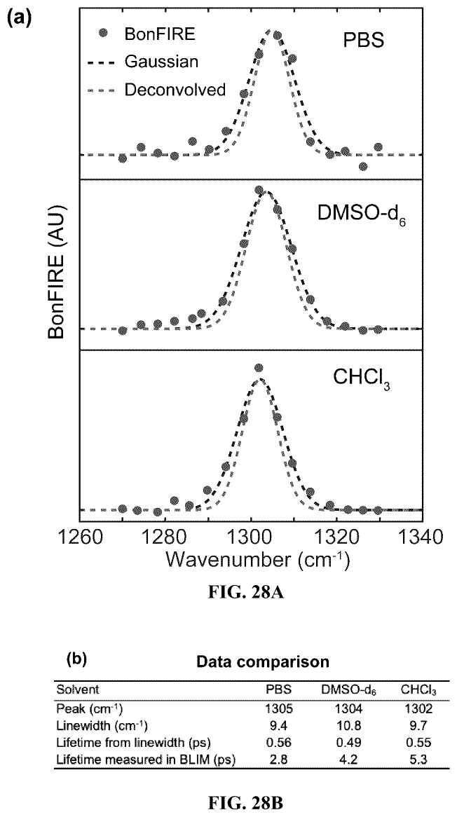

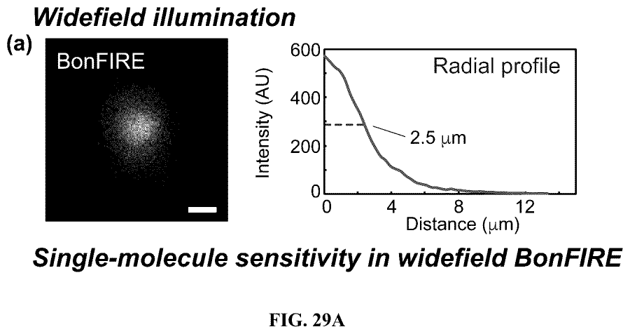

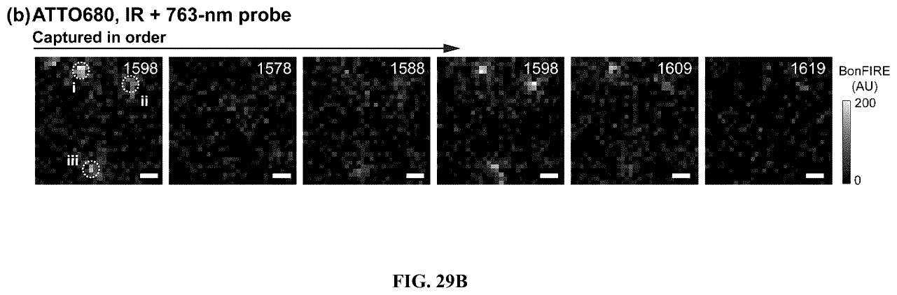

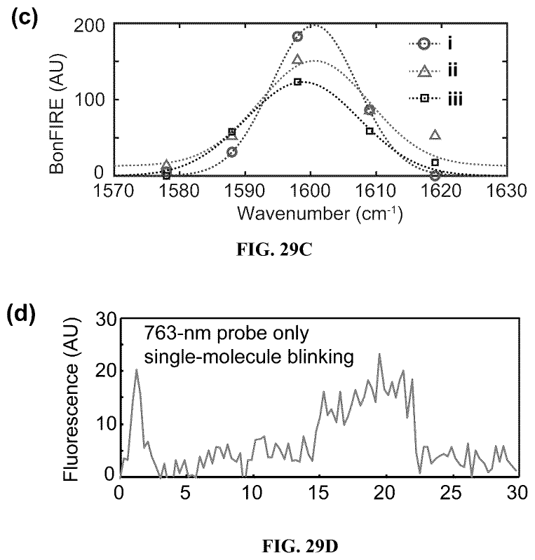

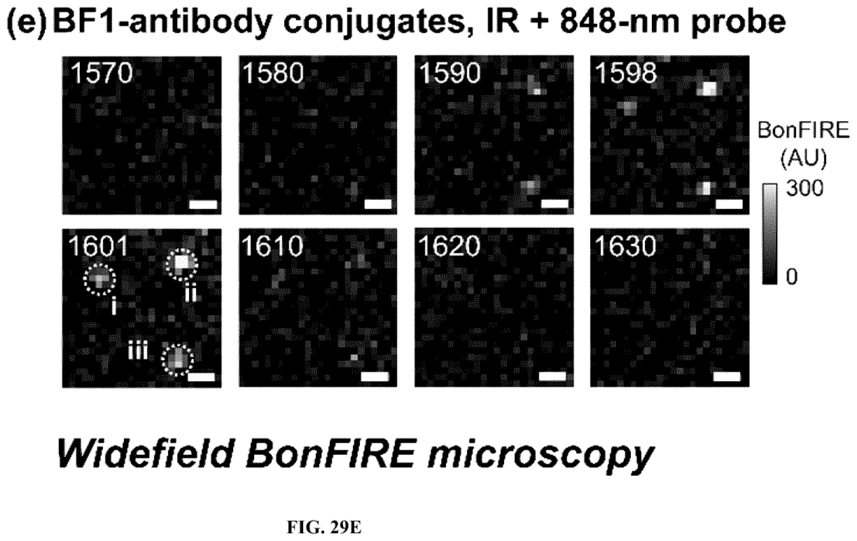

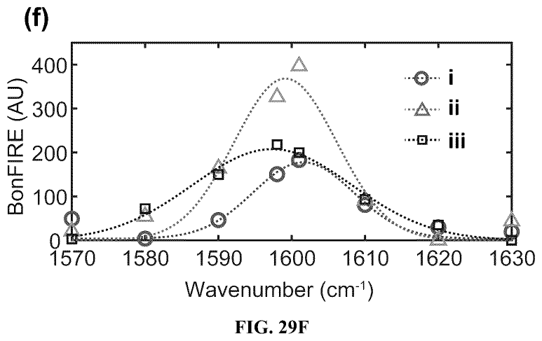

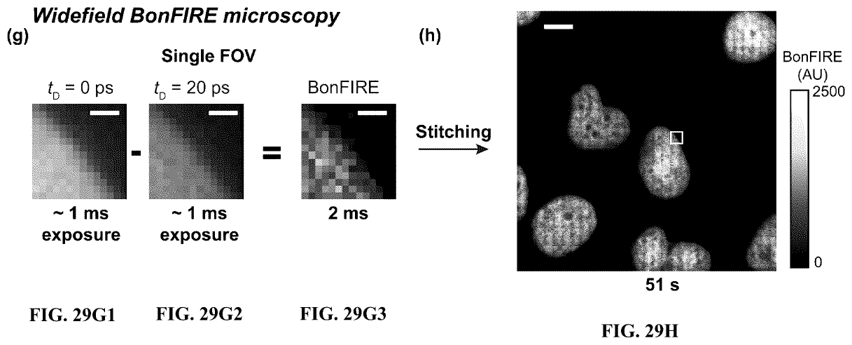

BonFIRE, with multi-dimensional information, offers unique bioimaging opportunities beyond existing techniques. First, the narrowband and broadly-tunable mid-IR sources allow BonFIRE to investigate many bonds of interest for bioimaging, which should greatly aid in super-multiplexed imaging. In FIGS. 26A-B, images based on six vibrational modes ranging from 1100 cm⁻¹ to 2860 cm⁻¹ were acquired for bioimaging from the same Rh800 dye molecule, which exceeds the spectral coverage offered by SREF or FEIR. Second, beyond intensity-based measurement, BonFIRE allows a unique capability for bond-selective vibrational lifetime imaging microscopy (BLIM) for vibrational sensing (FIGS. 27A-N). In particular, the lifetime of conjugated C≡N is linearly dependent on the hydrogen-bonding environment and the solvent electrostatic fields (FIG. 27B) and is suited for mapping the hydrogen-bonding environment in subcellular components (FIGS. 27C-F). Interestingly, it was found that the BLIM of a new mode, aromatic C—N (around 1300 cm⁻¹ for Rh800), shows high solvatochromism sensitivity and could selectively differentiate the environment between the endoplasmic reticulum (ER) and other structures in the cytoplasm (FIGS. 27G-J). This is potentially due to the positive charge from the resonance structure of aromatic C—N that renders it sensitive to mapping the various charged membrane structures. As a comparison, the vibrational lifetime of C═C lacks environmentally sensitive features in subcellular reporting (FIGS. 27K-N). Compared to spectral linewidth or peak shift, the lifetime measured in BLIM is also found to be more sensitive to environmental changes (FIGS. 28A-B). Third, widefield BonFTRE has been proven promising in the present preliminary data with single-molecule sensitivity (FIGS. 29A-G3), thanks to the large IR cross section for the linear IR excitation. This is highly challenging by SREF due to the required nonlinear Raman excitation. Such widefield capability is a key step toward localization-based BonFTRE super-resolution imaging and fast widefield mapping for dynamic biological activities (e.g., neuronal firing). These unique advantages in bioimaging distinguish BonFTRE from SREF and FEIR. The three techniques are summarized in Table 5 for a more detailed comparison.

Table 5 shows comparisons of key parameters of bioimaging between BonFTRE, SREF, and FEIR.

TABLE 5
Comparisons of key parameters of bioimaging between BonFIRE, SREF, and FEIR

| Parameter | BonFIRE | FEIR | SREF |
|---|---|---|---|
| Working | ω_{vib} + ω_{probe} ≈ ω_{abs} | ω_{vib} + ω_{probe} ≈ ω_{abs} | ωₚᵤₘₚ − ωₛₜₒₖₑₛ = ω_{vib}; |
| conditions | | | 2ωₚᵤₘₚ − ωₛₜₒₖₑₛ ≈ ω_{abs}; |
| | | | 1400 cm⁻¹ < ω_{abs} |
| | | | −ωₚᵤₘₚ < 4200 cm⁻¹ |
| Laser system | Two OPOs and one DFG | One OPA | One OPO |
| Repetition rate | 80 MHz | 1 MHz | 80 MHz |
| Pulse width | 2 ps | 200~300 fs | ~2 ps |
| Laser | 8 cm⁻¹ | 120 cm⁻¹ | ~10 cm⁻¹ |
| bandwidth | | | |
| Spectral | Laser tuning, | Interferometric, | Laser tuning, |
| measurement | bond-selective | broadband | bond-selective |
| Laser tunability | ω_{vib}: 800-4200 cm⁻¹ | ω_{vib}: demonstrated | ω_{vib}: ~1600 cm⁻¹; |
| for optimal | ω_{probe}: 690-980 nm | around 1600 cm⁻¹ | ~2200 cm⁻¹ |
| Spectral | | ω_{probe}: 517 nm, fixed | ω_{probe}: 700-750 nm; |
| coverage | | | 788-834 nm with |
| | | | frequency-doubled idler |
| | | | beam |
| Objective | 25X, NA 1.05 | 63X, NA 0.8 | 60X, NA 1.2 |
| Resolution | 600 nm | Not available | 400 nm |
| Bioimaging | Yes | Challenging due to | Yes |
| compatibility | | sample damage from high | |
| | | peak powers | |
| Sensitivity | Single-molecule imaging | Single-molecule in | Single-molecule imaging |
| | with bio-compatibility | acetonitrile-d₃ solution | with bio-compatibility |
| Wide-field | Yes | N/A | Point-scanning |
| compatibility | | | |
| Lifetime for | Yes, bond-selective | Not demonstrated | Not available |
| sensing | | | |
| Background | Anti-Stokes (constant for | Anti-Stokes (constant for | Anti-Stokes (from both |
| source | a fixed ω_{probe}); | a fixed ω_{probe}); | ωₚᵤₘₚ and ωₛₜₒₖₑₛ, |
| | Photothermal (removable | Photothermal (removable | varying for different |
| | with temporal | with temporal | ω_{vib}); two-photon |
| | subtraction) | subtraction) | pump/Stokes combined |
| | | | excitation; |
| Background- | Demonstrated with fast | N/A | Possible with a complex |
| free bioimaging | AC modulation | | frequency modulation |
| | | | scheme |

It is noted that the previous vibrational super-multiplexing techniques (e.g., epr-SRS or Carbow) are limited to sensitivities of 250-500 nM, without single-molecule sensitivity for accessing low-abundance biomolecules.

Each laser module (FIG. 1C, lasers 1-3) in BonFIRE setup is commercially available with high stability that ensures day-to-day data reproducibility, which is advantageous for modern spectroscopic and biological investigations. The current laser system also features an easy conversion to perform state-of-the-art multi-modal vibrational bio-imaging. For example, the signal output from NIR-OPO and the Stokes output (FIG. 1C, laser 1) could allow SREF and stimulated Raman scattering (SRS) imaging, which it has been already achieved in preliminary tests. The upgradability of BonFIRE and smooth integration with other modalities would open new opportunities from fundamental nonlinear optics to biological analysis and beyond.

### Wide-Field Bond-Selective Fluorescence Imaging

Highly sensitive wide-field (WF) microscopy plays a pivotal role in biological imaging. It provides the capability to image key biomolecules, such as RNA, proteins, and metabolites, with down to single-molecule sensitivity while capturing dynamic biological processes with fast imaging speed over the entire field-of-view (FOV) simultaneously. These features are highly desirable for applications such as imaging and tracing the neuronal action potentials, which happen at the millisecond time scale, across the entire neuron and to the surrounding cells. As a comparison, point-scanning microscopy configurations face fundamental constraints on temporal resolution due to the need for serial pixel-by-pixel acquisition. In addition, advanced functional fluorescence microscopy techniques were developed building upon the high-sensitivity wide-field imaging capability. These advanced techniques including single-molecule localization microscopy (SMLM), single-molecule fluorescence in situ hybridization (smFISH) microscopy, and structured illumination microscopy (SIM) have further pushed our new understandings of complex and dynamic biological phenomenon.

Chemical imaging techniques, emerged over the past two decades, have been proven to provide high molecular specificity with rich bond-selective information for biological investigations. However, achieving single-molecule WF chemical imaging remains a grand challenge. This is primarily due to the inherently small cross-sections of vibrational transitions. For example, spontaneous Raman cross-sections typically range from 10⁻³⁰ to 10⁻²⁸ cm², more than 10 orders of magnitude smaller than the visible absorption cross-sections in fluorescence spectroscopy. Stimulated Raman scattering (SRS) addresses this limitation with up to 10⁸ stimulated emission amplification with two simultaneous pulsed lasers. But the required tight-focus nonlinear excitation makes it challenging for the WF scheme without a significant sacrifice on sensitivity, even with the most recent advances of electronic pre-resonance SRS (epr-SRS) and stimulated Raman-excited fluorescence (SREF). Mid-Infrared (TR) photothermal microscopy recently achieved WF capability for ultrafast imaging, leveraging a much larger linear IR absorption cross section (10⁻²²˜10⁻¹⁷ cm²). However, its sensitivity is limited to the μM-mM range, leaving the space of high-sensitivity (from low μM to single-molecule) WF chemical-sensitive imaging inaccessible yet.

As described herein, bond-selective fluorescence-detected infrared-excited (BonFIRE) spectro-microscopy was developed. It achieves bond-selective single-molecule sensitivity by encoding the rich vibrational information into background-free fluorescence signals, through a picosecond mid-IR and near-IR double-resonance excitation scheme on fluorophores (FIG. 1A). To ensure single-molecule detectability across the wide fingerprint and cell-silent regions (1300 cm⁻¹-2400 cm⁻¹) for various double- and triple-bond vibrational modes, the first-generation BonFIRE design employed the point-scanning imaging mode with the tight focuses of both the mid-IR and the near-IR lasers. This serial-acquisition point-scanning mode hence is subject to constrained temporal resolution to capture the fast dynamic processes. In addition, the diffraction-limited mid-IR spots is significantly larger than that of the mid-IR one (FIG. 1D, point-scanning). This size mismatch results in more than 50% waste of mid-IR photons not being utilized for signal generation.

As an alternative, widefield (WF)-BonFIRE is described. With rational design and simulation balancing sensitivity with laser power, the imaging speed and the FOV limits of WF-BonFIRE was pushed to its new height while achieving single molecule sensitivity beyond existing technologies. The additional parallel acquisition approach enables speed enhancement of up to >200 fold compared to point-scanning at single-molecule sensitivity. The superb WF-BonFIRE imaging performances were demonstrated in cells, astrocytes, and in live neurons, capturing the fine structural details and network with decent signal-to-noise ratios (SNRs). To achieve ultrafast imaging, a temporal delay modulation scheme was then implemented that achieves up to 2100 frames per second (FPS) WF-BonFIRE imaging speed. It was further applied to track the Brownian motion of live Escherichia coli (E. coli). WF-BonFIRE significantly expands the boundary of chemical imaging toolbox, enabling high-speed and high-throughput imaging at the ultimate single-molecule limit (FIG. 1E).

Herein, wide-field bond-selective imaging at high sensitivity and speed is described. This is attributed to the use of efficient vibronic transitions, which help to lower the high photon flux requirements typically associated with multiphoton microscopy. Significant increases in imaging speed for both polymer films at large concentrations and single-molecule samples compared to its point-scanning counterparts were demonstrated. Disclosed herein are a 20-millisecond exposure time for single-molecule BonFIRE imaging, suggesting enhanced sensitivity and speed. The application of WF-BonFIRE to fixed biological samples has revealed fine structures of neurons and proteins at low concentrations, achieving large FOV imaging (200×200 μm) in under a minute. Importantly, large FOV imaging in live neurons was also demonstrated, which is highly challenging to achieve using point-scanning due to its long acquisition time. Through the introduction of a temporal delay modulation scheme, ultrafast imaging capabilities was facilitated, extending beyond video rates to achieve speeds up to 2100 FPS. This development allows for the tracking of Brownian motion in E. coli, necessitating millisecond-level temporal resolution.

Imaging speed is influenced by the signal-to-noise ratio (SNR), primarily determined by the photon flux of IR and probe lasers in most cases where shot noise is the limiting factor. In scenarios where detector-limited conditions prevail and available laser power exceeds necessity, increasing the FOV by a factor of M improves imaging speed by the square of M. However, the herein described system operates mostly in a source-limited regime where increased FOV decreases photon flux and signal, with a net decrease in overall imaging speed despite spatial multiplexing gains. For this reason, two distinct operational modes have been implemented to accommodate different application needs. Mode 1 is utilized for situations demanding high photon flux, such as single-molecule imaging or fast dynamic imaging. Mode 2 is selected for simultaneous detection across larger areas, despite the resultant signal loss. Additionally, fewer stage steps are needed to cover a 200×200 μm area when using a larger FOV per tile, reducing the requirement for stage stabilization at each step. Using a higher-power laser could transition our system to a detector-limited regime for larger FOVs beyond 50 μm.

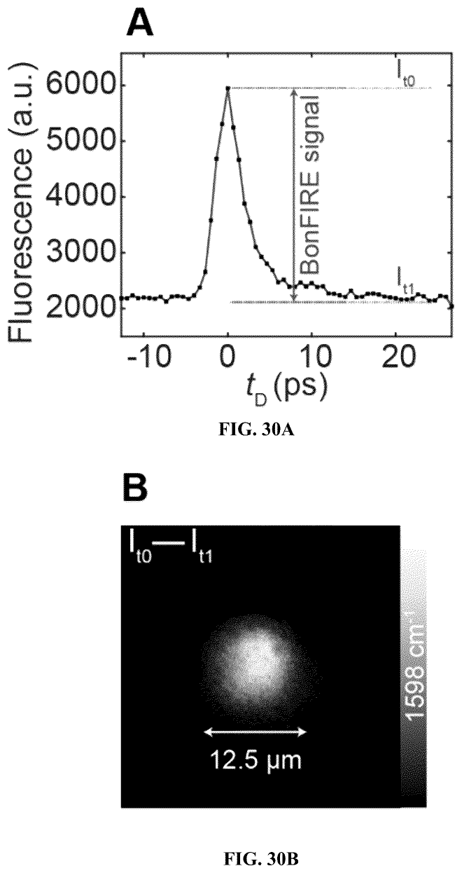

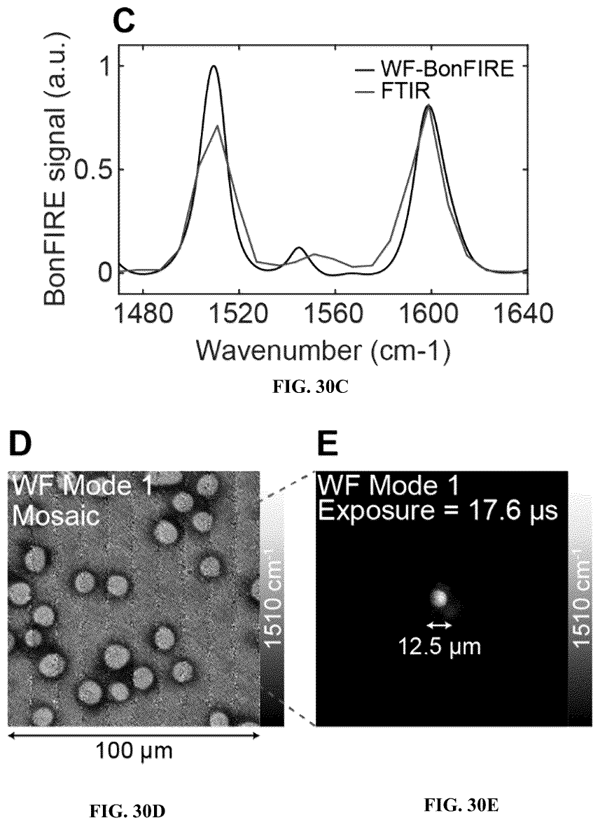

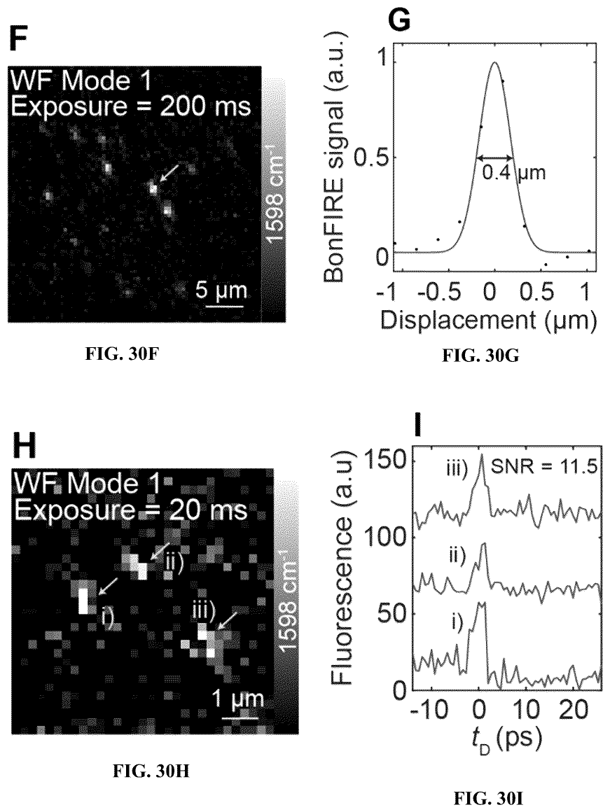

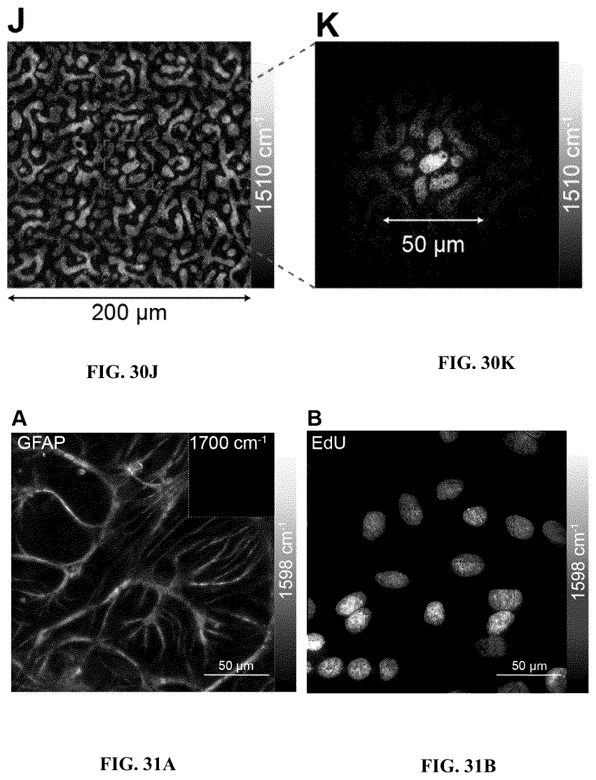

The imaging speeds of up to 2100 FPS are subject to the limitations imposed by the speed of camera and the frequency constraints of chopper rotation. For instance, the sCMOS cameras used in the exemplified experiments are limited to a maximum speed of 2100 FPS at a 10 μm FOV with an exposure time of 17.6 μs, suitable for imaging higher concentration polymer films as shown in FIG. 30D. Achieving speeds greater than 10000 FPS is challenging with the present temporal delay modulation scheme, given that the chopper's maximum speed is 10 kHz.

A primary advantage of BonFIRE is its spectral multiplexing capability. The triple bond features narrow linewidths that enable multiplexing of more than 11 colors within the cell-silent window. Consequently, the WF-BonFIRE method can be applied to diverse applications necessitating high sensitivity, rapid imaging, and multiplexing capabilities. For example, examining rapid biological dynamics, including synaptic activity, cellular responses, and cell migration, which take place in complex biological settings involving multiple biological components, can benefit from WF-BonFIRE. While other imaging modalities such as epr-SRS permit multiplexing, the enhanced temporal resolution and high sensitivity of WF-BonFIRE are advantageous for thoroughly capturing dynamic biological events in a wider cellular context.

### Kits

Provided herein also includes a kit for bond-selective fluorescence-detected infrared-excited (BonFIRE) spectro-microscopy. A kit can comprise one or more dyes described herein. The kit can further include appropriate cell labelling reagents known in the art such as 5-ethynyl-2′-deoxyuridine (EdU) for Click coupling reaction with a corresponding dye such as ATTO680-azide, wherein the ethynyl group of EdU reacts with the azido group of the ATTO680-azide to form a triazole group and labelling the cell with ATTO680, wherein the ATTO680-azide has a Formula (X),

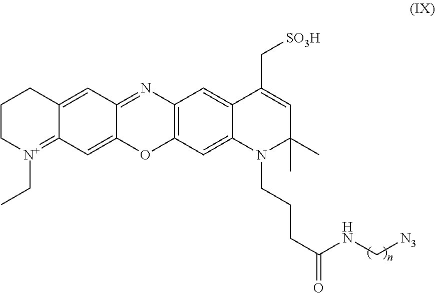

wherein n is an integer ranging from 1 to 6.

In some embodiments, n is 3 and the ATTO680 azide of Formula (X1) is azide-click-labeled to 5-ethynyl-2′-deoxyuridine (EdU) of the sample.

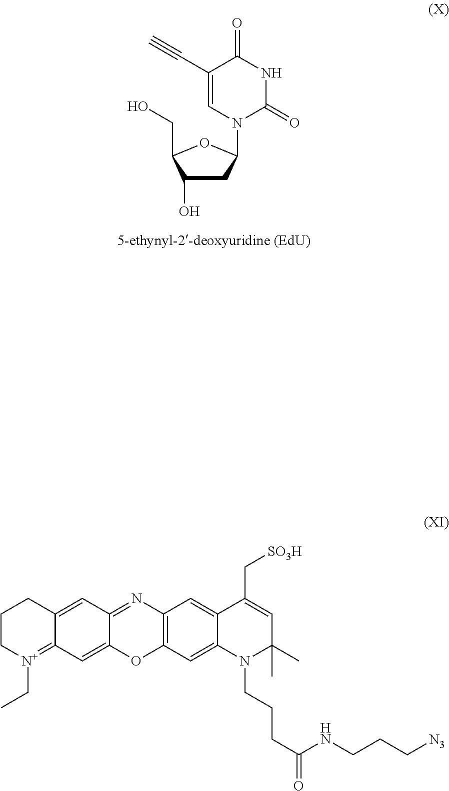

In some embodiments, the kit can include an activated dye such as N-hydroxysuccinimide ester-activated BF1 dye for a secondary antibody, and a corresponding primary antibody. In some embodiments, the kit may optionally contain 10% goat serum/1% BSA/0.3 M glycine/0.1% PBST for blocking cells. The compositions can be in the form of kits of parts. In a kit of parts, one or more components of the compositions disclosed herein can be provided independent of one another and then employed (e.g., by a user) to generate the compositions.

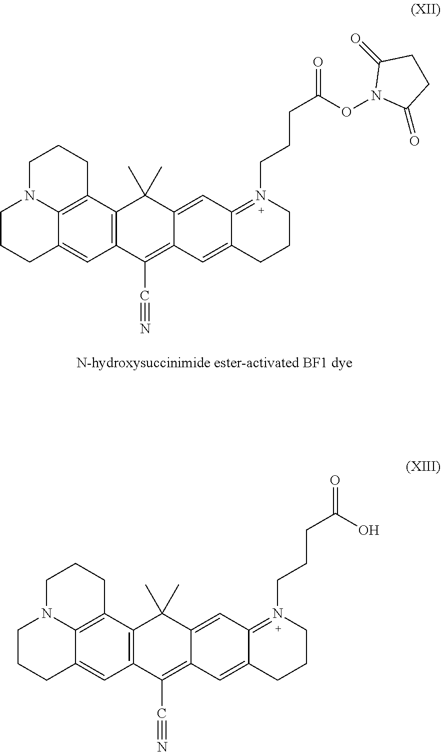

The kit can further include instructions for using the components of the kits to practice the methods described herein such as to image live cells, cell organelles, or a subject. The instructions for practicing the methods are generally recorded on a suitable recording medium. For example, the instructions can be printed on a substrate, such as paper or plastic, etc. The instructions can be present in the kits as a package insert, in the labeling of the container of the kit or components thereof (i.e., associated with the packaging or subpackaging), etc. The instructions can be present as an electronic storage data file present on a suitable computer readable storage medium, e.g., CD-ROM, diskette, flash drive, etc. In some instances, the actual instructions are not present in the kit, but means for obtaining the instructions from a remote source (e.g., via the Internet), can be provided. An example of this embodiment is a kit that includes a web address where the instructions can be viewed and/or from which the instructions can be downloaded. As with the instructions, this means for obtaining the instructions can be recorded on a suitable substrate.

### EXAMPLES

Some aspects of the embodiments discussed above are disclosed in further detail in the following examples, which are not in any way intended to limit the scope of the present disclosure.

### Example 1

### General Experimental Setup and Details

This example describes details of BonFIRE setup and spectro-microscopy in the fingerprint region.

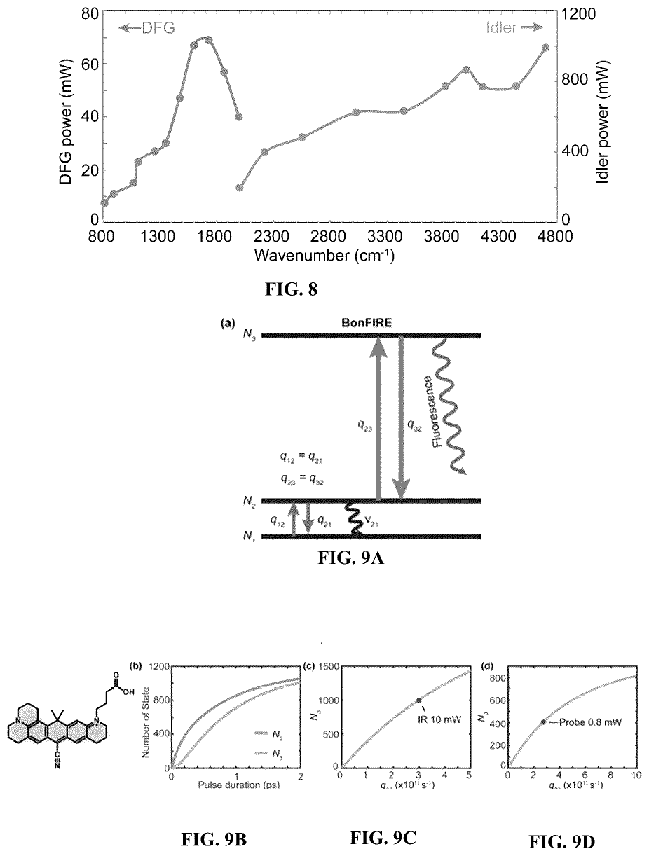

As shown in FIG. 1C, the BonFIRE system consists of two arms of laser outputs pumped by the primary source of a 2-ps 80 MHz mode-locked Yb fiber laser centered at 1031.2 nm (inside laser 1). First, mid-IR sources are composed of an optical parametric oscillator (OPO) with IR outputs (IR-OPO, laser 2) synchronously pumped by the 1031.2-nm laser, and a difference frequency generation (DFG) system (laser 3) fed by the signal and idler from the IR-OPO. The combined 2-ps tunable idler and DFG outputs cover the range of 800-4800 cm⁻¹ (2.1-12 μm) (FIG. 8). Second, a separate portion of the 1031.2-nm pump is frequency-doubled to 515.6 nm through a second harmonic generation (SHG) crystal before being used to pump a second OPO with a tunable (700-960 nm, 2 μs) near-IR probe output (NIR-OPO, laser 1) for up-conversion excitation. IR and probe beams are then aligned to a customized stage-scan confocal microscope in a counter-propagating configuration, with a ZnSe lens (NA=1) and a water-immersion near-IR-coated objective (25×, NA=1.05), respectively, for optimal focusing and throughput of each beam. A delay stage is added to the probe beam path for precise temporal overlapping of the two pulse trains. The backward fluorescence is collected by a single-photon-counting module (SPCM) with proper optical filter sets. All data acquisition, stage scanning, and laser tuning are controlled by a home-written LabVIEW program.

It was first validated BonFIRE spectroscopy by targeting the skeletal C═C mode at 1598 cm⁻¹ of a red dye ATTO680 (FIG. 2A). ATTO680 has high IR and absorption cross-sections and a fluorescence quantum yield of 30%, which makes for efficient BonFIRE transitions (see Methods in Example 5 and FIGS. 9A-G). The measured IR molar extinction (C═C in ATTO680, 1598 cm⁻¹) is 3198 M⁻¹ cm⁻¹ by Fourier-transform IR (FTIR), corresponding to a σ_{IR} of 1.2×10⁻¹⁷ cm², which is indeed more than 10¹⁰ times larger than the Raman cross section for a given C═C mode without resonance enhancement. A 765-nm up-conversion probe wavelength is chosen (FIG. 2A, orange line) so that the calculated excitation from the combined energy of IR and probe lasers (IR+probe, FIG. 2A, dashed purple line) reaches the absorption maximum, while the background excitation from the probe alone is low. It was obtained a fluorescence-detected peak as a function of the IR-probe temporal delay (t_{D}) (FIG. 2B). The time scale of the negative t_{D} (i.e., the probe is ahead) matches well with the temporal overlap profile of the 2-ps lasers. The resulting longer-tail toward positive t_{D} (i.e., the IR is ahead) could be used to decipher the vibrational lifetime of C═C bonds. The obtained signal-to-background ratio (S/B, peak height/background) is about 8% (FIG. 2B), higher than IR-photothermal-induced fluorescence change. Note that the background here mainly originates from the photothermal effect, which is much smaller in more IR-transparent solvents (FIG. 10, S/B ˜56%) and could be eliminated by adopting high-frequency modulation, which is herein demonstrated later for live-cell bio-imaging.

To characterize the BonFIRE signals, it was swept the probe wavelength across the excitation range at the red tail of the absorption spectrum (750-850 nm) while fixing the IR excitation at 1598 cm⁻¹. The shifted BonFIRE excitation profile from the combined energy of IR+probe (FIG. 2C, solid-orange) overlaps with ATTO680 absorption tail (FIG. 2C, purple), confirming the optimal up-converting wavelength is around 765 nm (FIG. 2C, dashed orange). Tuning the probe wavelength to the bluer side causes reduced S/B and increased noises (FIG. 2C and FIG. 11), likely due to other multi-photon processes (e.g., excited-state absorptions). It was ruled out the signal contribution from direct sum-frequency generation (SFG) by using a filter that blocks radiations at the frequency of IR+probe (681 nm). It was then experimentally confirmed that the BonFIRE signals are linearly dependent on the IR power (FIG. 2D) and show a saturated trend for the probe power (FIG. 2E), consistent with simulation results (Methods in Example 5 and FIGS. 9B-D).

Taking advantage of the wide IR tunability, it was obtained the ATTO680 BonFIRE spectrum (FIG. 2F, orange) in reference to its FTIR (FIG. 2F, gray). Most fingerprint features were revealed. In addition to strong peaks from conjugated C═C bonds (1500-1600 cm⁻¹), molecular fingerprints from C—O (1100-1200 cm⁻¹), C—N (1250-1350 cm⁻¹), and C—H (1350-1500 cm⁻¹) vibrations were also revealed. The intensity mismatch between the BonFIRE and the FTIR spectra is primarily due to the lower Franck-Condon (F-C) constants of less conjugated modes. A strong F-C coupling contributes to BonFIRE excitation. The correspondence between BonFIRE and FTIR peaks has been confirmed to be explicit for all investigated dyes (FIGS. 12A-D). It was examined C═C BonFIRE signals from eight molecules across various absorption peaks and identified ATTO680 as the best-performing dye with the highest signal (FIG. 2G and Table 3). Targeting the C═C excitation in ATTO680, the BonFIRE sensitivity reached 0.5 nM in solution (FIG. 211), well below the calculated single-molecule-equivalent concentration of 5 nM.

Table 3 shows BonFIRE signal comparison of dyes with C═C modes.

TABLE 3
BonFIRE signal comparison of dyes with C═C modes.

| | | | Probe | Measured |
|---|---|---|---|---|
| | Absorption | IR frequency | wavelength | BonFIRE |
| Dye | peak (nm) | (cm⁻¹) | (nm) | strength |
| Nile Blue A | 635 | 1580 | 705 | 0.02 |
| ATTO647N | 650 | 1598 | 720 | 0.29 |
| ATTO665 | 673 | 1598 | 740 | 0.10 |
| ATTO680 | 685 | 1598 | 765 | 1.00 |
| BF2 | 688 | 1598 | 760 | 0.71 |
| Rh800 | 696 | 1598 | 775 | 0.50 |
| ATTO725 | 742 | 1598 | 825 | 0.28 |
| BF1 | 758 | 1598 | 840 | 0.26 |

Note:
For Nile Blue A, ATTO647N, and ATTO665, the dichroic/filter set of FF700-Di01/ FF01-650/60 (Semrock) was used; For ATTO680, BF2, and Rh800, the dichroic/filter set of FF738-FDi01/FF01-665/150 was used; For ATTO725 and BF1, the dichroic/filter set of FF801-Di01/FF01-709/167 was used. Absorption peaks were verified with UV-vis and FTIR measurements in DMSO solutions. Probe wavelengths were optimized so that the sum energy of IR + probe matches the absorption peak (The 705 nm for Nile Blue A was not optimized due to the limitation of the used dichroic mirror). BonFIRE experimental data were taken from 1 μM solutions in DMSO.

### Example 2

### Cell-Silent BonFIRE Spectro-Microscopy

This example describes details of cell-silent BonFIRE spectro-microscopy.

With broad laser tuneability, it is now possible to investigate modes in the cell-silent window, the key spectral region for emerging applications such as super-multiplexing, and electrostatic sensing. Going beyond the fingerprint region, the importance of IR spectral information for triple bonds in the cell-silent region (1800-2800 cm⁻¹) is increasingly recognized for vibrational bio-imaging and sensing. First, the background IR absorption from water and endogenous species is minimized in this region. Second, by harnessing the single and strong narrowband vibrations of C≡N and C≡C, functional bioimaging, such as super-multiplexed imaging,⁵ could be achieved. Third, triple bonds have been demonstrated as ideal spectroscopic sensors to probe the local biological microenvironment. For example, the vibrational Stark effect through IR spectroscopy on C≡N for sensing the non-covalent electrostatic interactions has been quantitatively developed for understanding and modulating the biocatalytic effects at the enzyme active sites. However, no IR-pumped double-resonance spectroscopy has been demonstrated in the cell-silent region.

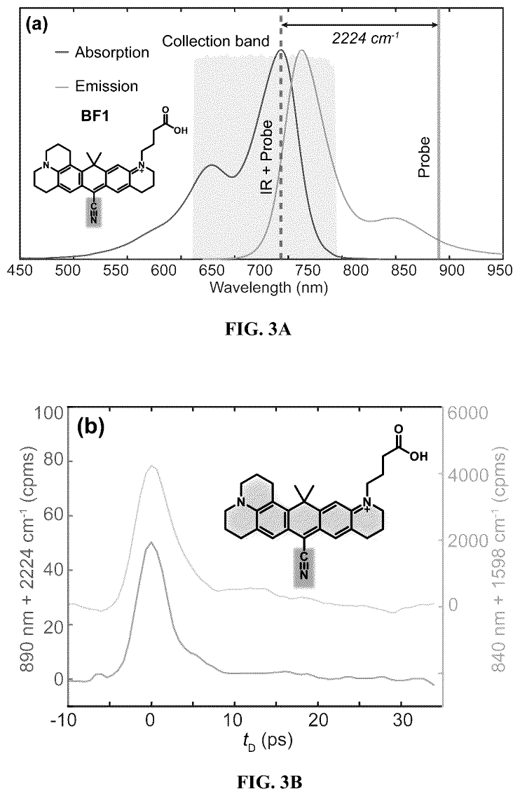

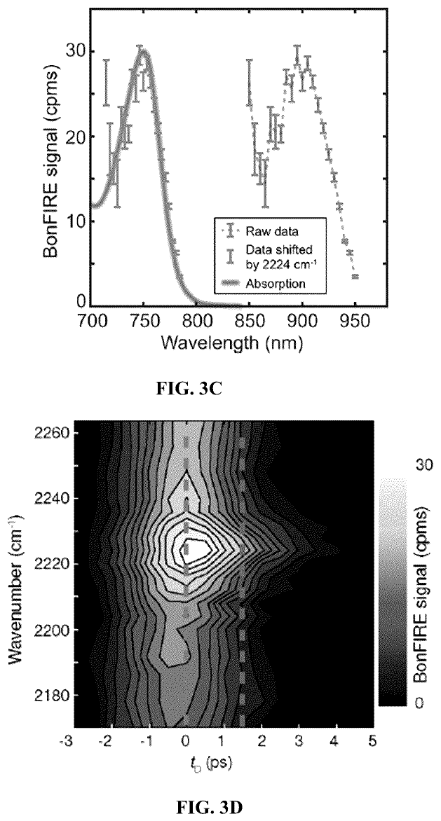

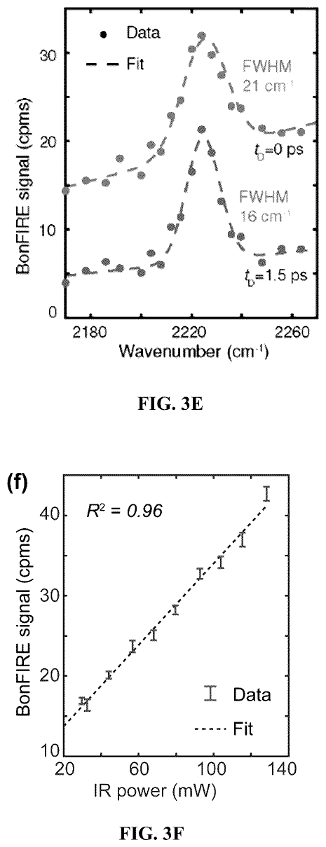

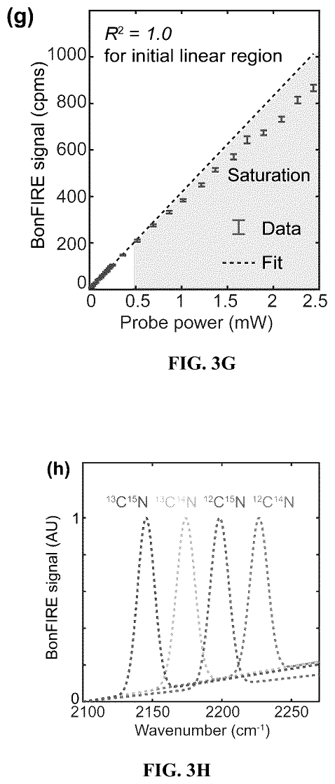

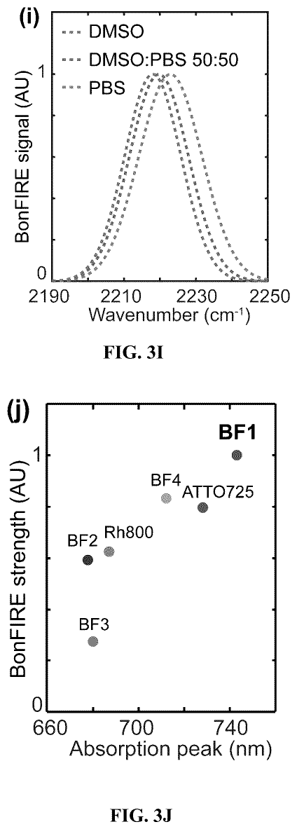

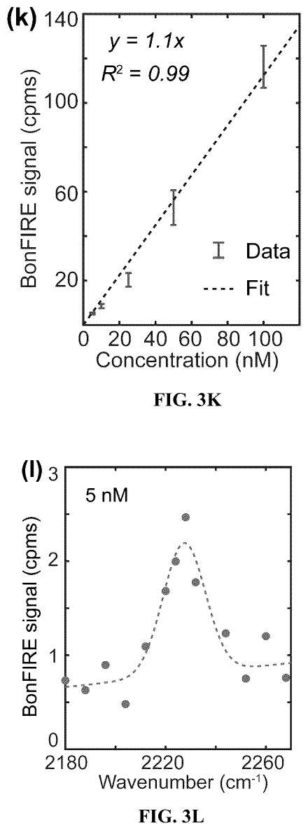

With the direct IR-OPO idler output (Laser 2, FIG. 1C), it was characterized the cell-silent BonFIRE spectroscopy. It was adopted a previously reported electronic pre-resonance Raman dye, MARS2228, bearing a C≡N conjugated to the dye resonance structure with strong F-C coupling. Since BonFIRE probes the IR transition of C≡N with a slight frequency shift from that in Raman, it was renamed the dye to BF1 (structure shown in FIG. 3A and Table 2) to avoid confusion. Like above-demonstrated, it was first calculated an optimal probe-upconverting wavelength of 890 nm to match the probe+IR (2224 cm⁻¹ for C≡N) to the absorption peak at 743 nm (FIG. 3A). The pure BonFIRE signal (FIG. 3B, blue) targeting the 2224 cm⁻¹ IR excitation for BF1 C≡N is only about 1.2% compared to that of C═C (1598 cm⁻¹, FIG. 3B, orange). This is mainly due to a much smaller σ_{IR}˜2.7×10⁻¹⁹ cm² of conjugated C≡N (Table 4) with a faster vibrational decay (observable from the decay trends in FIG. 3B) than that of C═C. Subsequent BonFIRE excitation profile in FIG. 3C also confirms the choice of optimal probe excitation around 890 nm, balancing the obtainable signal sizes, S/N, and S/B.

Table 4 shows BonFIRE signal comparison of dyes with C≡C and C≡N modes conjugated to the dye systems.

TABLE 4
BonFIRE signal comparison of dyes with C≡C and C≡N modes conjugated to the dye
systems.

| | | | | | | | Calculated | |
|---|---|---|---|---|---|---|---|---|
| | | | | IR | Calculated | | BonFIRE | |
| | | Absorption | IR | absorption | Franck- | | strength | Measured |
| | Absorption | coefficient | frequency | coefficient | Condon | Quantum | relative to | BonFIRE |
| Dye | peak (nm) | (M⁻¹ cm⁻¹) | (cm⁻¹) | (M⁻¹ cm⁻¹) | factor | yield | BF1 | strength |
| BF2 | 678 | 56078 | 2224 (C≡N) | 28 | 0.08 | 0.16 | 0.41 | 0.59 |
| BF3 | 680 | 39811 | 2194 (C≡C) | 307 | 0.06 | 0.017 | 0.25 | 0.27 |
| Rh800 | 687 | 66833 | 2224 (C≡N) | 28 | 0.078 | 0.16 | 0.47 | 0.63 |
| BF4 | 712 | 56234 | 2188 (C≡C) | 35 | 0.043 | 0.04 | 0.69 | 0.83 |
| ATTO725 | 728 | 123423 | 2224 (C≡N) | 63 | 0.059 | 0.1 | 0.93 | 0.80 |
| BF1 | 743 | 120000 | 2224 (C≡N) | 70 | 0.059 | 0.1 | 1.00 | 1.00 |
| BF1 | 743 | 120000 | 1598 (C≡C) | 3852 | 0.036 | 0.1 | 34 | 83 |

Note:
For BF2, BF3, Rh800, and BF4, the dichroic/filter set of FF801-Di01/FF01-709/167 (Semrock) was used; For ATTO725 and BF1, the dichroic/filter set of Di02-R830/FF01-775/140 (Semrock) was used; Absorption peaks and cross sections were verified with UV-vis measurements on dye solutions in PBS. BonFIRE data were obtained from 1 μM PBS solution of each dye. Absorption peaks, coefficients, and quantum yields of BF3 and BF4 were obtained from Pastierik, T., S̆ebej, P., Medalová, J., S̆tacko, P. & Klán, P. Near-Infrared Fluorescent 9-Phenylethynylpyronin Analogues for Bioimaging. The Journal of Organic Chemistry 79, 3374-3382, doi: 10.1021/jo500140y (2014). ORCA and custom scripts were used to estimate Franck-Condon factors according to Lee, S. Y. & Heller, E. J. Time-dependent theory of Raman scattering. The Journal of Chemical Physics 71, 4777-4788, doi: 10.1063/1.438316 (1979). The last row of BF1 C═C was added for comparison purpose.

Unlike fingerprint-BonFTRE (FIG. 2F), it was observed a background across a broad off-resonance frequency range around the C≡N band at t_{D}=0 ps (FIG. 3D), blue dashed-line). This background is unlikely caused by the excited-state absorption, as it is absent for double-bond BonFIRE, and the probe wavelength is at the far red of the excitation tail. As previously reported, it was attributed this background to IR excitation of broadband overtones and combinational modes. A more detailed investigation is undergoing for its mechanistic understanding. Practically, this unwanted background decays more sharply with t_{D} detuning than the desired signal. It is hence chosen to perform the following cell-silent BonFIRE detection at t_{D}=1.5 μs (FIG. 3D), green dashed line), a sweet spot to maintain decent BonFTRE signals and spectral fidelity with diminished background interference (FIG. 3E). Consistent with the present theoretical calculation (FIGS. 9E-G), the power dependence of C≡N (FIGS. 3F-G) follows similar trends as above-shown for C═C bonds.

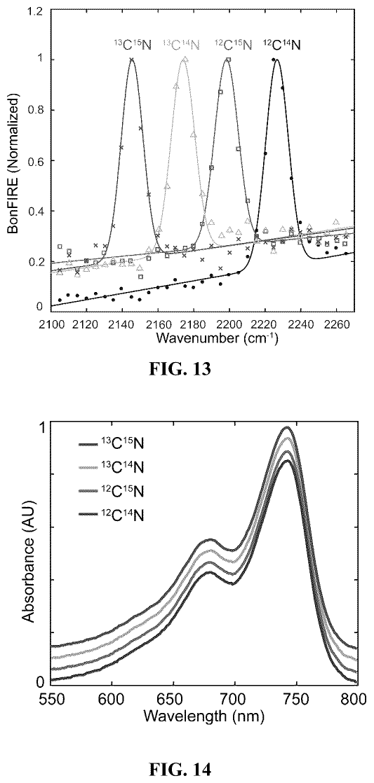

After validating cell-silent BonFTRE spectroscopy, it was first demonstrated its potential of vibrational super-multiplexing by measuring the BonFIRE spectra from four C≡N isotopologues of BF1. BonFTRE nicely resolves the four distinct vibrational peaks (FIG. 3H, raw data in FIG. 13), although the electronic absorption spectra are almost identical (FIG. 14). Second, to confirm the local environmental-sensing applicability, it was proved that BonFIRE could precisely identify the vibrational shift of C═N bond in solutions with varying hydrogen-bonding-forming capabilities. The C≡N peak shifts from 2224 cm⁻¹ (in PBS) to 2220 cm⁻¹ (in 50:50 PBS/DMSO) and 2218 cm⁻¹ (in DMSO) (FIG. 3I). Third, to identify the brightest cell-silent BonFIRE probe, it was compared six C≡N and C≡C bearing dyes across the vast absorption range and confirmed that BF1 shows the strongest BonFIRE signals (FIG. 3J), which agrees with the calculated results (Table 4). The BonFIRE detection limit targeting C≡N in BF1 reaches the single-molecule level of 5 nM (FIG. 3K), with an S/N of 6 and a well-resolved spectrum (FIG. 3L).

### Example 3

### Single-Molecule BonFIRE Imaging and Spectroscopy

This example describes details of Single-molecule BonFIRE imaging and spectroscopy.

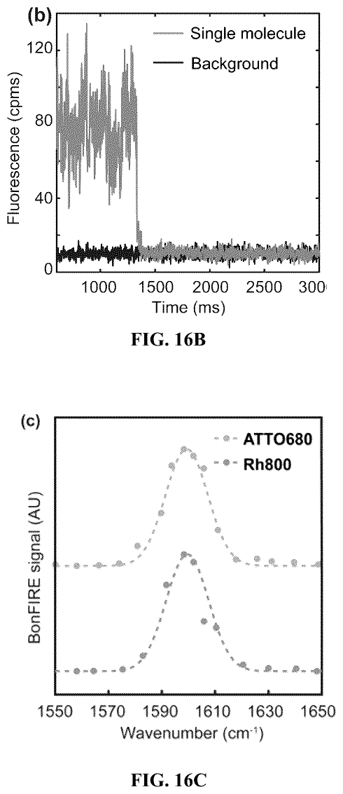

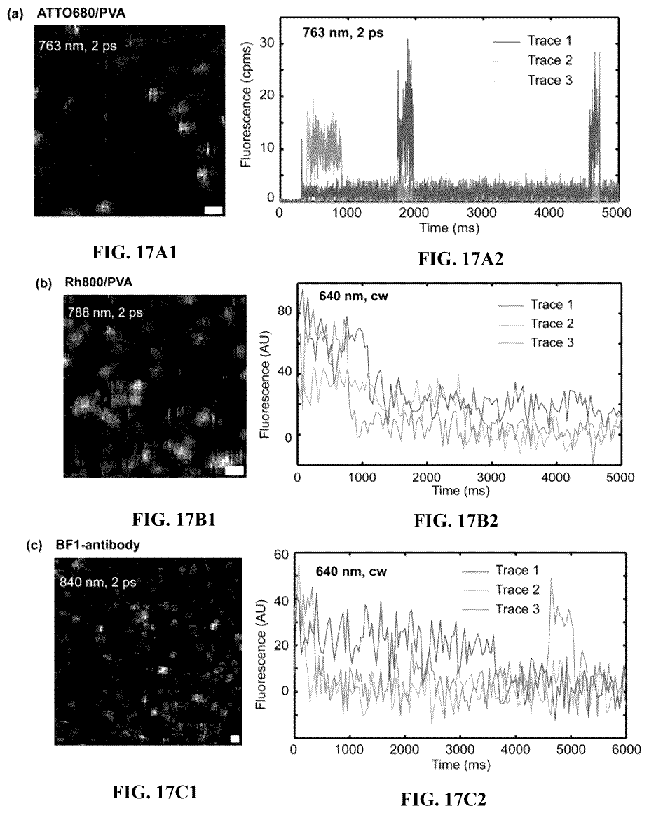

With the superb BonFIRE sensitivity in solutions for both C═C and C≡N bonds, it was next aimed to perform single-molecule IR imaging. It was first characterized the spatial resolution of BonFIRE microscope on 100-nm fluorescent beads, obtaining lateral and axial resolutions of 600 nm and 1.8 μm, respectively (FIGS. 15A1-B), close to the diffraction limit of the probe beam. It was then obtained single-molecule samples following two common approaches (Methods in Example 5) and confirmed the sample quality by observing single-step photobleaching, including “half-moon” bleach in scanning (FIG. 16A) and sudden photobleaching in situ (FIG. 16B and FIGS. 17A-C). It was next confirmed the BonFIRE peaks of C═C bonds in both ATTO680 and Rhodamine 800 (Rh800) in concentrated dye/polyvinyl alcohol (PVA) aggregates to be 1598 cm⁻¹ (FIG. 16C).

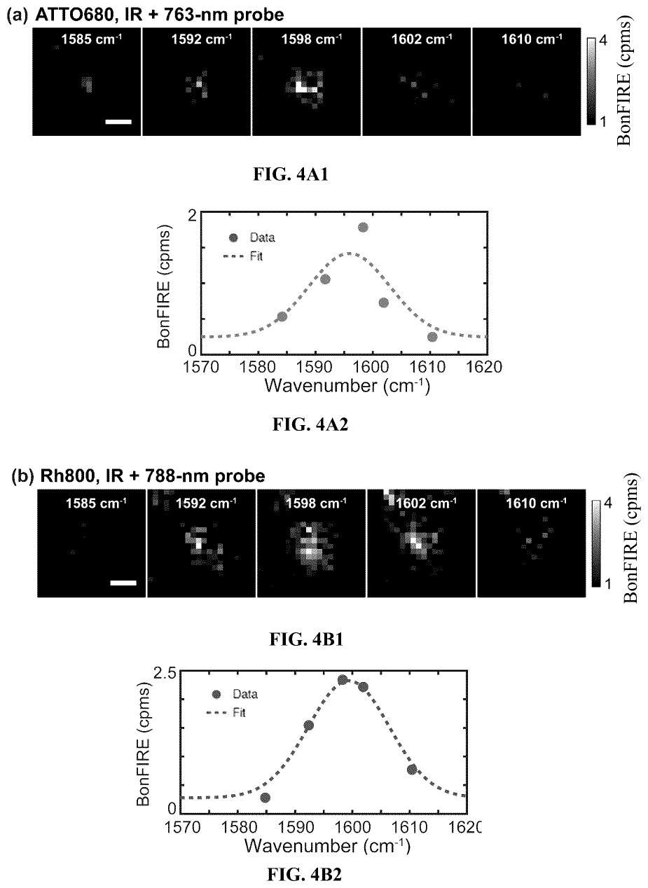

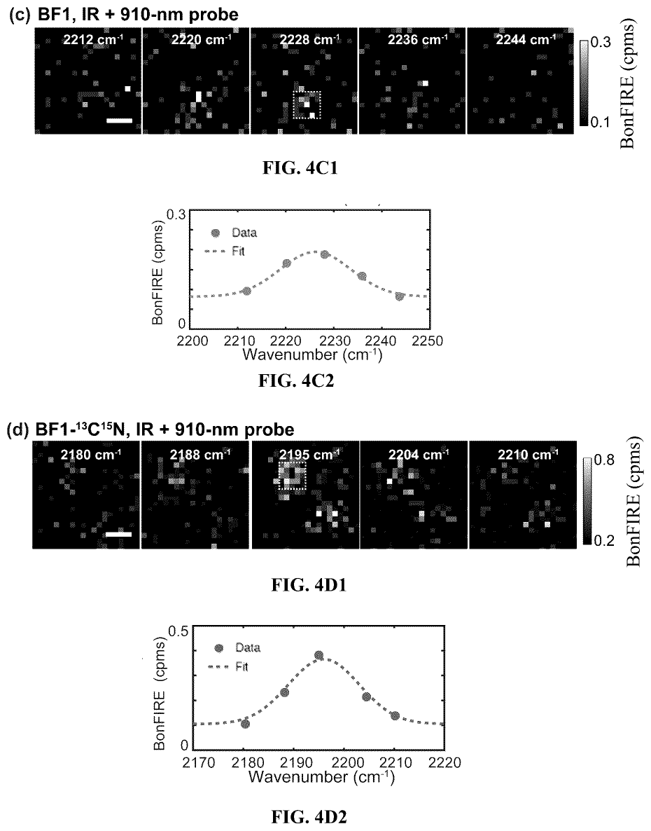

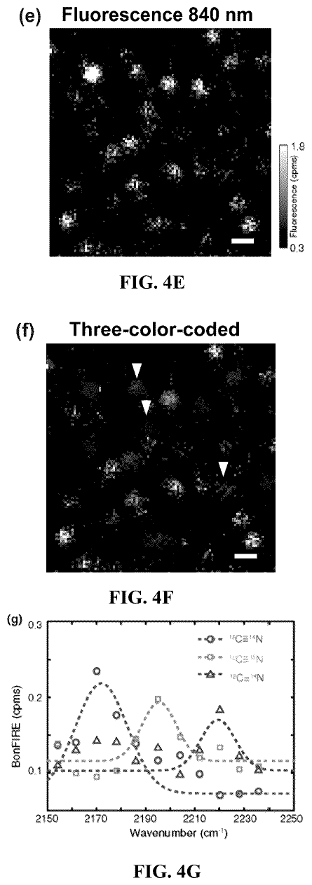

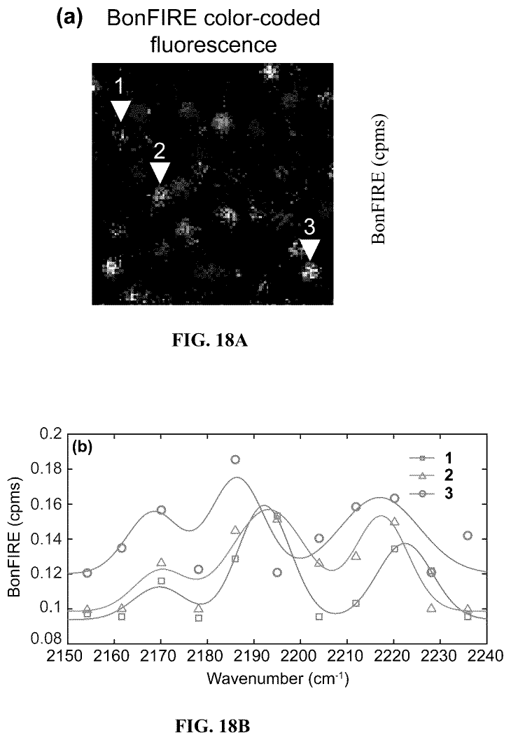

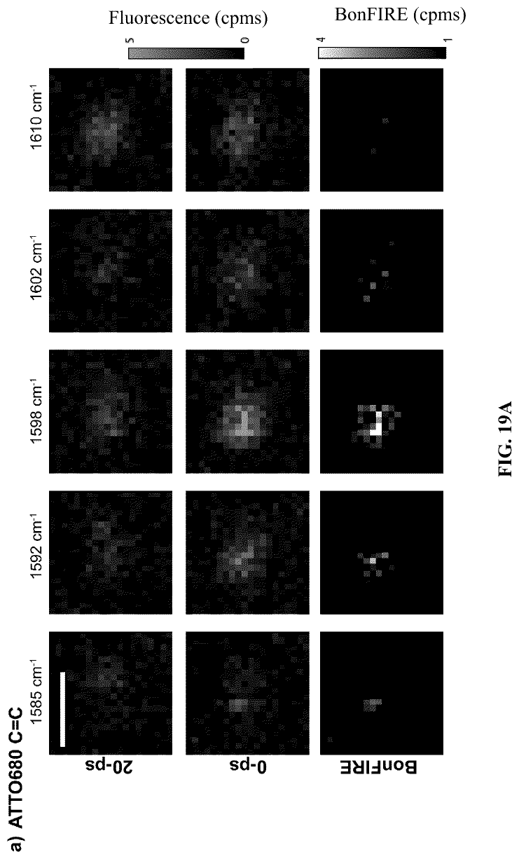

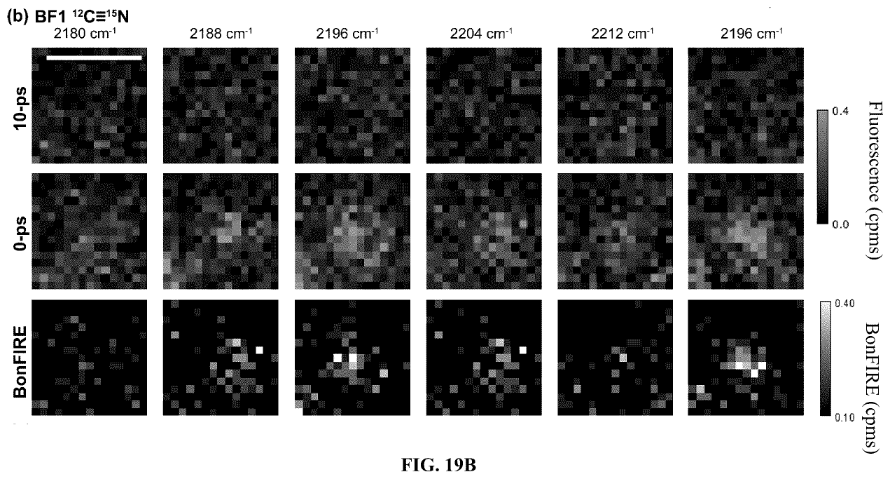

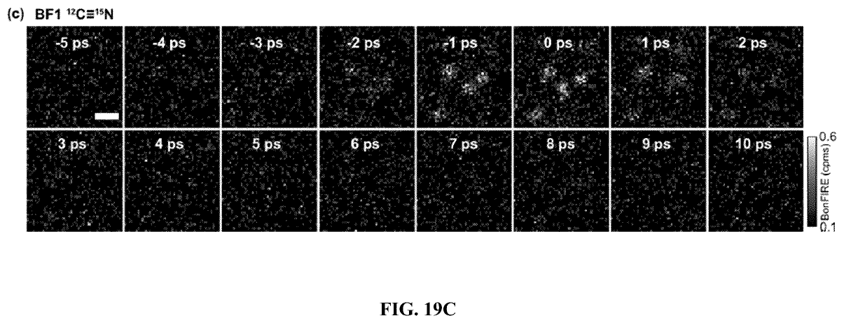

Single-molecule BonFIRE images were obtained for C═C bonds in ATTO680 and Rh800 (FIGS. 4A1-B2), where the most intense signal appears at the on-resonance frequency of 1598 cm⁻¹ and diminishes sharply toward the off-resonance frequencies. Compared to solution data in FIG. 2B, the S/B in FIGS. 4A1-B2 (raw data in FIGS. 19A-C) is increased due to the much-reduced photothermal effect in diluted single-molecule sample distribution and the IR-transparent PVA matrix. The fitted spectra at the single-molecule level closely resemble the bulk spectra (FIGS. 4A2 and 4B2). It was also achieved single-molecule imaging and spectroscopy for the weaker C≡N bonds in BF1 and the isotope-labeled (i.e., ¹³C≡¹⁵N) BF1-conjugated antibodies (FIGS. 4C1-D2). The vibrational peaks at 2228 cm⁻¹ and 2195 cm⁻¹ were recovered for ¹²C≡¹⁴N and ¹³C≡¹⁵N, respectively (FIGS. 4C2 and 4D2). With such ultimate-level sensitivity, it was demonstrated the unexpected and unprecedented resolvability of identifying the single-molecule C≡N isotopologues of BF1 based on BonFIRE spectra. FIG. 4E shows the fluorescence image of a mixture of BF1-¹³C≡¹⁴N, ¹²C≡¹⁵N, and ¹²C≡¹⁴N single molecules. The same image could then be color-coded (FIG. 4F) by assigning the vibrational identities based on their in-situ BonFIRE spectra (FIG. 4G). Notably, it was also resolved more than one color and revealed the co-existence of multiple isotopologues within the same diffraction-limited spot (FIGS. 18A-B). To the best of Applicant's knowledge, this is the first all-far-field single-molecule IR imaging and spectroscopy. The reproducibility and robustness of BonFIRE single-molecule imaging are shown in FIGS. 19A-C, where the S/B ratios of C≡N reach ˜3. The imaging results demonstrated here bring the sensitivity of BonFIRE comparable to that of confocal fluorescence, which could enrich cutting-edge single-molecule techniques such as super-resolution microscopy with vibrational information and selectivity.

### Example 4

### Bond-Selective Bioimaging by BonFIRE Microscopy

This example describes details of bond-selective bioimaging by BonFIRE microscopy.

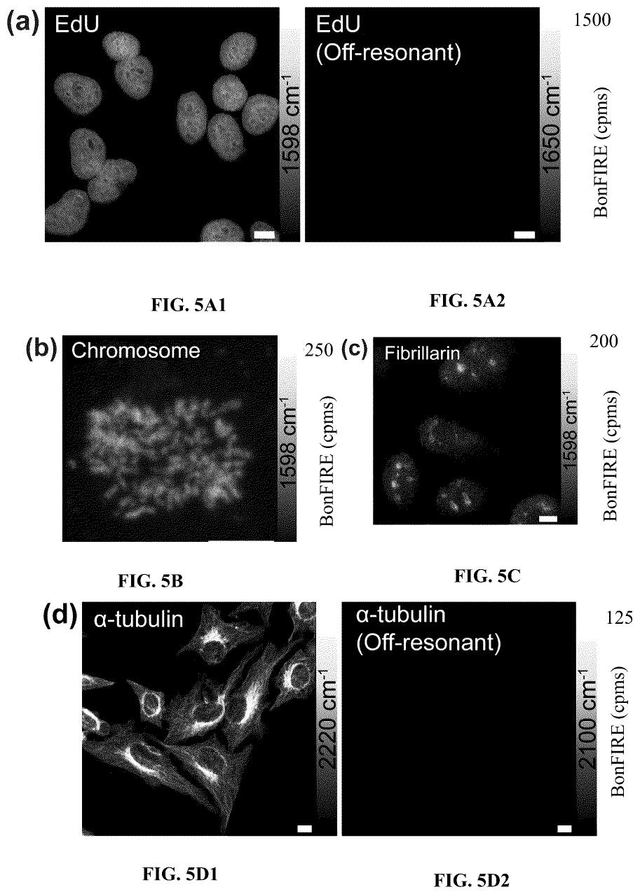

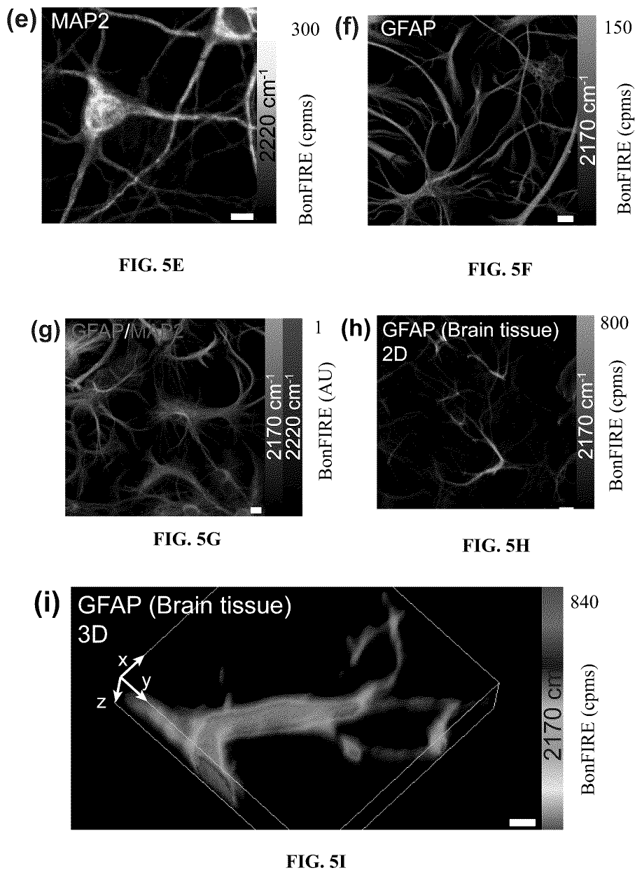

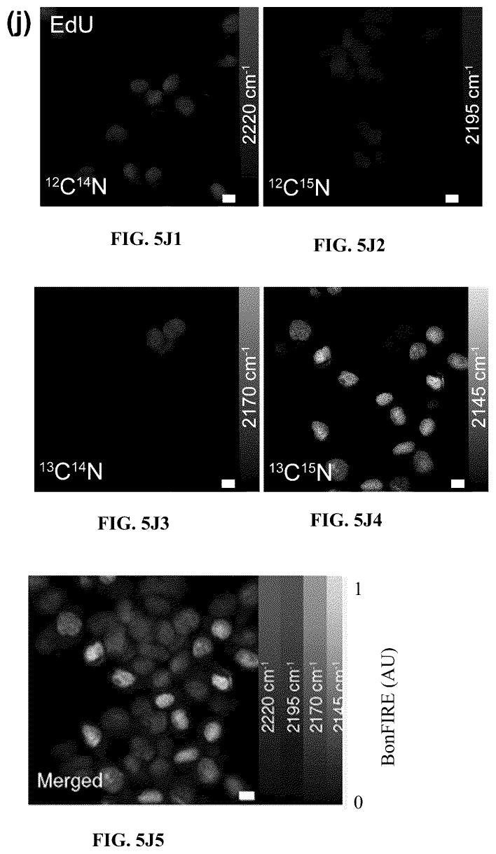

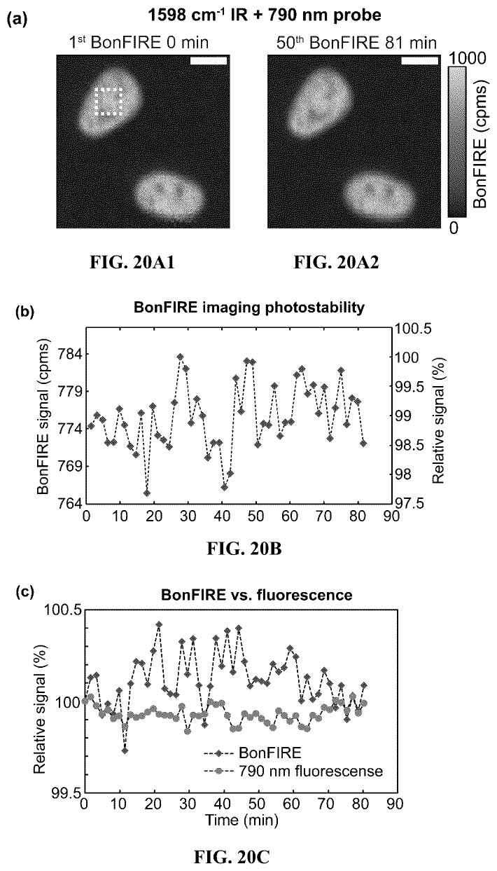

With narrow bond-selectivity and single-molecule sensitivity, it was sought to explore BonFIRE's bio-imaging compatibility. FIG. 5A1 shows a BonFIRE image of ATTO680-azide-click-labeled 5-ethynyl-2′-deoxyuridine (EdU) from newly synthesized DNA in HeLa cells, targeting the C═C vibration at 1598 cm⁻¹ for ATTO680. As expected, a clear pattern of cell nuclei is highlighted. Tuning the IR to an off-resonant frequency with the same probe setting yielded a dark background (FIG. 5A2, 1650 cm⁻¹), underlining the bond-selectivity. Negligible photobleaching in BonFIRE was confirmed by continuously scanning the same area of the ATTO680-labeled EdU over 100 frames with only ˜1% signal fluctuations (FIGS. 20A1-B), comparable to that from direct electronic excitation from the probe laser alone (FIG. 20C). To showcase the high spatial resolution, it was imaged ATTO680-click-labeled EdU in extracted chromosomes and ATTO680-immunolabeled fibrillarin from nucleoli (FIGS. 5B and 5C, 1598 cm⁻¹), with spatial contrast close to that of standard confocal fluorescence.

In addition to C═C bonds, it was performed cell-silent BonFIRE imaging targeting C≡N bonds. FIG. 5D1 displays the spatial pattern of BF1-immunolabeled a-tubulin targeting its C≡N vibration at 2220 cm⁻¹. Detailed contrast from microtubules in the cytoskeleton of HeLa cells is clearly shown. Such low-abundance delicate cellular structures would not have been detected by mid-IR-photothermal or photoacoustic imaging. At the off-resonant frequency, BonFTRE signals disappear, confirming the bond-selectivity (FIG. 5D2). It was then applied the C≡N BonFIRE to map the distribution of MAP2 and GFAP, characteristic marker proteins for mature neurons and astrocytes, respectively, and obtained highly-specific images with BF1 and its ¹³C≡¹⁴N isotopologue immuno-labeled antibodies in neuronal co-cultures (FIG. 5E-F). Such narrowband resolvability also allows two-color imaging for BF1-MAP2 neurons and BF1-¹³C≡¹⁴N-GFAP astrocytes in the same neuronal co-culture (FIG. 5G), although the absorption and the emission spectra of BF1 and BF1-¹³C≡¹⁴N are non-differentiable (FIG. 14). BonFIRE also applies to tissue imaging, exemplified by a high-resolution image (FIG. 5H) and a 3D volumetric rendering (FIG. 5I) of BF1-¹³C≡¹⁴N immunolabeled GFAP in brain tissues. To exploit the full potential of vibrational super-multiplexed imaging that breaks the “color barrier” in standard fluorescence, it was extended the two-color imaging (FIG. 5G) to the four isotopologues of BF1 for four-color BonFIRE vibrational imaging of click-labeled and mixed HeLa cells (FIG. 5J1-5). Combining the narrowband selectivity, isotope-edited multiplexed probes, and specific labeling methods, BonFIRE microscopy could encode rich vibrational information into fluorescence, opening new avenues for resolving many biomolecular targets in complex biosystems.

### Example 5

### Background-Free BonFIRE Bio-Imaging

This example describes details of background-free BonFIRE bio-imaging.

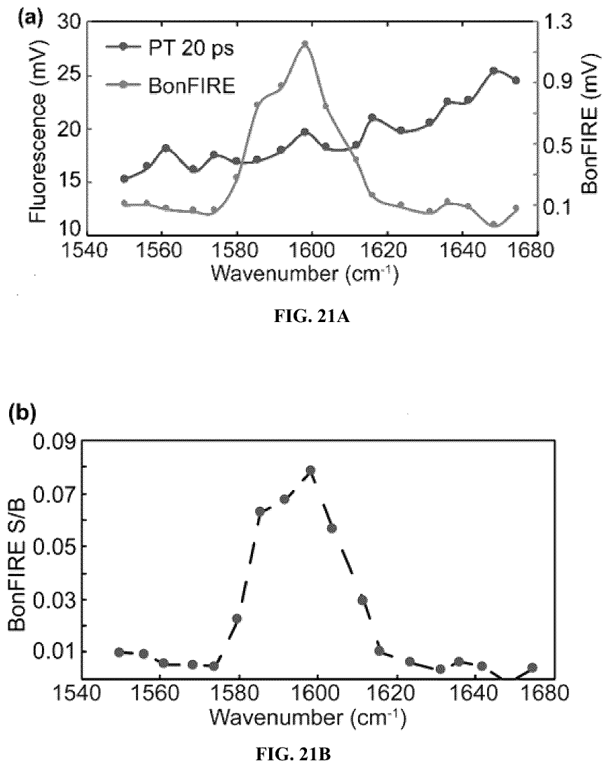

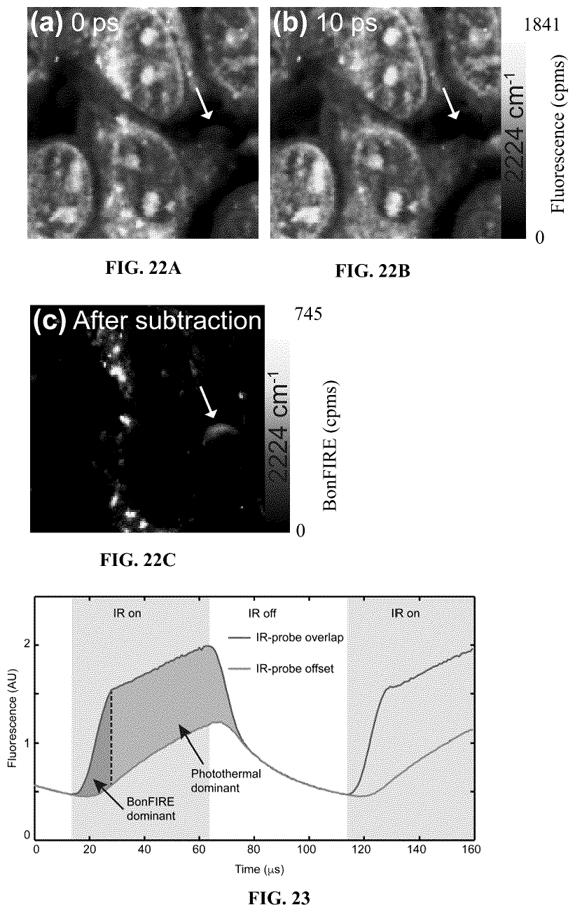

While the BonFIRE spectro-microscopy displays high-contrast imaging capability with single-molecule sensitivity, the present obtainable S/B is only 8% for C═C bonds in ATTO680 (in DMSO) and 23% for C≡N bonds in BF1 (in PBS). Such a high background is composed of two major sources: anti-Stokes fluorescence caused by the probe laser alone from the thermal (hot bands) population, and the IR-induced photothermal modulation of fluorescence (FIG. 6A), which is not vibrationally sensitive from the reporter dyes (FIGS. 21A-B), but should originate from the collective solvent/background absorption. That is the IR-induced photothermal modulation of fluorescence is absent of vibrational signatures as it mainly comes from the collective solvent/background absorption. For the images obtained above, it was retrieved pure signals (vibrational-specific BonFIRE signals) by subtracting the BonFIRE images at non-overlapped delays (e.g., t_{D}=20 ps and 10 ps for C═C and C≡N) from that at overlapped delays (e.g., t_{D}=0 ps and 1.5 ps for C═C and C≡N) (i, e, images taken at t_{D}=0 ps from that at t_{D}=20 ps for C═C measurement; and subtracting those at t_{D}=1.5 ps from that at t_{D}=10 ps for C≡N). However, such subtraction from consecutive image acquisitions slows down imaging speed. In addition, subtraction artefacts exist when the sample moves between two consecutive frames (FIGS. 22A-C). More importantly, while the careful post-processing alignment for drift correction worked fine for imaging fine structures (e.g., tubulin, extracted chromosome), it shows limited improvements in live-cell cases (FIGS. 22A-C). Without being bound to a theory, it was believed that a fast modulation on the IR beam in the MHz range should significantly remove both backgrounds, as the modulation instantaneously removes the probe-alone anti-Stokes background, and the photothermal background builds up at the timescale of tens of μs (FIG. 23).

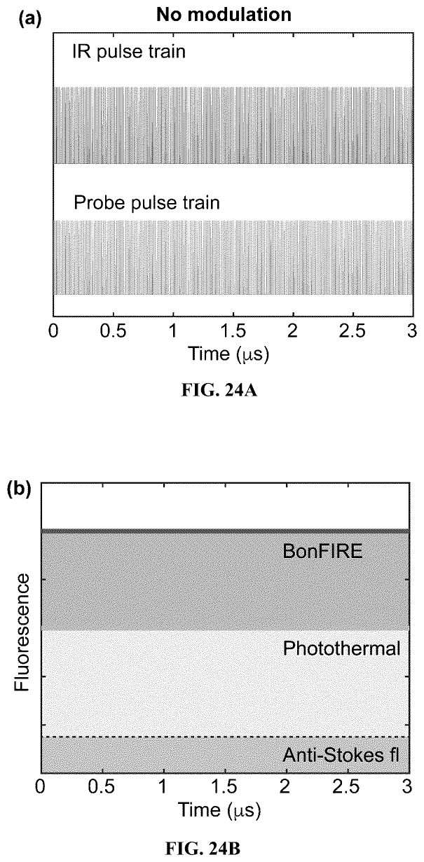

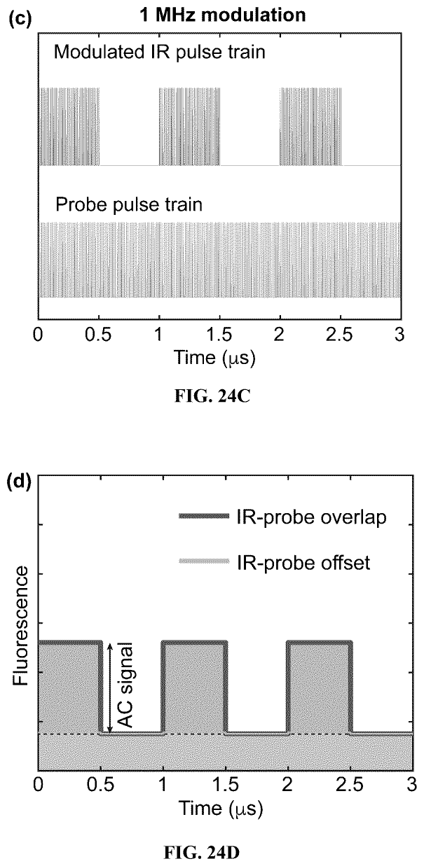

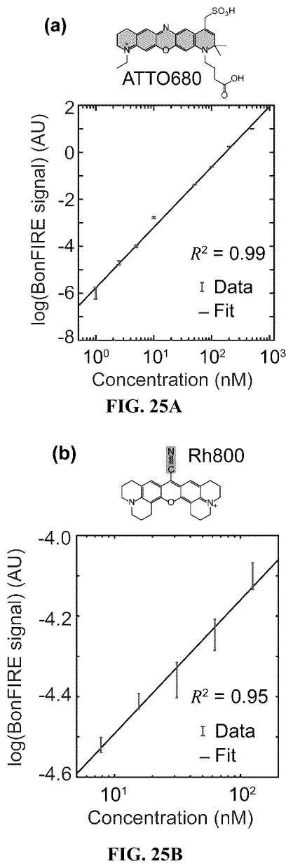

To this end, it was installed an acoustic optical modulator (AOM) in the IR light path and used the first-order diffraction from modulated AOM as the IR source (FIG. 6B). Correspondingly, the SPCM was replaced by a photomultiplier tube (PMT) with an 80-MHz bandwidth for fast signal detection. The demodulated AC signals from a lock-in amplifier were recorded as BonFIRE signals (FIGS. 24A-D). Although PMT has a lower quantum efficiency than SPCM, the single-molecule sensitivity in solution could still be reached (FIGS. 25A-B). Experimentally, it was confirmed that background and noise decrease exponentially as modulation frequency increases (FIG. 6C, insets), with S/B and S/N leveling off at approximately 2 MHz (FIG. 6C).

Background-free BonFIRE imaging targeting C═C and C≡N bonds was directly obtained from multiple biomolecule targets without subtraction, especially for fine structures and live-cell imaging needing temporal resolution. For instance, FIGS. 6D1-2 show images from ATTO680-click-labeled-EdU at both t_{D} of 0 ps (FIG. 6D1) and 20 ps (FIG. 6D2), where signals at 20 ps were turned-off. Similarly, in FIGS. 6E1-2, both background-free BonFIRE images of BF1-¹³C≡¹⁵N-immuno-labeled a-tubulin of HeLa cells and BF2-click-labeled EdU of extracted chromosomes present clear spatial resolution with high S/Ns on fine subcellular structures. The elimination of two-frame subtraction allows BonFIRE to image live cells (FIG. 6f, for both C═C and C≡N) and capture dynamic information. As shown in FIG. 6G, the dividing process of Rh800-stained live HeLa cells was time-lapse imaged. The stained mitochondria migrate from peripherals and dividing junction to the whole cell body as the cell goes through telophase to cytokinesis. The background-free BonFIRE is hence imperative for obtaining spatial and kinetic information in live-cell imaging with bond-selectivity.

### Example 6

### Methods: Experimental Setup of BonFIRE

This example further describes details of methods and experimental setup of BonFIRE.

In FIG. 1C, the NIR-OPO including the 80 MHz mode-locked Yb fiber laser (laser 1, PicoEmerald), the IR-OPO (laser 2, Levante IR), and DFG (laser 3, Harmonixx DFG) from Applied Physics & Electonics, Inc were used for BonFIRE measurements. Lasers 2 and 3 were purged with N₂. The BonFIRE probe power from NIR-OPO was controlled by the internal software and a series of neutral density filters (NDK01, Thorlabs). The IR power of IR-OPO idler was controlled by a half-wave plate (WPLH05M-5300, Thorlabs) and a polarizer (WP25H-C, Thorlabs). The IR power of DFG was controlled by the rotation (phase matching condition) of the DFG crystal.

The probe beam from the NIR-OPO was first guided to a spatial filter with a 70-m pinhole (P75HK, Thorlabs) to obtain a Gaussian beam profile and then expanded by a pair of lenses by a factor of 4. The IR beam was first expanded by a factor of 1.5 through a pair of off-axis parabolic mirrors (with unprotected gold coatings, Thorlabs) and then focused onto the stage through a ZnSe lens (6-mm focal length, NA=1, Edmund). The probe beam was focused through a water-immersed objective with NIR coatings (25×, NA=1.05, Olympus). IR and probe beams were guided to a customized stage-scan confocal microscope (Cerna series, Thorlabs). The spatial overlap of the probe and IR foci was achieved by mounting the ZnSe lens on an XY translational stage (ST1XY, Thorlabs) with piezo inertia actuators (PIAK10, Thorlabs) for fine adjustments. For image acquisition, it was used a 3D scanning piezo stage (P-545, PI) and a customized LabVIEW program to synchronize scanned positions and record fluorescence readings from the detector. A delay stage (DL325, Newport) was added to the light path of the probe beam to control probe-IR delays.

All solution samples were sandwiched between a 0.3-mm thick CaF₂ window (Crystran) on the probe side and a 0.5-mm thick CaF₂ window (Crystran) on the IR side with a thin PTFE spacer (Harrick) with thicknesses of 6-54 μm. All other samples were either deposited and dried on a 0.3-mm thick circular CaF₂ window or sandwiched between two CaF₂ windows with a spacer and filled with medium (e.g., D₂O and PBS). A customized sample holder was machined to mount CaF₂ windows on the piezo stage. For the quick finding of sample areas of interest, a CMOS camera (CS165CU, Thorlabs) was installed after the tube lens.

Fluorescence signals were separated and collected by a set of a long-pass dichroic mirror and filter (Semrock) through epi-detection and collected by a single-photon counting module (SPCM-AQRH-16, dark count 11 cps, Excelitas). The collected fluorescence was focused by a tube lens (150-mm focal length) onto the 180-μm aperture of the SPCM, ensuring a loose confocal condition. The TTL counts from SPCM were recorded by a multifunctional data acquisition card (PCIe-6351, National Instruments) in the counter mode and read by the customized LabView program. SPCM readings were corrected according to the calibration curve provided by the manufacturer during post-processing. For ATTO680 C═C, the dichroic/filter set was FF738-FDi01/FF01-665/150 (Semrock). For BF1 C≡N, the dichroic/filter set was Di02-R830/FFO1-775/140 (Semrock). For single-molecule imaging of BF1 C≡N, double filters (FF731/137 and FF709/167, Semrock) were used to minimize the background.

For background-free BonFTRE shown in FIG. 6B, IR modulation was enabled by two AOMs with coatings centered at 4500 nm (GEM-40-4-4500/4 mm, Brimrose) for C≡N and 6282 nm (GEM-40-4-6282/4 mm, Brimrose) for C═C. The IR was focused on the AOM aperture (4 mm) and collimated by a pair of CaF₂ (LA5255, Thorlabs) or ZnSe (LA7228-E2, Thorlabs) lenses. A 0-5V square wave trigger was generated by a function generator (DG2102, RIGOL) to trigger the AOM. The same trigger was routed to the reference input of a lock-in amplifier (HF2LI, 50 MHz bandwidth, Zurich) for signal demodulation. Fluorescence was detected by a PMT (PMT1002, Thorlabs) installed after a 400-μm confocal pinhole (P400K, Thorlabs). The voltage signal from PMT was routed to the lock-in amplifier for the demodulation. The original DC signal from PMT and AC signal from the lock-in amplifier were read by the same DAQ card in analog input mode simultaneously and processed in the customized LabVIEW program. For FIG. 23, IR modulation was implemented by a chopper (MC2000B, Thorlabs) at 10 kHz.

For widefield BonFIRE microscopy in FIGS. 29A-G3, the SPCM in FIG. 1C was replaced by an sCMOS camera (ORCA-Fusion BT, Hamamatsu, with 2304×2304 square detectors and each detector is 6.5 μm×6.5 μm). The same water-immersed objective used in point-scan (NA=1.05, Olympus) and a 200-mm focal length tube lens (AC254-200-B, Thorlabs) were used to achieve a 27.8× magnification, resulting in a 0.23-μm pixel size on the image plane on camera. A ZnSe lens (NA=1, Edmund) was used to focus the IR beam to a spot of ˜5 μm diameter to guarantee the maximal IR transition for the single-molecule sensitivity. The illumination area of the probe beam was enlarged to ˜10 μm by adjusting the expansion telescope (shown in FIG. 1C) so that a mildly diverging beam enters the back aperture of the objective. The probe power was increased to maintain a photon flux and S/N similar to those of point-scan configuration for the single-molecule sensitivity. The field of view (FOV) of BonFTRE was measured to be 5 μm (FIG. 29A) from a Rh800-stained PVA thin film. Each widefield BonFIRE image is formed by subtracting two consecutive fluorescence frames, one at t_{D} of 0 μs and the other at 20 μs, to completely remove the photothermal background. For fast single-FOV imaging demonstrated in FIGS. 29G1-3 of ATTO680-labeled EdU, 2-ms imaging speed per BonFIRE frame is achieved from the subtraction of the two consecutive fluorescence frames each with ˜1 ms exposure. For scanning and stitching individual FOVs to form a large-area image (FIG. 2911), it was picked a smaller square FOV with size of 3 μm at the center, where the illumination is uniform. The step size of the piezo sample stage (P-545, PI) was then set to match 3 μm during the scan. A customized LabVIEW code was used to synchronize image acquisition with the stage scan. The total time needed for capturing all frames used in FIG. 29H (87×87 μm², 29×29 FOVs) is 51 s, about 30 times faster than using the point-scan scheme with the same parameters (i.e., pixel size and dwell time). The total time needed for stitching large-area images was mostly dominated by the movement speed of the piezostage and the time needed for the data synchronization between the camera and PC (˜60 ms per step instead of 2 ms). For biological samples where the single-molecule sensitivity is not needed (e.g., EdU-labeled nuclei), the acquisition time can be further reduced by expanding IR and probe illumination with increased FOV (e.g., from 3×3 μm² to 10×10 μm²).

For BLIM images shown in FIGS. 27A-N, all data were collected based on the background-free BonFIRE setup (FIG. 6B) using IR modulation and lock-in demodulation, at multiple t_{D} steps with small spacings. The signal decay at each pixel is then fitted with a single exponential function to extract the 1/e vibrational lifetime.

### Example 7

### Modeling of the Double-Resonance in BonFIRE

This example describes details of modeling of the double-resonance in BonFIRE.

Similar to physical modeling in SREF, it is feasible to model the BonFTRE process with a three-level system (FIG. 9A) with populations of N₁, N₂, and N₃. The transition rates between the three states can be written as q₁₂ (IR-excitation rate), q₂₃ (probe up-conversion rate), and v₂₁ (vibrational relaxation rate). The rate equations can be written as follows:

$$\frac{{dN}_{1}}{dt} = {q}_{12} ( {N}_{2} - {N}_{1} ) + {v}_{21} {N}_{2} \qquad ( 1 )$$

$$\frac{{dN}_{2}}{dt} = {q}_{23} ( {N}_{3} - {N}_{2} ) + {q}_{12} ( {N}_{1} - {N}_{2} ) - {v}_{21} {N}_{2} \qquad ( 2 )$$

$$\frac{{dN}_{3}}{dt} = {q}_{23} ( {N}_{2} - {N}_{3} ) \qquad ( 3 )$$

Table 4 summarizes absorption coefficients and calculated F-C factors of six triple-bond bearing dyes. Considering the C≡N bond of BF1 with IR extinction coefficient of 70 M-1 cm⁻¹ (2.7×10⁻¹⁹ cm² per molecule). With 100-mW IR power on the sample at 2224 cm⁻¹ (4496 nm), there are about 2.8×10¹⁰ IR photons in one pulse (the laser repetition rate is 80 MHz). The diffraction-limited focal area of IR is λ²/4≈5.1×10⁻⁸ cm². The transition rate q₁₂ for a single molecule could be estimated as:

$${q}_{12} = \frac{2.8 \times {10}^{10} \times 2.7 \times {10}^{- 19}}{5.1 \times {10}^{- 8} \times 2 \times {10}^{- 12}} {s}^{- 1} = 7.4 \times {10}^{10} {s}^{- 1} \qquad ( 4 )$$

For the second up-conversion step, it was used the extinction coefficient of 1.2×10⁵ M⁻¹ cm⁻¹ at the absorption peak of BF1 as an estimation of the electronic cross-section (4.6×10⁻¹⁶ cm²) and use an F-C factor of 0.1. It was assumed a probe (890 nm) power of 10 mW with 5.6×10⁸ photons per pulse. The probe focal area can be estimated from the spatial resolution measurements, which is 3.6×10⁻⁹ cm². Therefore:

$${q}_{23} = \frac{5.6 \times {10}^{8} \times 4.6 \times {10}^{- 16} \times 0.1}{3.6 \times {10}^{- 9} \times 2 \times {10}^{- 12}} {s}^{- 1} = 3.6 \times {10}^{12} {s}^{- 1} \qquad ( 5 )$$

Finally, it was assumed the vibrational lifetime of C≡N to be 0.4 μs, which is estimated from the 13 cm⁻¹ linewidth obtained by deconvoluting the Gaussian peak in FIG. 3E with 8 cm⁻¹ laser bandwidth. Thus, v₂₁=2.5×10¹² s⁻¹.

Similarly, for BF1 C═C bonds, it can be obtained q₁₂=(3.8×10⁹×1.5×10⁻¹⁷)/(9.8×10⁻⁸×2×10⁻²)s⁻¹=3.0×10¹¹ s⁻¹ for 10 mW IR power at 6257 nm (1598 cm⁻¹) and q₂₃=(5.3×10⁸×4.6×10⁻¹⁶×0.1)/(3.6×10⁻⁹×2×10⁻²)s⁻¹=3.4×10¹² s⁻¹ for 10 mW probe power at 845 nm. It was used a longer lifetime of 0.6 μs and V₂₁=1.7×10¹² s⁻¹ for C═C. Given all these values, it can numerically be solved rate equations (1-3) and investigate the properties of BonFIRE signals.

First, changes in N₂ and N₃ are plotted over time in FIGS. 9B&E for double and triple bonds, respectively. The vibrationally excited-state population of N₂ saturates within the 2-ps duration. The electronic excited-state population N₃, which is proportional to the emitted fluorescence, also starts to level off at the end of the 2-ps duration. The saturated N₃ can be found by arbitrarily extending the pulse duration to 10 μs, and the N₃ from 2-ps excitation is already 82% of the saturated value for C═C and 88% for C≡N. The transition efficiency of BonFIRE could be defined as N₃/N₁. As a result, transition efficiencies are 10.0% and 2.4% for C═C and C≡N, respectively, with ²-ps radiations. The transition efficiency could be improved using shorter fs radiations with higher pulse energy. However, fs pulses lack the necessary spectral resolution for the desired bond-selectivity in bioimaging. In this regard, 2-ps pulses reach a balance between the high spectral resolution (˜8 cm⁻¹) and sufficient transition efficiency. Note that by updating the used lifetimes of 0.6 μs for C═C and 0.4 μs for C≡N with 1.8 μs and 0.9 μs (experimentally obtained from BonFIRE), transition rates of C═C and C≡N can increase up to 14.8% and 3.8%, respectively.

In FIGS. 9C-D and FIGS. 9F-G, N₃ is plotted as the function of transition rates q₁₂ and q₂₃, respectively. A monotonic trend, which is linear at the beginning and saturates later, is observed in both curves. This trend successfully reproduces the experimental observations of probe power dependence in FIG. 2E and FIG. 3G. Regarding the IR excitation rate, the trend is quite linear within the experimental conditions, which agrees well with the linear trend observed in FIG. 2D and FIG. 3F.

### Example 8

### Linear Unmixing Post-Processing

This example describes details of linear unmixing post-processing.

The BonFIRE signal (S) can be expressed as a multiplication of the normalized cross sections matrix (M) and dye concentrations (C). Using the cross-section matrix of C≡N BF1 isotopologues derived from FIG. 3H, unmixed images in FIGS. 5G&J1-5 were generated via matrix multiplication C=M'S implemented using MATLAB.

### Example 9

### Materials

This example describes additional details of Materials as used herein.

Dyes. ATTO dyes were purchased from ATTO-TEC GmbH, Alexa dyes were purchased from Thermo Fisher, cyanine dyes were purchased from Lumiprobe, Nile blue A, and Rhodamine 800 were purchased from Sigma Aldrich. All dyes were aliquoted in DMSO as stock solutions (10 mM) upon receiving and stored at −20° C. Synthesis of customized BF dyes and their isotopologues was conducted using published procedures. Details are shown in Table 2.

Antibodies. Primary antibodies: Anti-a-tubulin in rabbit (ab18251, Abcam); Anti-GFAP in mouse (3670S, Cell Signaling Technology); Anti-MAP2 in rabbit (ab32454, Abcam). Secondary antibodies: Goat anti-mouse antibody (31160, Invitrogen); Goat anti-rabbit antibody (31210, Invitrogen).

### Example 10

### UV-Vis Absorption, Fluorescence Emission, and FTIR

This example describes additional details of UV-vis absorption, fluorescence emission, and FTIR as used herein.

UV-vis spectra were obtained from dye solutions with concentrations of 1-10 μM in DMSO or PBS on a Varian Cary 500 Scan UV-Vis near-IR spectrophotometer (Agilent). Fluorescence emission spectra were recorded on an RF-6000 spectrofluorometer (Shimadzu) with dye concentrations of 1˜10 μM in DMSO or PBS. FTIR spectroscopy was performed with a N₂-purged VERTEX 80v FTIR spectrometer (Bruker). 10˜20 μL of dye solutions in DMSO with high concentration (e.g., 10 mM) were sandwiched between two CaF₂ windows with a PTFE spacer in between. CaF₂ windows were then mounted in the sample cell for the IR transmission measurement. The DMSO backgrounds were recorded as a reference and corrected by post-processing.

### Example 11

### Preparation of Single-Molecule Samples

This example describes additional details of preparation of single-molecule samples as used herein.

For the spin-coated samples, a dilute solution of dyes (5-20 μM) in 0.2% PVA was prepared freshly from the stock solution and then deposited on a new CaF₂ window by a spin coater (BSC-100, MicroNano Tools) at 5000 rpm for 30 s. This method is common for preparing single-molecule dye samples. For dye-antibody conjugates, the CaF₂ window was first coated with poly-l-lysine by incubating 200 μL of 0.01 mg/mL poly-l-lysine (Sigma) on the surface at room temperature for 1 h. Then, the CaF₂ window was rinsed with DI water several times before being incubated with diluted (e.g., 1×10⁶ diluted from the stock) dye-antibody solutions for 40 min. Finally, the sample was rinsed with DI water and dried under air at room temperature. This method is common for preparing single-molecule dye-protein conjugates. The concentrations of BF1-antibody stock solutions for ¹³C≡¹⁴N, ¹²C≡¹⁵N, and ¹²C≡¹⁴N are 0.93 mg/mL, 0.51 mg/mL, and 1.54 mg/mL with dye: protein ratios of 2.4, 1.7, and 2.6, respectively, confirmed with UV-vis absorption measurements. For the mixed single-molecule sample in FIG. 4E, the BF1-antibody stock solutions of ¹³C≡¹⁴N, ¹²C≡¹⁵N, and ¹²C≡¹⁴N were diluted by 0.5×10⁶, 1×10⁶, and 0.75×10⁶ times in PBS and incubated on a poly-l-lysine coated CaF₂ window simultaneously for 30 min.

### Example 12

### Preparation of Biological Samples

This example describes additional details of preparation of biological samples as used herein.

HeLa culture. Cultured HeLa-CCL2 (ATCC) cells were seeded onto 0.3-mm thick CaF₂ windows with a density of 1×10⁵ cells/mL in 4-well plates with 0.3 mL DMEM culture medium at 37° C. and 5% CO₂. DMEM culture medium was made of 90% Dulbecco's modified Eagle medium (DMEM; 11965, Invitrogen), 10% fetal bovine serum (FBS; 10082, Invitrogen), and 1× penicillin/streptomycin (15140, Invitrogen). For the cells with EdU labeling, DMEM culture medium was then changed to DMEM medium (FBS-free, Gibco) for 20-22 h for cell cycle synchronization. After synchronization, the medium was replaced back to DMEM culture medium and EdU (10 mM stock in H₂O) was simultaneously added with a concentration of 100 μM for 20-24 h. Then 4% PFA was added for 20 min for fixation. After that, DPBS was used to wash away PFA and fixed cells could be stored in DPBS at 4° C. for several days.

Neuron culture. Primary rat hippocampal neurons were isolated from neonatal Sprague-Dawley rat (CD® (Sprague Dawley) IGS Rat, Charles River) pups with a protocol (IA22-1835) approved by Caltech's Institutional Animal Care and Use Committee (IACUC). The brains were dissected from the skull and placed into a 10 cm petri dish with ice-chilled HBSS (Hanks' Balanced Salt Solution, Gibco). The hippocampus was isolated from the brains under a dissection scope, cut into small pieces (˜0.5 mm), and incubated with 5 ml of Trypsin-EDTA (0.25%, Gibco) at 37° C. with 5% CO for 15 min. The Trypsin-EDTA liquid was carefully aspirated and replaced with 2 ml of DMEM containing 10% FBS to stop the digestion. The tissue fragments were changed into 2 mL neuronal culture medium (Neurobasal A medium, B-27 supplement, GlutaMAX supplement, Thermos Fisher, and 1× penicillin-streptomycin) and were dispersed by repeated pipetting several times. The sediment was discarded, and the supernatant was collected and further diluted by neuronal culture medium to a final cell density of 9×10⁴ cells/mL. A 0.7-ml volume of cell suspension was added to each well of a 24-well plate on the coated CaF₂ windows. For pre-coating, sterile CaF₂ windows were incubated with 100 μg/ml poly-D-lysine (Sigma) solution at 37° C. with 5% CO₂ for 24 h in a 24-well plate. The CaF₂ windows were washed twice with ddH2O and incubated with g/ml laminin mouse protein (Gibco) solution at 37° C. with 5% CO₂ overnight. Thereafter, the CaF₂ windows were washed twice with ddH₂O and allowed to dry at room temperature inside of biosafety cabinet. Half of the neuron culture medium was replaced with fresh medium every four days. At DIV14, 4% PFA was added for 20 min for fixation. After that, DPBS was used to wash away PFA and fixed cells could be stored in DPBS at 4° C. for several days.

Click-reaction of EdU labeled samples. After permeabilization, the EdU labeled cells were incubated with reaction buffer prepared following the procedure specified in the Click reaction buffer kit (C10269, Thermo Fisher). For the four-color BonFIRE imaging experiment, four cell suspensions were each clicked-labeled with the four C≡N isotopologues of BF1-azide. Then, a mixture of the clicked-cell suspensions was deposited onto a CaF₂ window.

Spread chromosome preparation. HeLa cells were seeded in a 35-cm dish and labeled with EdU. Cells were incubated with 1 μg/mL colcemid (KaryoMAX™ Colcemid™ Solution in PBS, Gibco) for 4 hours. Then cells were trypsinized into single cells with Trypsin-EDTA (0.25%, Gibco). To stop the digestion, 5 mL DMEM containing 10% FBS was added. The cell suspensions were centrifuged at 1000 rpm for 5 min and the supernatant was aspirated with about 200 μL left in the tube. Clumps were removed by gently tapping the bottom of the tube. 5 mL of ice-cold 0.56% KCl solution was added to the cell suspensions gently. After putting it at room temperature for 10 min, the cell suspensions were centrifuged at 1000 rpm for 5 min and the supernatant was aspirated with about 200 μl left in the tube. 5 ml of methanol:glacial acetic acid (3:1) fixative solution was added to the cell suspensions gently and slowly. The cell suspensions were centrifuged at 1000 rpm for 5 min and the cells were resuspended with PBS, after aspirating the supernatant. The cells were then clicked-labeled using the procedure described above. The clicked chromosomes were deposited onto a CaF₂ window and were dried for BonFIRE imaging.

Rh800-stained live HeLa cell. HeLa cells seeded on 0.3-mm thick CaF₂ windows were incubated in DMEM with 0.5-2 μM Rh800 for 30 min at 37° C. After incubation, DMEM was replaced with PBS containing 1 μM Rh800 and was transferred to the sample holder. 30 μL PBS with 1 μM Rh800 was deposited to prevent air bubbles. The CaF₂ window was then sealed using another CaF₂ window with a 12-μm-thick spacer before imaging.

Rh800-stained HeLa cell for BLIM HeLa cells fixed on 0.3-mm thick CaF₂ windows were incubated in 10 μM Rh800 (PBS) for 15 min at room temperature. After incubation, excessive dye solutions were rinsed and replaced by pure PBS. The CaF₂ window was then sealed using another CaF₂ window with a 56-μm-thick spacer for BLIM imaging.

Secondary antibody-dye conjugation. The secondary antibody was diluted to 2 mg/mL using 0.1 M NaHCO₃. To reach a final pH of ˜8.3, one-tenth volume of 1 M NaHCO₃ was added to the diluted antibody solution. To start the conjugation reaction, 3 mM of N-hydroxysuccinimide ester-activated BF1 dye was added at a dye-to-protein ratio of ˜30:1. The reaction was incubated in the dark for 1.5 h under slow stirring. Gel permeation chromatography was used to remove the excess dye from the conjugated protein. The Sephadex G-25 was first swelled at 90° C. for 1 h and was used to pack a 1 cm diameter column with >12 cm length. After the reaction, the solution was loaded onto the column and the first eluted dye band was collected. The collected proteins were then concentrated using Amicon ultra-centrifugal filters (UFC501096, EMD, Millipore) to a final concentration of 1-2 mg/mL in PBS.

Immuno-staining of fixed HeLa neurons brain tissue. Fixed cells were first permeabilized using 0.1% Triton X-100 (T8787, Sigma) for 20 min. After blocking for 1-3 h in 10% goat serum/1% BSA/0.3 M glycine/0.1% PBST, the cells were incubated overnight at 4° C. in 10 μg/mL primary antibody in 3% BSA. After washing with PBS, the cells were blocked using 10% goat serum in 0.1% PBST for 1-3 h, followed by overnight incubation at 4° C. in ˜10 μg/mL secondary antibody in 10% goat serum. The cells were blocked with 10% goat serum for 30 min and dried before imaging.

### Example 13

### BonFIRE Signal Estimation

This example provides BonFIRE signal estimation at varying field-of-view size using Rh800 as illustrated in FIG. 35. Rate equations, based on molecular balances for each energy state, were used to calculate the BonFIRE signal (photons/ms) (CITE). Maximum IR and probe powers were used for the simulation. The pulse duration is 2 μs. At field-of-view of 12.5 μm, BonFIRE signal was computed to be 1 photons/ms. Signal-to-noise ratio (SNR) can be computed by the following equations.

$$SNR = \frac{QE \cdot N \cdot t}{\sqrt{{σ}_{shot noise}^{2} + {σ}_{read noise}^{2} + {σ}_{dark horse}^{2}}} \qquad ( 6 )$$

$${σ}_{shot noise} = \sqrt{QE \cdot N \cdot t} \qquad ( 7 )$$

$${σ}_{dark noise} = \sqrt{{I}_{d} \cdot t} \qquad ( 8 )$$

where QE is quantum efficiency, N is number of photons per pixel per millisecond, t is exposure time, and I_{d} is dark current. At 12.5 μm FOV, SNR of 3 can be achieved with exposure times of 25 ms, indicating single-molecule sensitivity while achieving wide-field detection. Due to the quadratic reduction in photon flux across both probe and IR beams, the BonFIRE signal diminishes quickly with increasing FOV. As a result, at a 50 μm FOV, the BonFIRE signal drops substantially, necessitating impractically long exposure times to attain an adequate SNR.

### Example 14

### WF-BonFIRE Speed Estimation

This example provides WF-BonFIRE speed estimation relative to PT-BonFIRE. Pixel rate and pixel rate ratio R are defined as

$$pixel rate ≡ {( total acquisition time normalized by number of pixels and SNR )}^{- 1} \qquad ( 9 )$$

$${R}_{WF / PT} ≡ \frac{pixel rate for widefield}{pixel rate for point scanning} = \text{} \frac{{( \frac{{t}_{WF}}{{n}_{WF} \cdot {SNR}_{WF}} )}^{- 1}}{{( \frac{{t}_{PS}}{{n}_{PS} \cdot {SNR}_{PS}} )}^{- 1}} = \frac{{n}_{WF}}{{n}_{PS}} \frac{{t}_{PS}}{{t}_{WF}} {( \frac{{SNR}_{WF}}{{SNR}_{PS}} )}^{2} \qquad ( 10 )$$

where n is the number of pixels, t_{PT} is the pixel dwell time, t_{WF} is the camera exposure time, and SNR is the signal-to-noise ratio. Assuming the system shot noise is the dominant noise source, Equation (6) is simplified to

$$SNR = \sqrt{QE \cdot C \cdot ( k \cdot σ \cdot {I}_{IR} \cdot {I}_{probe} ) \cdot t} \qquad ( 11 )$$

where QE is quantum efficiency, C is concentration, k is a scaling constant, a is the BonFIRE cross-section, I is the peak intensity, and t is the acquisition time. Combining Equation (10) and (11),

$$R = \frac{16}{π} \cdot \frac{{A}_{{IR}_{PS}} \cdot {P}_{r}}{{ω}_{0}^{2}} where {P}_{r} ≡ \frac{{P}_{probe \_ WF}}{{P}_{probe \_ PT}} \qquad ( 12 )$$

where A_{IR_PS} is diffraction-limited area at IR wavelength, ω₀ is spot diameter, and where Pᵣ is the ratio of the probe power used for wide-field and point-scanning. Pᵣ is determined by various factors (e.g. SNR, concentration of the sample, saturation) and experimentally determined to be ˜5000 for many biological samples. Using Equation (12), R is calculated to be 153 at ω₀=50 μm and Pᵣ=5000, achieving more than two orders of magnitude increase in imaging speed compared to point-scanning. In theory, the FOV can be expanded to 620 um where the R value equals 1, at which wide-field is the same speed compared to point-scanning.

### Example 15

### Rational Design and Simulation of WF-BonFIRE

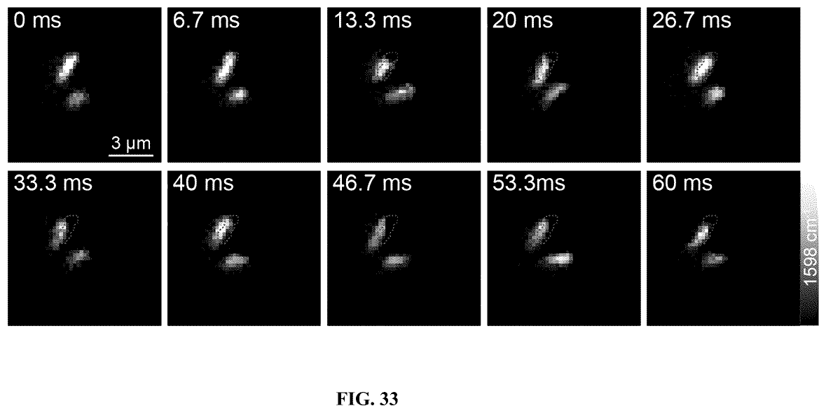

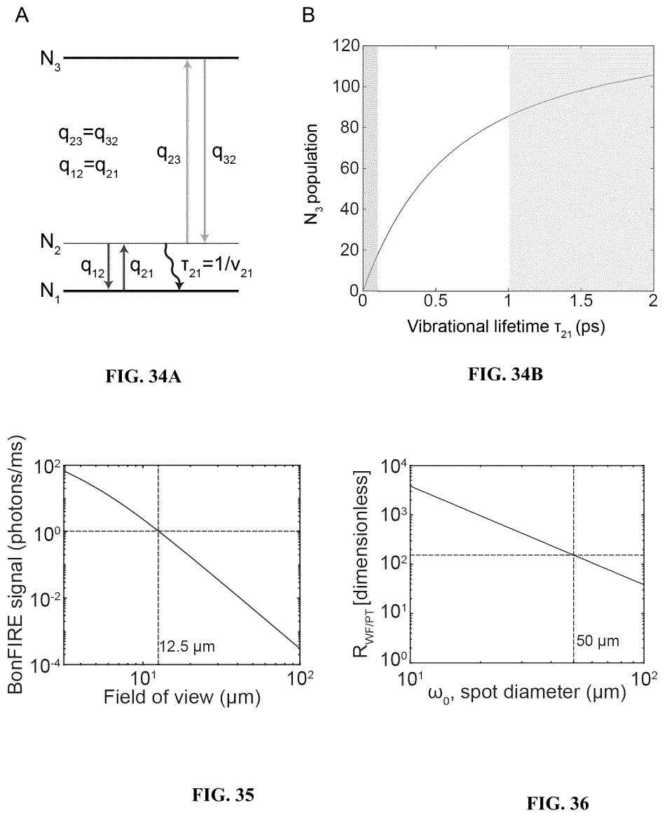

This example provides rationalization of the feasibility of WF-BonFIRE especially in the single molecule regime. Contrary to conventional virtual-state mediated two-photon imaging techniques such as two-photon fluorescence and SRS microscopy, which face challenges in high-sensitivity WF implementation due to high photon-flux requirements, BonFIRE is a real vibrational-state mediated non-degenerate two-photon excitation process. Employing 2-ps laser excitation achieves a balance between bond-selectivity and efficient vibrational excitation (FIG. 34), which competes with the picosecond vibrational relaxation lifetime. Furthermore, the up-conversion step is also highly efficient due to the large electronic absorption cross section. These efficient excitation steps lessen the necessity for high photon flux, thus allowing picosecond laser pulses to spread over a wider focal area. Given the excess power of the probe laser, the most straightforward design of WF-BonFIRE is to expand the probe beam to match with the diffraction-limited spot of the mid-IR beam, thereby optimizing the utilization of mid-IR photons with opportunities for additional area expansion.

To quantitatively model the optimal FOVs, we next calculated the achievable signals and signal-to-noise ratios (SNRs) as a function of FOV using a high-sensitivity sCMOS camera. At a 12.5 μm FOV, the achievable BonFIRE signal from a single Rh800 molecule is expected to reach 1 photon/ms with a SNR of 3, under a short camera exposure time of 25 ms (FIG. 35). In situations where single-molecule sensitivity is not essential, the FOV can be further expanded. It was then investigated the maximum FOV achievable for higher concentration biological samples. It was introduced a pixel rate ratio, R, for comparison between WF-BonFIRE and its point-scanning counterpart. Our analysis shows that, with maximum IR and probe power, the imaging speed of WF-BonFIRE is over 150 times faster than point-scanning at a FOV of 50 μm (FIG. 36). Any further increase in the FOV is possible but will compromise imaging speed due to the inverse quadratic relationship of laser intensity for each beam with the illumination area (FIG. 36).

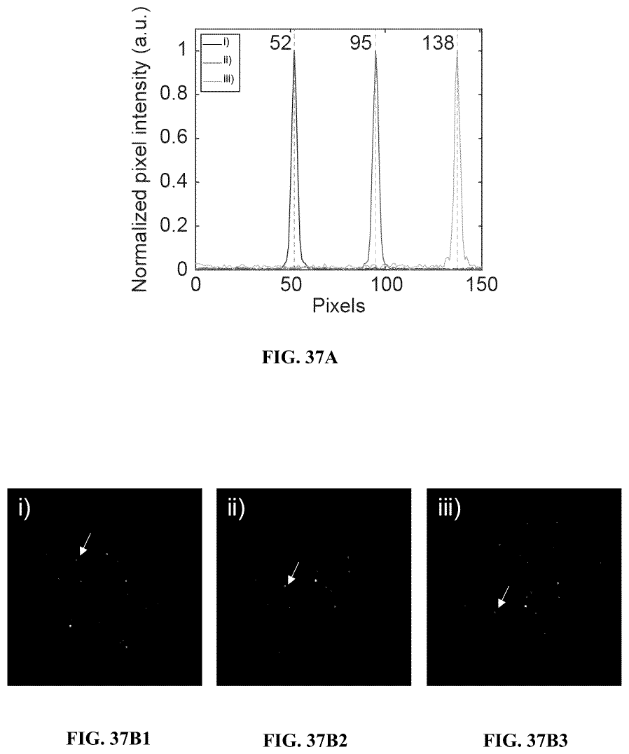

Based on above simulation, WF-BonFIRE was implemented in two modes. In Mode 1 (FIG. 1D, Mode 1), The sizes of the probe and the mid-IR beams were expanded and matched to a diameter of 12.5 μm. Given the sCMOS camera's quantum efficiency and noise characteristics, this expansion theoretically promises a substantial increase in acquisition speed without compromising SNR. For the second mode (FIG. 1D, Mode 2), both the IR and probe beams were expanded to a 50 μm FOV, striking a balance between ensuring adequate SNR and speed, all while encompassing an entire cell (FIG. 36). To achieve this FOV expansion, we focused the probe beam onto the back focal plane of the objective to ensure uniform illumination (FIG. 1F). Simultaneously, the IR beam underwent expansion using a lower numerical aperture (NA) IR objective to align its spot size with that of the probe beam. System magnification was carefully determined to meet the requirements of the Nyquist theorem while simultaneously optimizing SNR (FIG. 37). These two modes offer versatile capabilities for various bioimaging applications. Mode 1, with its smaller FOV, proves advantageous for scenarios demanding high photon flux, such as single-molecule imaging and ultrafast imaging. Conversely, Mode 2 proves valuable in scenarios where single molecule sensitivity is not required and a larger FOV is advantageous. To contextualize WF-BonFIRE's capabilities, we conducted a comprehensive assessment of its acquisition speed and detection limits-two critical parameters in bioimaging. This evaluation encompassed various chemical imaging modalities (FIG. 1E), spanning label-free and probe-dependent techniques, and WF-BonFIRE demonstrated superior performance in both aspects.

### Example 16

### Characterization of WF-BonFIRE Spectroscopy and Imaging Performance

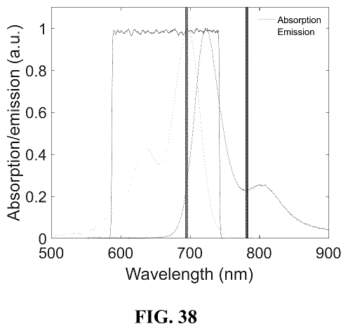

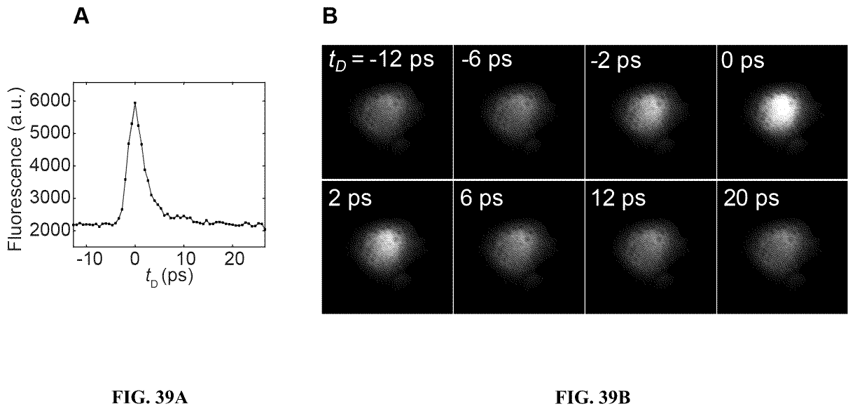

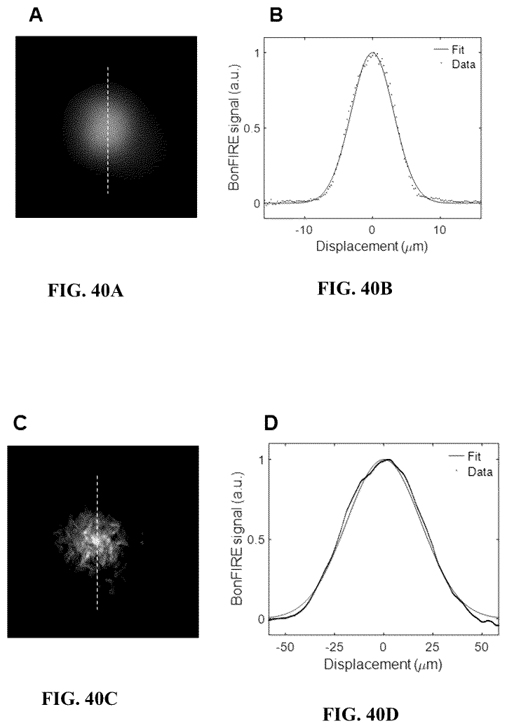

This example provides validation of WF-BonFIRE signal detection by targeting the C═C bond of Rhodamine 800 (Rh800), a near-infrared (NIR) probe with an absorption peak at 700 nm (FIG. 38). To optimize the efficiency of up-conversion from higher vibrational to higher electronic states, the probe wavelength was tuned to 788 nm to achieve a sum frequency that matches the absorption peak maximum. Initially, it was observed an increase in fluorescence when irradiated with the IR beam compared to using only the probe beam. However, it is worth noting that various spectroscopic processes, particularly the photothermal effect, can also lead to increased fluorescence in the presence of IR photons. Thus, an increase in fluorescence alone does not definitively confirm the presence of the BonFIRE signal. To distinguish BonFIRE from other processes, advantage was taken of the differing time scales between BonFIRE and photothermal effects by measuring fluorescence as a function of picosecond temporal delays between the IR and probe pulses. Given that photothermal processes occur on a microsecond time scale, BonFIRE exhibits sensitivity to picosecond shifts in temporal overlap. As anticipated, wide-field BonFIRE images with fluorescence variations dependent on temporal delay were aquired, conclusively confirming the presence of BonFIRE signals (FIGS. 30A-B, FIGS. 39A-B). To obtain a purified BonFIRE image, we performed a subtraction of the two fluorescence images acquired at t₀ and t₁. The resulting pure BonFIRE image displayed diameters of 12.5 μm and 50 μm, respectively, aligning with the desired FOV for the two distinct modes as determined through our simulations (FIGS. 40A-D).

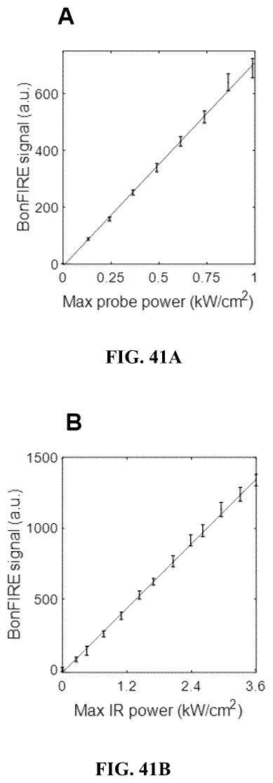

A series of spectroscopic and speed characterizations was then conducted. Initially, a BonFIRE spectrum was obtained while varying the IR wavelength (FIG. 30C). Notably, the two major peaks at 1505 cm⁻¹ and 1598 cm⁻¹ closely matched those of the FTIR spectrum, confirming high spectral fidelity. Furthermore, the BonFIRE signal's response to variations in both IR and probe power (FIGS. 41A-B) was explored, revealing a linear relationship between these parameters.

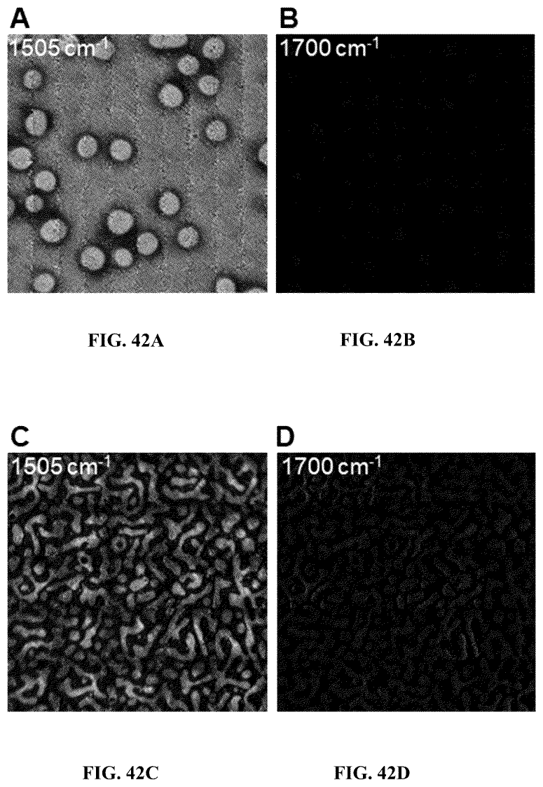

To illustrate the speed advantage of WF-BonFIRE, a Rh800 copolymer film—a structured soft material resulting from the phase separation of polystyrene and polymethylmethacrylate segments was imaged. In Mode 1, a 100×100 μm area was captured (FIG. 30D), with each tile acquired at an exposure time of 17.6 μs (FIG. 30E), the lowest exposure reachable using this sCMOS camera. The imaging speed of WF-BonFIRE and its point-scanning counterpart were compared. The metric used here for comparison is the imaging rate normalized by number of pixels and SNR:

$${R}_{WF / PS} = \frac{{n}_{WF}}{{n}_{PS}} \frac{{t}_{PS}}{{t}_{WF}} {( \frac{{SNR}_{WF}}{{SNR}_{PS}} )}^{2}$$

where R_{WF/PS} is the ratio of the pixel rate of WF-BonFIRE and its point-scanning (PS) counterpart and n is the number of pixels measured in exposure time t. As simulation predicts, the R_{WF/PS} was measured to be 10467 for WF mode 1, indicating significant increase of speed compared to PS-BonFIRE without compromising SNR. Tuning to an off-resonance frequency resulted in a dark background image, indicating narrow bond-selectivity of WF-BonFIRE (FIGS. 42A-D).

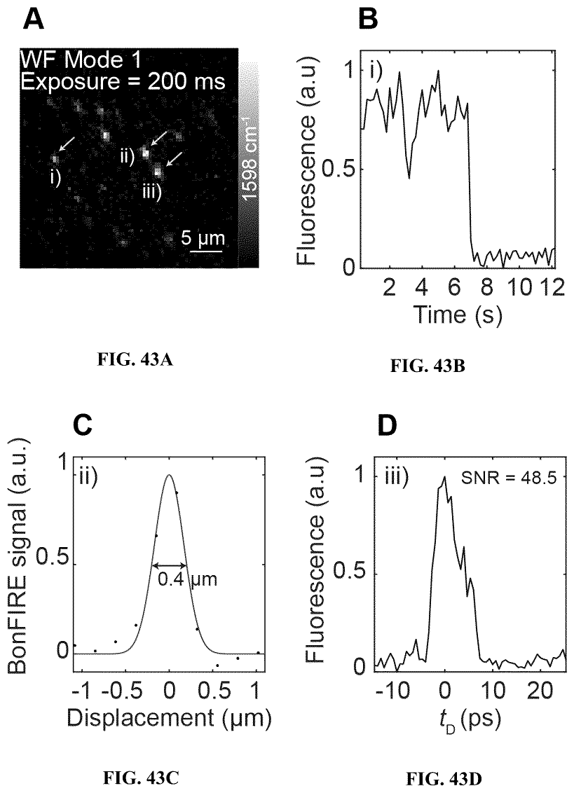

To illustrate the high sensitivity of WF-BonFIRE, more characterizations were performed using single-molecule sample. Using Mode 1, 12.5 μm FOV was imaged using exposure time of 200 ms (FIG. 30F). Such WF-BonFIRE image shows 235 times speed improvement over point-scanning image. One-step photobleaching curve indicates single molecule nature of the sample (FIG. 43 B), while temporal sweep indicates clear presence of BonFIRE signal with SNR close 50 (FIG. 43D). By taking a spatial profile of the single molecules, spatial resolution was determined to be 0.4 μm (FIG. 30G), indicative of diffraction-limited performance. Interestingly, BonFIRE signal was detected using exposure time low as 20 ms (FIGS. 30H & 30I), which agrees well with minimum exposure time calculated to achieve detectable SNR (FIG. 35), indicative of superb sensitivity and speed of WF-BonFIRE. In Mode 2, the scope was expanded to a 200×200 μm area of a similar copolymer sample (FIG. 30J), and each tile captured with an exposure time of 500 μs (FIG. 30K). The R value for Mode 2 was calculated to be 1721.

### Example 17

### Large Area WF-BonFIRE Imaging of Biological Samples

This example illustrates that the expanded FOV provided by WF-BonFIRE was harnessed for biological imaging. In many biological applications, especially systems neuroscience, capturing a broad acquisition area is vital, as many biological phenomena are best interpreted within a broader biological context. Serial acquisition methods for obtaining large-area images are time-consuming and may not be suitable for dynamic live cell applications. Wide-field detection significantly mitigates these time constraints.

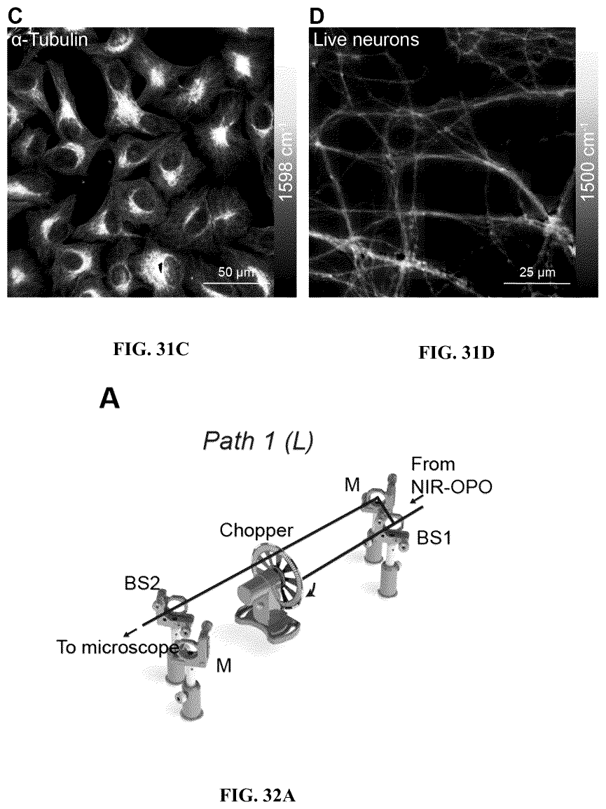

It was first conducted imaging of glial fibrillary acidic protein (GFAP), a key marker protein for astrocytes (FIGS. 31A-D, GFAP). GFAP was immunolabeled with ATTO680, whose double bond was imaged with WF-BonFIRE. By tuning to an off-resonant infrared (IR) frequency, a dark background was observed, indicative of the high bond-selectivity of WF-BonFIRE (FIG. 31A, GFAP inset). The imaging was extended to the nuclei of HeLa cells, which contained 5-ethynyl-2′-deoxyuridine (EdU), a thymidine analog (FIGS. 31 A-D, EdU). These nuclei were similarly labeled with ATTO680 dye through a click chemistry reaction. WF-BonFIRE proved effective for samples with low-abundance proteins such as ATTO680-immunolabeled alpha-tubulins, at concentrations below the micromolar range (FIGS. 31A-D, α-Tubulin). The high signal-to-noise ratio (SNR) achieved enabled resolution of clear tubulin structures, thereby providing detailed insights into their spatial organization. Additionally, live cell imaging was performed to visualize Rh800 labeled mitochondrial structures in neurons (FIGS. 31A-D, Live neurons). The approach covered a 100×100 μm area and captured images in less than a minute, depending on the concentration of the target of interest. This rapid imaging capability is in stark contrast to the over an hour required with point-scanning BonFIRE, making the approach particularly advantageous for live cell imaging or applications that require high temporal resolution.

### Example 18

### Ultrafast WF-BonFIRE Imaging Using Temporal Delay Modulation

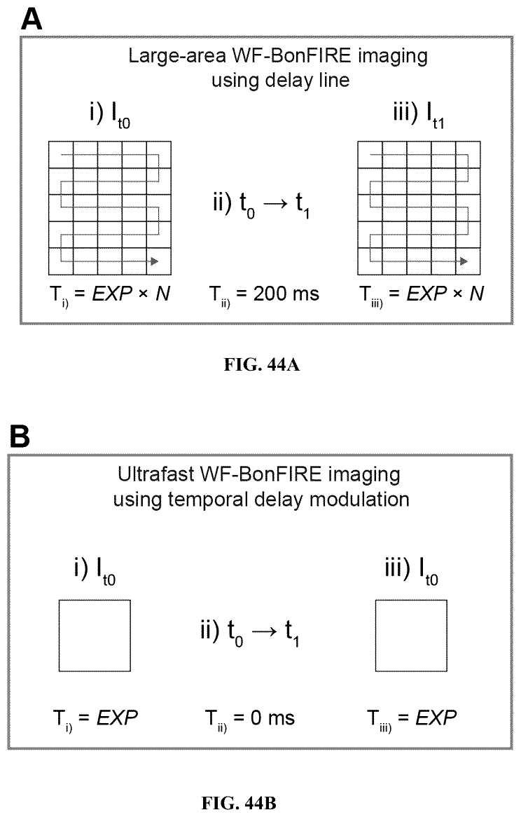

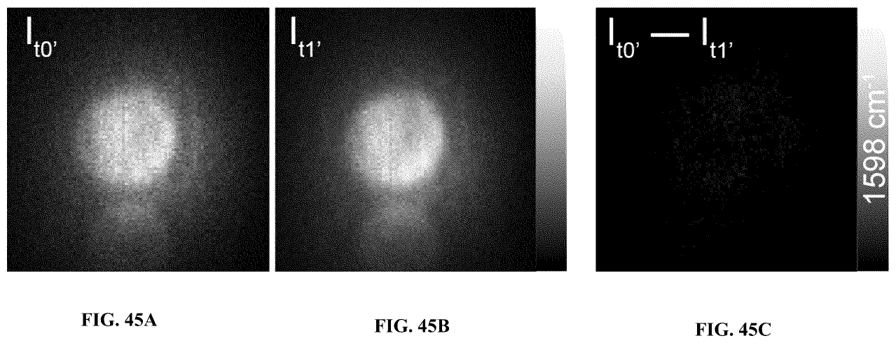

This example illustrates ultrafast imaging at frame rates surpassing video-rate FPS. While large-area imaging demonstrated significant improvements in acquisition speed, achieving ultrafast imaging beyond video-rate presented a notable challenge (FIGS. 44A-B). BonFIRE necessitates the acquisition of two fluorescence images at different temporal delays to eliminate undesired photothermal background. However, adjusting the temporal delay involves an additional 0.2-second delay due to the mechanical settling time of the delay line, which hampers the achievement of ultrafast imaging.

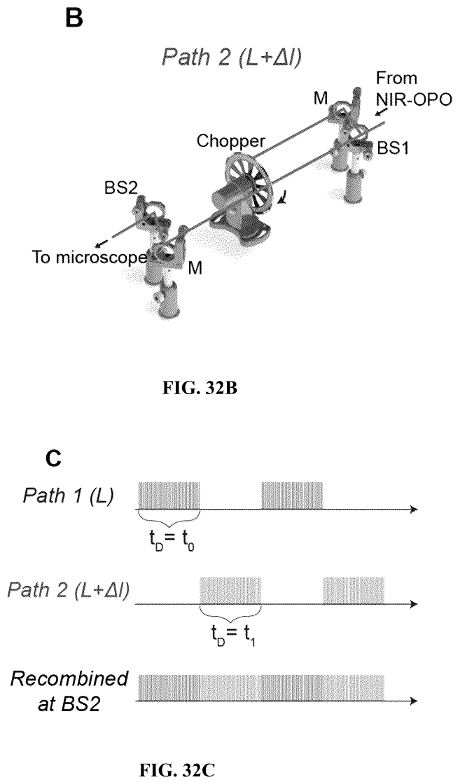

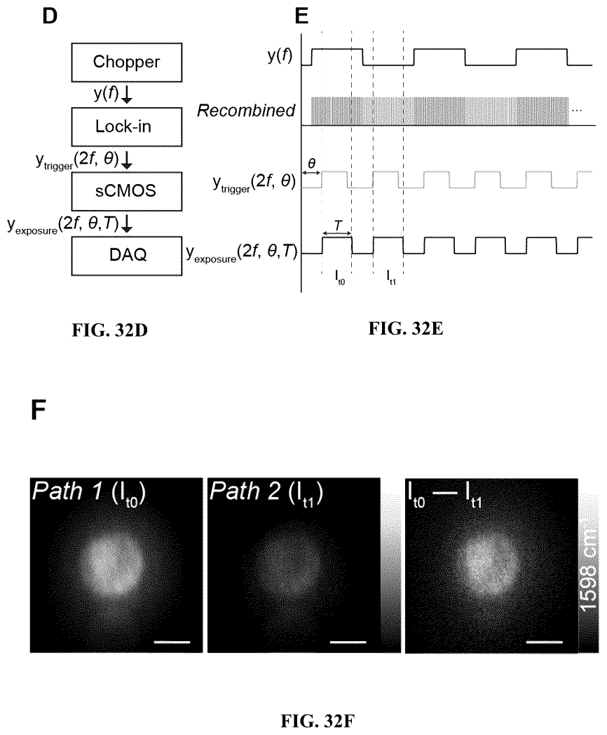

To address these challenges and fully harness the imaging capabilities of WF-BonFIRE, Mode 1 was adopted, where the spot size of the IR and probe beams were matched, resulting in a BonFIRE FOV of 12.5 μm. This configuration maximizes the photon flux while achieving wide-field detection. Additionally, a temporal delay modulation scheme was implemented to allow instantaneous adjustments of pulse delays without relying on the physical position of the delay line (FIGS. 32A & B). To achieve this, the probe beam was split into two pulse trains using a beam splitter (FIGS. 32A & B, BS1). Within these two light paths, one path was deliberately lengthened by Δl (FIG. 32B), introducing a slight temporal delay compared to the pulse trains from the shorter path. To synchronize the imaging process, a chopper was employed to selectively allow only one of the pulse trains to reach the sample at a time, blocking the other. These two beams were later recombined using a second beam splitter (FIGS. 32A & B, BS2) and directed towards the sample, resulting in an alternating pulse train of two different temporal delays (FIG. 32C, preferred). The chopper was precisely coordinated with the camera, ensuring that one image was acquired with only the first pulse train at t_{D}=t₀, followed by the acquisition of another image with the second pulse train at t_{D}=t1, where the IR and probe pulses were intentionally misaligned temporally (FIGS. 32D & E).

In FIG. 32D, the wiring diagram for control signals that govern camera and lock-in synchronization within the system was presented. The chopper's reference output (y(f)) undergoes frequency doubling via a lock-in amplifier, with the digital output from the lock-in amplifier (y_{trigger}(2f, θ)) serving as the trigger for the sCMOS camera's exposure (FIGS. 32D & E, yₑₓₚₒₛᵤᵣₑ(2f, θ, T)). The critical elements for achieving precise synchronization involve the camera's exposure timing output and the recombined alternating pulse train (FIG. 32E). To ensure seamless coordination, adjustments are made to the lock-in phase (θ) to account for the chopper's rise and fall times, during which the beam partially obstructs. Moreover, the exposure duration (T) is set to maintain approximately 60% of the reciprocal of the doubled chopper frequency (1/2f).

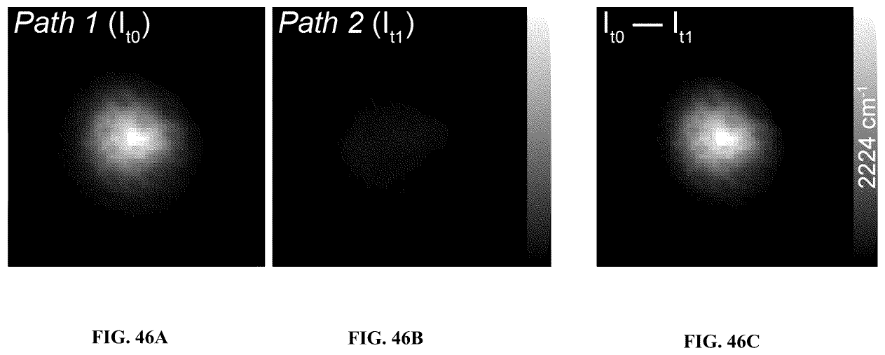

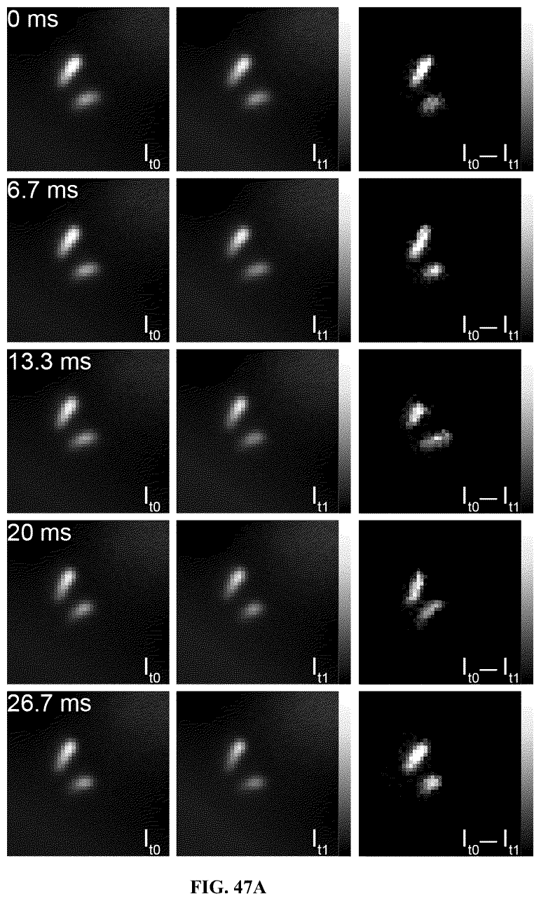

Utilizing the temporal delay modulation scheme, measurements of the BonFIRE signal (FIG. 32F) were conducted using a Rh800 copolymer polymer. Image sequence was acquired where the sequence contained alternating images acquired at temporal delays t₀ and t₁, corresponding to Path 1 and Path 2 in the temporal delay modulation scheme (FIG. 32F, Path 1 (Iₜ₀), Path 2 (Iₜ₁)). The subtraction of the two resulted in a background free BonFIRE image (FIG. 32F, Iₜ₀−Iₜ₁). Using temporal delay modulation, ultrafast WF-BonFIRE imaging of 300 FPS was achieved. When tuned to a delay position where both Path1 and Path2 produced temporally misaligned IR and probe pulses, no BonFIRE signal was observed, indicating absence of artifacts introduced from temporal delay modulation scheme (FIGS. 45A-C). Similarly, temporal delay modulation was demonstrated at 2224 cm⁻¹ targeting the nitrile bond of Rh800 (FIGS. 46A-C).

### Example 19

### WF-BonFIRE Imaging Beyond Video-Rate

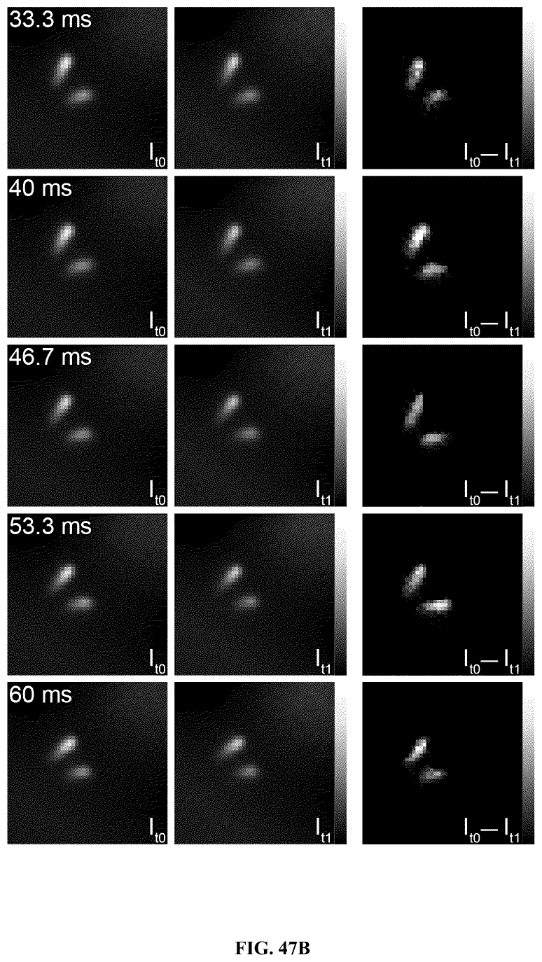

This example illustrates that Rh800-labeled E. coli was employed to observe their Brownian motion—an essential aspect of microbial behavior in liquid environments. The diffusion coefficient of E. coli in water, typically determined by the Stokes-Einstein equation, falls within the range of 10 to 100 μm²/s. To effectively capture and analyze this rapid microscopic motion, high-speed microscopy with frame rates exceeding several tens of frames per second is required. BonFIRE images at 150 frames per second were acquired, enabling precise tracking of E. coli movement with 10 frames within 60 milliseconds without motion artifacts (FIG. 33 & FIGS. 47A-B).

### Example 20

### WF-Super-Resolution Bond-Selective Imaging

This example illustrates a further significant application which is super-resolution bond-selective imaging. While various label-free methods have yielded super-resolution chemical imaging, achieving sub-100 nm spatial resolution has been challenging due to the limited SNR inherent in chemical imaging. Combining chemical imaging with established methods, such as STED and RESOLFT, lead to considerable photobleaching and restricted multiplexing potential. In contrast, the sensitivity and imaging speed we have shown offer considerable promise for super-resolution bond-selective imaging, particularly within the framework of single-molecule localization microscopy (SMLM), where the effects of photobleaching could be substantially minimized. When combined with SMLM, WF-BonFIRE facilitates super-multiplexed super-resolution microscopy, a task that remains challenging with current fluorescence imaging techniques.

### Example 21

### WF-Imaging Speeds Above 2100 FPS

This example illustrates implementation for achieving WF-imaging speeds above 2100 FPS. The use of electro-optic modulators (EOM) and quartz crystals offers a solution by enabling temporal delay modulation at high frequencies, bypassing these current constraints of the speed of camera and the frequency constraints of chopper rotation. This method utilizes the quick switching capabilities of an EOM for polarization changes, along with the birefringent nature of quartz waveplates to create temporal separation between polarizations.

### Terminology

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of bond-selective fluorescence-detected infrared-excited (BonFIRE) spectroscopy or microscopy, the method comprising:
providing a sample comprising a dye having an UV-vis absorption maximum;
generating an IR laser and a NIR laser, wherein the IR laser and the NIR laser are coherent;
aligning the IR laser and the NIR laser in a counter-propagating configuration on the sample;
irradiating the dye molecule with the IR laser and the NIR laser; and
detecting a fluorescence from the dye molecule.

2. The method of claim 1, comprising selecting a total energy of a photon of the IR laser and a photon of the NIR laser to be about equal to the energy of the UV-vis absorption maximum, and extracting a bond-selective IR absorption maximum of the dye from the fluorescence or obtaining an image of the sample from the fluorescence.

3. (canceled)

4. The method of claim 1, wherein the UV-vis absorption maximum ranges from 400-800 nm or 800-4800 cm⁻¹; the IR laser has a wave number ranging from 800-4800 cm⁻¹; and the NIR laser has a wavelength ranging from 700-960 nm.

5-6. (canceled)

7. The method of claim 1, wherein the IR laser has a duration ranging from 0.1 to 10 picoseconds, and/or the NIR laser has a duration ranging from 0.1 to 10 picoseconds.

8. (canceled)

9. The method of claim 1, wherein the IR laser has a bandwidth ranging from 1 to 25 cm⁻¹ and/or the NIR laser has a bandwidth ranging from 1 to 25 cm⁻¹.

10. (canceled)

11. The method of claim 1, further comprising providing the NIR laser with a temporal delay (t_{D}) ranging from −10 picoseconds to 25 picoseconds.

12-18. (canceled)

19. The method of claim 1, wherein the dye comprises one or more isotopologues of conjugated carbon-carbon double bond (C═C), conjugated carbon-carbon triple bond (C≡C) and/or conjugated carbon-nitrogen triple bond (C≡N), wherein the carbon is ¹²C or ¹³C and the nitrogen is ¹⁴N or ¹⁵N, in any combinations thereof.

20.-25. (canceled)

26. The method of claim 1, further comprising obtaining a plurality of images of the sample from the fluorescence, wherein the plurality of images each corresponds to one of a plurality of temporal delays (t_{D}).

27.-31. (canceled)

32. The method of claim 1, further comprising passing the IR laser through an acoustic optical modulator (AOM) to obtain a first-order diffraction IR laser before aligning the IR laser and the NIR laser in a counter-propagating configuration on the sample, wherein the acoustic optical modulator (AOM) is controlled by a trigger source which produces a modulation frequency.

33. The method of claim 32, wherein the detecting a fluorescence from the dye was performed with a photomultiplier tube (PMT), wherein the BonFIRE spectroscopy has a signal to background ratio (S/B) ranging from 2 to 100.

34-39. (canceled)

40. The method of claim 32, wherein the modulation frequency ranges from 0.1 to 5.0 MHz.

41.-43. (canceled)

44. The method of claim 1, wherein the detecting comprises a field of view ranging from 1 to 25 μm or from 25 to 100 μm in dimension.

45.-50. (canceled)

51. The method of claim 1, wherein the detecting has an acquisition speed ranging from 20 to 10,000 frames per second (fps).

52. (canceled)

53. A system for bond-selective fluorescence-detected infrared-excited (BonFIRE) spectroscopy or microscopy, the system comprising:
a piezo stage for holding a sample comprising a dye wherein the dye has an UV-vis absorption maximum;
a laser source for an IR-OPO (optical parametric oscillator), and a NIR-OPO for generating an IR laser and a NIR laser, respectively, wherein the IR laser and the NIR laser are coherent and, wherein the IR-OPO was followed by and optically connected to a DFG (difference frequency generation), optionally followed by and optically connected to an acoustic optical modulator (AOM), and the NIR-OPO is preceded by and optically connected to a SHG (second-harmonic generation), and
a SPCM (single-photon counting module) or a photomultiplier tube (PMT) for detecting a fluorescence from the dye.

54. The system of claim 53, wherein the acoustic optical modulator (AOM), and the photomultiplier tube (PMT) are present, and wherein the acoustic optical modulator (AOM) and the photomultiplier tube (PMT) are communicatively electrically connected to a lock-in amplifier, wherein the acoustic optical modulator (AOM) is controlled by a trigger source which produces a modulation frequency.

55. The system of claim 53 further comprising a delay stage on a light path of the NIR laser.

56. The system of claim 53 further comprising an optical chopper on a first path and a second path of the NIR laser.

57. The system of claim 56, wherein the optical chopper has a rotation speed ranging from 1 to 20 kHz, or 5 to 10 kHz.

58. The system of claim 56, further comprising a first beam splitter and a second beam splitter on the first path and the second path of the NIR laser.

59. The system of claim 56, wherein the second path is lengthier than the first path by Δl ranging from 0.01 mm to 10 mm.

60. (canceled)
